(19) United States
(12) Patent Application Publication
(10) Pub. No.: US 2013/0085064 A1
(43) Pub. Date: Apr. 4, 2013

(54) PESTICIDAL MIXTURES CONTAINING ISOXAZOLINE DERIVATIVES AND INSECTICIDE OR NEMATOICIDAL BIOLOGICAL AGENT

(71) Applicants: Patrik Hoegger, Stein (CH); Ana Cristina Dutton, Stein (CH); Max Angst, Basel (CH); Jérôme Yves Cassayre, Stein (CH)

(72) Inventors: Patrik Hoegger, Stein (CH); Ana Cristina Dutton, Stein (CH); Max Angst, Basel (CH); Jérôme Yves Cassayre, Stein (CH)

(73) Assignee: SYNGENTA CROP PROTECTION LLC, Greensboro, NC (US)

(21) Appl. No.: 13/581,156

(22) PCT Filed: Feb. 3, 2011
(86) PCT No.: PCT/EP2011/051511

§ 371 Date: Nov. 13, 2012

(30) Foreign Application Priority Data
Feb. 25, 2010 (EP) 10250337.2
May 7, 2010 (GB) 1007689.1
May 28, 2010 (EP) 10164231.2
Oct. 12, 2010 (EP) 10187269.5

(51) Int. Cl. A01N 43/80; A01N 53/00; A01N 43/88; A01N 57/16

(52) U.S. Cl. CPC A01N 43/80; A01N 57/16; A01N 53/00; A01N 43/88
USPC 504/100; 514/30; 514/89; 514/341; 514/378; 514/242; 514/229.2; 514/355

(57) ABSTRACT

The present invention relates to pesticidal mixtures comprising a component A and a component B, wherein component A is a compound of formula (I) wherein A¹, A², R¹, R², R³, R⁴ and R⁵ are as defined in claim 1 and one of Y¹ and Y² is S, SO or SO₂ and the other is CH₂ and component B is an insecticide or nematicidal biological agent as defined in claim 1. The present invention also relates to methods of using said mixtures for the control of pests.

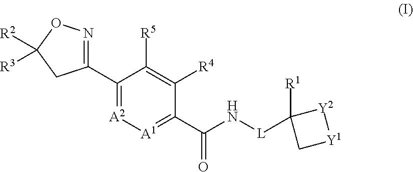

The present invention relates to mixtures of pesticidally active ingredients and to methods of using the mixtures in the field of agriculture.

WO 2009/080250 discloses that certain isoxazoline compounds have insecticidal activity.

The present invention provides pesticidal mixtures comprising a component A and a component B, wherein component A is a compound of formula I

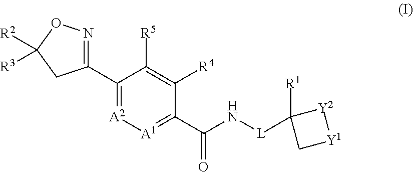

wherein
one of Y¹ and Y² is S, SO or SO₂ and the other is CH₂;
L is a direct bond or methylene;
A¹ and A² are C—H, or one of A¹ and A² is C—H and the other is N;
R¹ is hydrogen or methyl;
R² is chlorodifluoromethyl or trifluoromethyl;
R³ is 3,5-dibromo-phenyl, 3,5-dichloro-phenyl, 3,4-dichloro-phenyl, or 3,4,5-trichlorophenyl;
R⁴ is methyl;
R⁵ is hydrogen;
or R⁴ and R⁵ together form a bridging 1,3-butadiene group;
and component B is a compound selected from
a) a pyrethroid including those selected from the group consisting of permethrin, cypermethrin, fenvalerate, esfenvalerate, deltamethrin, cyhalothrin, lambda-cyhalothrin, gamma-cyhalothrin, bifenthrin, fenpropathrin, cyfluthrin, tefluthrin, ethofenprox, natural pyrethrin, tetramethrin, S-bioallethrin, fenfluthrin, prallethrin and 5-benzyl-3-furylmethyl-(E)-(1R,3S)-2,2-dimethyl-3-(2-oxothiolan-3-ylidenemethyl)cyclopropane carboxylate;
b) an organophosphate including those selected from the group consisting of sulprofos, acephate, methyl parathion, azinphos-methyl, demeton-s-methyl, heptenophos, thiometon, fenamiphos, monocrotophos, profenofos, triazophos, methamidophos, dimethoate, phosphamidon, malathion, chlorpyrifos, phosalone, terbufos, fensulfothion, fonofos, phorate, phoxim, pirimiphos-methyl, pirimiphos-ethyl, fenitrothion, fosthiazate and diazinon;
c) a carbamate including those selected from the group consisting of pirimicarb, triazamate, cloethocarb, carbofuran, furathiocarb, ethiofencarb, aldicarb, thiofurox, carbosulfan, bendiocarb, fenobucarb, propoxur, methomyl and oxamyl;
d) a benzoyl urea including those selected from the group consisting of diflubenzuron, triflumuron, hexaflumuron, flufenoxuron, lufenuron and chlorfluazuron;
e) an organic tin compound including those selected from the group consisting of cyhexatin, fenbutatin oxide and azocyclotin;
f) a pyrazole including those selected from the group consisting of tebufenpyrad and fenpyroximate;
g) a macrolide including those selected from the group consisting of abamectin, emamectin (e.g. emamectin benzoate), ivermectin, milbemycin, spinosad, azadirachtin and spinetoram;
h) an organochlorine compound including those selected from the group consisting of endosulfan (in particular alpha-endosulfan), benzene hexachloride, DDT, chlordane and dieldrin;
i) an amidine including those selected from the group consisting of chlordimeform and amitraz;
j) a fumigant agent including those selected from the group consisting of chloropicrin, dichloropropane, methyl bromide and metam;
k) a neonicotinoid compound including those selected from the group consisting of imidacloprid, thiacloprid, acetamiprid, nitenpyram, dinotefuran, thiamethoxam, clothianidin, nithiazine and flonicamid;
l) a diacylhydrazine including those selected from the group consisting of tebufenozide, chromafenozide and methoxyfenozide;
m) a diphenyl ether including those selected from the group consisting of diofenolan and pyriproxyfen;
n) indoxacarb;
o) chlorfenapyr;
p) pymetrozine;
q) spirotetramat, spirodiclofen and spiromesifen;
r) a diamide including those selected from the group consisting of flubendiamide, chlorantraniliprole (Rynaxypyr®) and cyantraniliprole;
s) sulfoxaflor;
t) metaflumizone;
u) fipronil and ethiprole;
v) pyrifluqinazon;
w) buprofezin.
x) diafenthiuron; and
y) 4-[(6-Chloro-pyridin-3-ylmethyl)-(2,2-difluoro-ethyl)-amino]-5H-furan-2-one.

In addition, component B may be a nematicidally active biological agent. The nematicidally active biological agent refers to any biological agent that has nematicidal activity. The biological agent can be any type known in the art including bacteria and fungi. The wording “nematicidally active” refers to having an effect on, such as reduction in damage caused by, agricultural-related nematodes. The nematicidally active biological agent can be a bacterium or a fungus. Preferably, the biological agent is a bacterium. Examples of nematicidally active bacteria include Bacillus firmus, Bacillus cereus, Bacillus subtilis, and Pasteuria penetrans, preferably Bacillus firmus, Bacillus subtilis, and Pasteuria penetrans. A suitable Bacillus firmus strain is strain CNCM I-1582 which is commercially available as BioNem™. A suitable Bacillus cereus strain is strain CNCM I-1562. Of both Bacillus strains more details can be found in U.S. Pat. No. 6,406,690.

It has now been found, surprisingly, that the active ingredient mixture according to the invention not only delivers about the additive enhancement of the spectrum of action with respect to the pest to be controlled that was in principle to be expected but achieves a synergistic effect which can extend the range of action of the component A and of the component B in two ways. Firstly, the rates of application of the component A and of the component B are lowered whilst the action remains equally good. Secondly, the active ingredient mixture still achieves a high degree of pest control, sometimes even where the two individual components have become totally ineffective in such a low application rate range. This allows increased safety in use.

However, besides the actual synergistic action with respect to pest control, the pesticidal compositions according to the invention can have further surprising advantageous properties which can also be described, in a wider sense, as synergistic activity. Examples of such advantageous properties that may be mentioned are: a broadening of the spectrum of pest control to other pests, for example to resistant strains; a reduction in the rate of application of the active ingredients; adequate pest control with the aid of the compositions according to the invention, even at a rate of application at which the individual compounds are totally ineffective; advantageous behaviour during formulation and/or upon application, for example upon grinding, sieving, emulsifying, dissolving or dispensing; increased storage stability; improved stability to light; more advantageuos degradability; improved toxicological and/or ecotoxicological behaviour; improved characteristics of the useful plants including: emergence, crop yields, more developed root system, tillering increase, increase in plant height, bigger leaf blade, less dead basal leaves, stronger tillers, greener leaf colour, less fertilizers needed, less seeds needed, more productive tillers, earlier flowering, early grain maturity, less plant verse (lodging), increased shoot growth, improved plant vigor, and early germination; or any other advantages familiar to a person skilled in the art.

The compounds of formula I and their manufacturing processes are known from WO 2009/080250. The components B are known, e.g. from “The Pesticide Manual”, Fifteenth Edition, Edited by Clive Tomlin, British Crop Protection Council. The compound under y) is known from DE 102006015467. Reference to the above components B includes reference to their salts and any usual derivatives, such as ester derivatives.

The combinations according to the invention may also comprise more than one of the active components B, if, for example, a broadening of the spectrum of pest control is desired. For instance, it may be advantageous in the agricultural practice to combine two or three components B with any of the compounds of formula I, or with any preferred member of the group of compounds of formula I. The mixtures of the invention may also comprise other active ingredients in addition to components A and B. In other embodiments the mixtures of the invention may include only components A and B as pesticidally active ingredients, e.g. no more than two pesticidally active ingredients.

In one preferred group of compounds of formula I Y¹ is S and Y² is CH₂.

In another preferred group of compounds of formula I Y¹ is SO and Y² is CH₂.

In another preferred group of compounds of formula I Y¹ is SO₂ and Y² is CH₂.

In another preferred group of compounds of formula I Y² is S and Y¹ is CH₂.

In another preferred group of compounds of formula I Y² is SO and Y¹ is CH₂.

In another preferred group of compounds of formula I Y² is SO₂ and Y¹ is CH₂.

In yet another preferred group of compounds of formula I L is a direct bond or methylene; one of Y¹ and Y² is S and the other is CH₂; A¹ and A² are C—H; R¹ is hydrogen or methyl; R² is trifluoromethyl; R³ is 3,5-dichloro-phenyl; R⁴ is methyl; and R⁵ is hydrogen.

In yet another preferred group of compounds of formula I L is a direct bond or methylene; one of Y¹ and Y² is SO and the other is CH₂; A¹ and A² are C—H; R¹ is hydrogen or methyl; R² is trifluoromethyl; R³ is 3,5-dichloro-phenyl; R⁴ is methyl; and R⁵ is hydrogen.

In yet another preferred group of compounds of formula I L is a direct bond or methylene; one of Y¹ and Y² is SO₂ and the other is CH₂; A¹ and A² are C—H; R¹ is hydrogen or methyl; R² is trifluoromethyl; R³ is 3,5-dichloro-phenyl; R⁴ is methyl; and R⁵ is hydrogen.

In yet another preferred group of compounds of formula I L is a direct bond or methylene; one of Y¹ and Y² is S and the other is CH₂; A¹ and A² are C—H; R¹ is hydrogen or methyl; R² is trifluoromethyl; R³ is 3,5-dichloro-phenyl; and R⁴ is methyl; and R⁴ and R⁵ together form a bridging 1,3-butadiene group.

In yet another preferred group of compounds of formula I L is a direct bond or methylene; one of Y¹ and Y² is SO and the other is CH₂; A¹ and A² are C—H; R¹ is hydrogen or methyl; R² is trifluoromethyl; R³ is 3,5-dichloro-phenyl; and R⁴ is methyl; and R⁴ and R⁵ together form a bridging 1,3-butadiene group.

In yet another preferred group of compounds of formula I L is a direct bond or methylene; one of Y¹ and Y² is SO₂ and the other is CH₂; A¹ and A² are C—H; R¹ is hydrogen or methyl; R² is trifluoromethyl; R³ is 3,5-dichloro-phenyl; and R⁴ is methyl; and R⁴ and R⁵ together form a bridging 1,3-butadiene group.

In yet another preferred group of compounds of formula I L is a direct bond or methylene; one of Y¹ and Y² is S and the other is CH₂; A¹ is C—H; A² is N; R¹ is hydrogen or methyl; R² is trifluoromethyl; R³ is 3,5-dichloro-phenyl; R⁴ is methyl; and R⁵ is hydrogen.

In yet another preferred group of compounds of formula I L is a direct bond or methylene; one of Y¹ and Y² is SO and the other is CH₂; A¹ is C—H; A² is N; R¹ is hydrogen or methyl; R² is trifluoromethyl; R³ is 3,5-dichloro-phenyl; R⁴ is methyl; and R⁵ is hydrogen.

In yet another preferred group of compounds of formula I L is a direct bond or methylene; one of Y¹ and Y² is SO₂ and the other is CH₂; A¹ is C—H; A² is N; R¹ is hydrogen or methyl; R² is trifluoromethyl; R³ is 3,5-dichloro-phenyl; R⁴ is methyl; and R⁵ is hydrogen.

In yet another preferred group of compounds of formula I L is a direct bond; Y¹ is S, SO or SO₂; Y² is CH₂; A¹ is C—H; A² is C—H; R¹ is hydrogen; R² is trifluoromethyl; R³ is 3,5-dichloro-phenyl; R⁴ is methyl; and R⁵ is hydrogen.

In yet another preferred group of compounds of formula I L is a direct bond; Y¹ is S, SO or SO₂; Y² is CH₂; A¹ is C—H; A² is C—H; R¹ is methyl; R² is trifluoromethyl; R³ is 3,5-dichloro-phenyl; R⁴ is methyl; and R⁵ is hydrogen.

In yet another preferred group of compounds of formula I L is methylene; Y¹ is CH₂; Y² is S, SO or SO₂; A¹ is C—H; A² is C—H; R¹ is hydrogen; R² is trifluoromethyl; R³ is 3,5-dichloro-phenyl; R⁴ is methyl; and R⁵ is hydrogen.

In yet another preferred group of compounds of formula I L is methylene; Y¹ is CH₂; Y² is S, SO or SO₂; A¹ is C—H; A² is C—H; R¹ is methyl; R² is trifluoromethyl; R³ is 3,5-dichloro-phenyl; R⁴ is methyl; and R⁵ is hydrogen.

Preferably when L is a direct bond Y² is CH₂ and Y¹ is S, SO or SO₂ and when L is methylene Y² is S, SO or SO₂ and Y¹ is CH₂.

Each substituent definition in each preferred group of compounds of formula I may be juxtaposed with any substituent definition in any other preferred group of compounds, in any combination.

Compounds of formula I include at least one chiral centre and may exist as compounds of formula I* or compounds of formula I**.

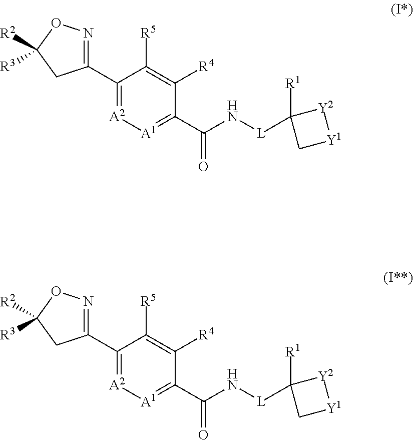

Compounds of formula I** are more biologically active than compounds of formula I* (confirmed by X-ray analysis). Component A may be a mixture of compounds I* and I** in any ratio e.g. in a molar ratio of 1:99 to 99:1, e.g. 10:1 to 1:10, e.g. a substantially 50:50 molar ratio. Preferably component A is a racemic mixture of the compounds of formula I** and I* or is enantiomerically enriched for the compound of formula I**. For example, when component A is an enantiomerically enriched mixture of formula I**, the molar proportion of compound I** compared to the total amount of both enantiomers is for example greater than 50%, e.g. at least 55, 60, 65, 70, 75, 80, 85, 90, 95, 96, 97, 98, or at least 99%.

Preferred compounds of formula I are shown in the Table below.

TABLE A
Compounds of formula I(a)

| 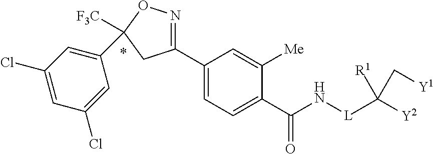 | | | | | (Ia) |
|---|---|---|---|---|---|
| Comp | Stereochemistry | | | | |
| No. | at * | L | R¹ | Y¹ | Y² |
| 1 | racemic mixture | bond | CH₃ | S | CH₂ |
| 2 | racemic mixture | bond | CH₃ | SO (cis) | CH₂ |
| 3 | racemic mixture | bond | CH₃ | SO (trans) | CH₂ |
| 4 | racemic mixture | bond | CH₃ | SO₂ | CH₂ |
| 5 | racemic mixture | bond | H | S | CH₂ |
| 6 | racemic mixture | bond | H | SO (cis) | CH₂ |
| 7 | racemic mixture | bond | H | SO (trans) | CH₂ |
| 8 | racemic mixture | bond | H | SO₂ | CH₂ |
| 9 | racemic mixture | CH₂ | CH₃ | CH₂ | S |
| 10 | racemic mixture | CH₂ | CH₃ | CH₂ | SO (cis) |
| 11 | racemic mixture | CH₂ | CH₃ | CH₂ | SO (trans) |
| 12 | racemic mixture | CH₂ | CH₃ | CH₂ | SO₂ |
| 13 | racemic mixture | CH₂ | H | CH₂ | S |
| 14 | racemic mixture | CH₂ | H | CH₂ | SO (cis) |
| 15 | racemic mixture | CH₂ | H | CH₂ | SO (trans) |
| 16 | racemic mixture | CH₂ | H | CH₂ | SO₂ |
| 19 | S | bond | CH₃ | S | CH₂ |
| 20 | S | bond | CH₃ | SO (cis) | CH₂ |
| 21 | S | bond | CH₃ | SO (trans) | CH₂ |
| 22 | S | bond | CH₃ | SO₂ | CH₂ |
| 23 | S | bond | H | S | CH₂ |
| 24 | S | bond | H | SO (cis) | CH₂ |
| 25 | S | bond | H | SO (trans) | CH₂ |
| 26 | S | bond | H | SO₂ | CH₂ |
| 27 | S | CH₂ | CH₃ | CH₂ | S |
| 28 | S | CH₂ | CH₃ | CH₂ | SO (cis) |
| 29 | S | CH₂ | CH₃ | CH₂ | SO (trans) |
| 30 | S | CH₂ | CH₃ | CH₂ | SO₂ |
| 31 | S | CH₂ | H | CH₂ | S |
| 32 | S | CH₂ | H | CH₂ | SO (cis) |
| 33 | S | CH₂ | H | CH₂ | SO (trans) |
| 34 | S | CH₂ | H | CH₂ | SO₂ |

The symbol * indicates the location of the chiral centre

The present invention includes all isomers of compounds of formula (I), salts and N-oxides thereof, including enantiomers, diastereomers and tautomers. Component A may be a mixture of any type of isomer of a compound of formula I, or may be substantially a single type of isomer. For example, where Y¹or Y² is SO, component A may be a mixture of the cis and trans isomer in any ratio, e.g. in a molar ratio of 1:99 to 99:1, e.g. 10:1 to 1:10, e.g. a substantially 50:50 molar ratio. For example, in trans enriched mixtures of the compound of formula I, e.g. when Y¹or Y² is SO, the molar proportion of the trans compound in the mixture compared to the total amount of both cis and trans is for example greater than 50%, e.g. at least 55, 60, 65, 70, 75, 80, 85, 90, 95, 96, 97, 98, or at least 99%. Likewise, in cis enriched mixtures of the compound of formula I (preferred), e.g. when Y¹ or Y² is SO, the molar proportion of the cis compound in the mixture compared to the total amount of both cis and trans is for example greater than 50%, e.g. at least 55, 60, 65, 70, 75, 80, 85, 90, 95, 96, 97, 98, or at least 99%. The compound of formula I may be enriched for the trans sulphoxide. Likewise, the compound of formula I may be enriched for the cis sulphoxide. Y¹or Y² is SO for compounds 2, 3, 6, 7, 10, 11, 14, 15, 20, 21, 24, 25, 28, 29, 32 and 33 in Table A. Each may be a mixture which is enriched for the cis or trans isomer respectively.

In one embodiment of the invention component B is a compound selected from
pymetrozine;
an organophosphate selected from the group consisting of sulprofos, acephate, methyl parathion, azinphos-methyl, demeton-s-methyl, heptenophos, thiometon, fenamiphos, monocrotophos, profenofos, triazophos, methamidophos, dimethoate, phosphamidon, malathion, chlorpyrifos, phosalone, terbufos, fensulfothion, fonofos, phorate, phoxim, pirimiphos-methyl, pirimiphos-ethyl, fenitrothion, fosthiazate and diazinon;
a pyrethroid selected from the group consisting of permethrin, cypermethrin, fenvalerate, esfenvalerate, deltamethrin, cyhalothrin, lambda-cyhalothrin, gamma-cyhalothrin, bifenthrin, fenpropathrin, cyfluthrin, tefluthrin, ethofenprox, natural pyrethrin, tetramethrin, S-bioallethrin, fenfluthrin, prallethrin and 5-benzyl-3-furylmethyl-(E)-(1R,3S)-2,2-dimethyl-3-(2-oxothiolan-3-ylidenemethyl)cyclopropane carboxylate;
a macrolide selected from the group consisting of abamectin, emamectin benzoate, ivermectin, milbemycin, spinosad, azadirachtin and spinetoram;
a diamide selected from the group consisting of flubendiamide, chlorantraniliprole (Rynaxypyr®) and cyantraniliprole;
a neonicotinoid compound selected from the group consisting of imidacloprid, thiacloprid, acetamiprid, nitenpyram, dinotefuran, thiamethoxam, clothianidin, nithiazine and flonicamid;
spirotetramat, spirodiclofen and spiromesifen; and
sulfoxaflor, lufeneron, diafenthiuron, and fipronil.

Preferably component B is a compound selected from the group consisting of abamectin, chlorpyrifos, cyantraniliprole, emamectin, lambda cyhalothrin, pymetrozine, spirotetramat, thiamethoxam, clothianidin, imidacloprid, chlorantraniliprole, flonicamid. sulfoxaflor, lufeneron, diafenthiuron, flubendiamide, tefluthrin, and fipronil. More preferably component B is a compound selected from the group consisting of abamectin, chlorpyrifos, cyantraniliprole, emamectin, lambda cyhalothrin, pymetrozine, spirotetramat, thiamethoxam, clothianidin, imidacloprid and flonicamid.

In one embodiment component B is a compound selected from the group consisting of abamectin, chlorpyrifos, cyantraniliprole, emamectin, lambda cyhalothrin, pymetrozine, spirotetramat, thiamethoxam, clothianidin, imidacloprid and chlorantraniliprole. In another embodiment component B is a compound selected from the group consisting of abamectin, chlorpyrifos, cyantraniliprole, emamectin, lambda cyhalothrin, pymetrozine, spirotetramat, and thiamethoxam.

The invention also includes the following combinations:

A mixture of a compound from Table A and abamectin.

A mixture of a compound from Table A and chlorpyrifos.

A mixture of a compound from Table A and cyantraniliprole.

A mixture of a compound from Table A and emamectin.

A mixture of a compound from Table A and cyhalothrin.

A mixture of a compound from Table A and lambda cyhalothrin.

A mixture of a compound from Table A and gamma cyhalothrin.

A mixture of a compound from Table A and pymetrozine.

A mixture of a compound from Table A and spirotetramat.

A mixture of a compound from Table A and thiamethoxam.

A mixture of a compound from Table A and chlorantraniliprole.

A mixture of a compound from Table A and profenofos.

A mixture of a compound from Table A and acephate.

A mixture of a compound from Table A and azinphos-methyl.

A mixture of a compound from Table A and methamidophos.

A mixture of a compound from Table A and spinosad.

A mixture of a compound from Table A and spinetoram.

A mixture of a compound from Table A and flonicamid.

A mixture of a compound from Table A and indoxacarb.

A mixture of a compound from Table A and spirodiclofen.

A mixture of a compound from Table A and spiromesifen.

A mixture of a compound from Table A and sulfoxaflor.

A mixture of a compound from Table A and fipronil.

A mixture of a compound from Table A and imidacloprid.

A mixture of a compound from Table A and thiacloprid.

A mixture of a compound from Table A and acetamiprid.

A mixture of a compound from Table A and nitenpyram.

A mixture of a compound from Table A and dinotefuran.

A mixture of a compound from Table A and clothianidin.

A mixture of a compound from Table A and nithiazine.

A mixture of a compound from Table A and pyriproxyfen.

A mixture of a compound from Table A and buprofezin.

A mixture of a compound from Table A and pyrifluqinazon.

A mixture of a compound from Table A, thiamethoxam and cyantraniliprole.

A mixture of a compound from Table A, thiamethoxam and chlorantraniliprole.

A mixture of a compound from Table A and sulfoxaflor.

A mixture of a compound from Table A and Lufeneron.

A mixture of a compound from Table A and Diafenthiuron.

A mixture of a compound from Table A and Flubendiamide.

A mixture of a compound from Table A and Tefluthrin.

A mixture of a compound from Table A and Fipronil.

The present invention also relates to a method of controlling insects, acarines, nematodes or molluscs which comprises applying to a pest, to a locus of a pest, or to a plant susceptible to attack by a pest a combination of components A and B; seeds comprising a mixture of components A and B; and a method comprising coating a seed with a mixture of components A and B.

Components A and B may be provided and/or used in amounts such that they are capable of synergistic pest control. For example, For example, the present invention includes pesticidal mixtures comprising a component A and a component B in a synergistically effective amount; agricultural compositions comprising a mixture of component A and B in a synergistically effective amount; the use of a mixture of component A and B in a synergistically effective amount for combating animal pests; a method of combating animal pests which comprises contacting the animal pests, their habit, breeding ground, food supply, plant, seed, soil, area, material or environment in which the animal pests are growing or may grow, or the materials, plants, seeds, soils, surfaces or spaces to be protected from animal attack or infestation with a mixture of component A and B in a synergistically effective amount; a method for protecting crops from attack or infestation by animal pests which comprises contacting a crop with a mixture of component A and B in a synergistically effective amount; a method for the protection of seeds from soil insects and of the seedlings' roots and shoots from soil and foliar insects comprising contacting the seeds before sowing and/or after pre-germination with a mixture of component A and B in a synergistically effective amount; seeds comprising, e.g. coated with, a mixture of component A and B in a synergistically effective amount; a method comprising coating a seed with a mixture of component A and B in a synergistically effective amount; a method of controlling insects, acarines, nematodes or molluscs which comprises applying to a pest, to a locus of a pest, or to a plant susceptible to attack by a pest a combination of components A and B in a synergistically effective amount. Mixtures of A and B will normally be applied in an insecticidally, acaricidally, nematicidally or molluscicidally effective amount. In application components A and B may be applied simultaneously or separately.

The mixtures of the present invention can be used to control infestations of insect pests such as Lepidoptera, Diptera, Hemiptera, Thysanoptera, Orthoptera, Dictyoptera, Coleoptera, Siphonaptera, Hymenoptera and Isoptera and also other invertebrate pests, for example, acarine, nematode and mollusc pests. Insects, acarines, nematodes and molluscs are herein collectively referred to as pests. The pests which may be controlled by the use of the invention compounds include those pests associated with agriculture (which term includes the growing of crops for food and fiber products), horticulture and animal husbandry, companion animals, forestry and the storage of products of vegetable origin (such as fruit, grain and timber); those pests associated with the damage of man-made structures and the transmission of diseases of man and animals; and also nuisance pests (such as flies). The mixtures of the invention are particularly effective against insects, acarines and/or nematodes.

According to the invention “useful plants” typically comprise the following species of plants: grape vines; cereals, such as wheat, barley, rye or oats; beet, such as sugar beet or fodder beet; fruits, such as pomes, stone fruits or soft fruits, for example apples, pears, plums, peaches, almonds, cherries, strawberries, raspberries or blackberries; leguminous plants, such as beans, lentils, peas or soybeans; oil plants, such as rape, mustard, poppy, olives, sunflowers, coconut, castor oil plants, cocoa beans or groundnuts; cucumber plants, such as marrows, cucumbers or melons; fibre plants, such as cotton, flax, hemp or jute; citrus fruit, such as oranges, lemons, grapefruit or mandarins; vegetables, such as spinach, lettuce, asparagus, cabbages, carrots, onions, tomatoes, potatoes, cucurbits or paprika; lauraceae, such as avocados, cinnamon or camphor; maize; tobacco; nuts; coffee; sugar cane; tea; vines; hops; durian; bananas; natural rubber plants; turf or ornamentals, such as flowers, shrubs, broad-leaved trees or evergreens, for example conifers. This list does not represent any limitation.

The term “useful plants” is to be understood as including also useful plants that have been rendered tolerant to herbicides like bromoxynil or classes of herbicides (such as, for example, HPPD inhibitors, ALS inhibitors, for example primisulfuron, prosulfuron and trifloxysulfuron, EPSPS (5-enol-pyrovyl-shikimate-3-phosphate-synthase) inhibitors, GS (glutamine synthetase) inhibitors) as a result of conventional methods of breeding or genetic engineering. An example of a crop that has been rendered tolerant to imidazolinones, e.g. imazamox, by conventional methods of breeding (mutagenesis) is Clearfield® summer rape (Canola). Examples of crops that have been rendered tolerant to herbicides or classes of herbicides by genetic engineering methods include glyphosate- and glufosinate-resistant maize varieties commercially available under the trade names RoundupReady®, Herculex I® and LibertyLink®.

The term “useful plants” is to be understood as including also useful plants which have been so transformed by the use of recombinant DNA techniques that they are capable of synthesising one or more selectively acting toxins, such as are known, for example, from toxin-producing bacteria, especially those of the genus Bacillus.

Toxins that can be expressed by such transgenic plants include, for example, insecticidal proteins, for example insecticidal proteins from Bacillus cereus or Bacillus popliae; or insecticidal proteins from Bacillus thuringiensis, such as δ-endotoxins, e.g. CryIA(b), CryIA(c), CryIF, CryIF(a2), CryIIA(b), CryIIIA, CryIIIB(b1) or Cry9c, or vegetative insecticidal proteins (VIP), e.g. VIP1, VIP2, VIP3 or VIP3A; or insecticidal proteins of bacteria colonising nematodes, for example Photorhabdus spp. or Xenorhabdus spp., such as Photorhabdus luminescens, Xenorhabdus nematophilus; toxins produced by animals, such as scorpion toxins, arachnid toxins, wasp toxins and other insect-specific neurotoxins; toxins produced by fungi, such as Streptomycetes toxins, plant lectins, such as pea lectins, barley lectins or snowdrop lectins; agglutinins; proteinase inhibitors, such as trypsine inhibitors, serine protease inhibitors, patatin, cystatin, papain inhibitors; ribosome-inactivating proteins (RIP), such as ricin, maize-RIP, abrin, luffin, saporin or bryodin; steroid metabolism enzymes, such as 3-hydroxysteroidoxidase, ecdysteroid-UDP-glycosyl-transferase, cholesterol oxidases, ecdysone inhibitors, HMG-COA-reductase, ion channel blockers, such as blockers of sodium or calcium channels, juvenile hormone esterase, diuretic hormone receptors, stilbene synthase, bibenzyl synthase, chitinases and glucanases.

In the context of the present invention there are to be understood by δ-endotoxins, for example CryIA(b), CryIA(c), CryIF, CryIF(a2), CryIIA(b), CryIIIA, CryIIIB(b1) or Cry9c, or vegetative insecticidal proteins (VIP), for example VIP1, VIP2, VIP3 or VIP3A, expressly also hybrid toxins, truncated toxins and modified toxins. Hybrid toxins are produced recombinantly by a new combination of different domains of those proteins (see, for example, WO 02/15701). An example for a truncated toxin is a truncated CryIA(b), which is expressed in the Btl 1 maize from Syngenta Seed SAS, as described below. In the case of modified toxins, one or more amino acids of the naturally occurring toxin are replaced. In such amino acid replacements, preferably non-naturally present protease recognition sequences are inserted into the toxin, such as, for example, in the case of CryIIIA055, a cathepsin-D-recognition sequence is inserted into a CryIIIA toxin (see WO 03/018810)

Examples of such toxins or transgenic plants capable of synthesising such toxins are disclosed, for example, in EP-A-0 374 753, WO 93/07278, WO 95/34656, EP-A-0 427 529, EP-A-451 878 and WO 03/052073.

The processes for the preparation of such transgenic plants are generally known to the person skilled in the art and are described, for example, in the publications mentioned above. CryI-type deoxyribonucleic acids and their preparation are known, for example, from WO 95/34656, EP-A-0 367 474, EP-A-0 401 979 and WO 90/13651.

The toxin contained in the transgenic plants imparts to the plants tolerance to harmful insects. Such insects can occur in any taxonomic group of insects, but are especially commonly found in the beetles (Coleoptera), two-winged insects (Diptera) and butterflies (Lepidoptera).

Transgenic plants containing one or more genes that code for an insecticidal resistance and express one or more toxins are known and some of them are commercially available. Examples of such plants are: YieldGard® (maize variety that expresses a CryIA(b) toxin); YieldGard Rootworm® (maize variety that expresses a CryIIIB(b1) toxin); YieldGard Plus® (maize variety that expresses a CryIA(b) and a CryIIIB(b1) toxin); Starlink® (maize variety that expresses a Cry9(c) toxin); Herculex I® (maize variety that expresses a CryIF(a2) toxin and the enzyme phosphinothricine N-acetyltransferase (PAT) to achieve tolerance to the herbicide glufosinate ammonium); NuCOTN 33B® (cotton variety that expresses a CryIA(c) toxin); Bollgard I® (cotton variety that expresses a CryIA(c) toxin); Bollgard II® (cotton variety that expresses a CryIA(c) and a CryIIA(b) toxin); VIPCOT® (cotton variety that expresses a VIP toxin); NewLeaf® (potato variety that expresses a CryIIIA toxin); NatureGard® and Protecta®.

Further examples of such transgenic crops are:

1. Btl1 Maize from Syngenta Seeds SAS, Chemin de l'Hobit 27, F-31 790 St. Sauveur, France, registration number C/FR/96/05/10. Genetically modified Zea mays which has been rendered resistant to attack by the European corn borer (Ostrinia nubilalis and Sesamia nonagrioides) by transgenic expression of a truncated CryIA(b) toxin. Btl1 maize also transgenically expresses the enzyme PAT to achieve tolerance to the herbicide glufosinate ammonium.
2. Bt176 Maize from Syngenta Seeds SAS, Chemin de l'Hobit 27, F-31 790 St. Sauveur, France, registration number C/FR/96/05/10. Genetically modified Zea mays which has been rendered resistant to attack by the European corn borer (Ostrinia nubilalis and Sesamia nonagrioides) by transgenic expression of a CryIA(b) toxin. Bt176 maize also transgenically expresses the enzyme PAT to achieve tolerance to the herbicide glufosinate ammonium.
3. MIR604 Maize from Syngenta Seeds SAS, Chemin de l'Hobit 27, F-31 790 St. Sauveur, France, registration number C/FR/96/05/10. Maize which has been rendered insect-resistant by transgenic expression of a modified CryIIIA toxin. This toxin is Cry3A055 modified by insertion of a cathepsin-D-protease recognition sequence. The preparation of such transgenic maize plants is described in WO 03/018810.
4. MON 863 Maize from Monsanto Europe S.A. 270-272 Avenue de Tervuren, B-1150 Brussels, Belgium, registration number C/DE/02/9. MON 863 expresses a CryIIIB(b1) toxin and has resistance to certain Coleoptera insects.
5. IPC 531 Cotton from Monsanto Europe S.A. 270-272 Avenue de Tervuren, B-1150 Brussels, Belgium, registration number C/ES/96/02.
6. 1507 Maize from Pioneer Overseas Corporation, Avenue Tedesco, 7 B-1160 Brussels, Belgium, registration number C/NL/00/10. Genetically modified maize for the expression of the protein CryI F for achieving resistance to certain Lepidoptera insects and of the PAT protein for achieving tolerance to the herbicide glufosinate ammonium.
7. NK603×MON 810 Maize from Monsanto Europe S.A. 270-272 Avenue de Tervuren, B-1150 Brussels, Belgium, registration number C/GB/02/M3/03. Consists of conventionally bred hybrid maize varieties by crossing the genetically modified varieties NK603 and MON 810. NK603×MON 810 Maize transgenically expresses the protein CP4 EPSPS, obtained from Agrobacterium sp. strain CP4, which imparts tolerance to the herbicide Roundup® (contains glyphosate), and also a CryIA(b) toxin obtained from Bacillus thuringiensis subsp. kurstaki which brings about tolerance to certain Lepidoptera, include the European corn borer.

Transgenic crops of insect-resistant plants are also described in BATS (Zentrum für Biosicherheit and Nachhaltigkeit, Zentrum BATS, Clarastrasse 13, 4058 Basel, Switzerland) Report 2003, (http://bats.ch).

The term “useful plants” is to be understood as including also useful plants which have been so transformed by the use of recombinant DNA techniques that they are capable of synthesising antipathogenic substances having a selective action, such as, for example, the so-called “pathogenesis-related proteins” (PRPs, see e.g. EP-A-0 392 225). Examples of such antipathogenic substances and transgenic plants capable of synthesising such antipathogenic substances are known, for example, from EP-A-0 392 225, WO 95/33818, and EP-A-0 353 191. The methods of producing such transgenic plants are generally known to the person skilled in the art and are described, for example, in the publications mentioned above.

Antipathogenic substances which can be expressed by such transgenic plants include, for example, ion channel blockers, such as blockers for sodium and calcium channels, for example the viral KP1, KP4 or KP6 toxins; stilbene synthases; bibenzyl synthases; chitinases; glucanases; the so-called “pathogenesis-related proteins” (PRPs; see e.g. EP-A-0 392 225); antipathogenic substances produced by microorganisms, for example peptide antibiotics or heterocyclic antibiotics (see e.g. WO 95/33818) or protein or polypeptide factors involved in plant pathogen defence (so-called “plant disease resistance genes”, as described in WO 03/000906).

Useful plants of elevated interest in connection with present invention are cereals; soybean; rice; oil seed rape; pome fruits; stone fruits; peanuts; coffee; tea; strawberries; turf; vines and vegetables, such as tomatoes, potatoes, cucurbits and lettuce.

The term “locus” of a useful plant as used herein is intended to embrace the place on which the useful plants are growing, where the plant propagation materials of the useful plants are sown or where the plant propagation materials of the useful plants will be placed into the soil. An example for such a locus is a field, on which crop plants are growing.

The term “plant propagation material” is understood to denote generative parts of a plant, such as seeds, which can be used for the multiplication of the latter, and vegetative material, such as cuttings or tubers, for example potatoes. There may be mentioned for example seeds (in the strict sense), roots, fruits, tubers, bulbs, rhizomes and parts of plants. Germinated plants and young plants which are to be transplanted after germination or after emergence from the soil, may also be mentioned. These young plants may be protected before transplantation by a total or partial treatment by immersion. Preferably “plant propagation material” is understood to denote seeds. Insecticides that are of particular interest for treating seeds include thiamethoxam, imidacloprid and clothianidin. Accordingly, in one embodiment component B is selected from thiamethoxam, imidacloprid and clothianidin.

A further aspect of the instant invention is a method of protecting natural substances of plant and/or animal origin, which have been taken from the natural life cycle, and/or their processed forms against attack of pests, which comprises applying to said natural substances of plant and/or animal origin or their processed forms a combination of components A and B in a synergistically effective amount.

According to the instant invention, the term “natural substances of plant origin, which have been taken from the natural life cycle” denotes plants or parts thereof which have been harvested from the natural life cycle and which are in the freshly harvested form. Examples of such natural substances of plant origin are stalks, leafs, tubers, seeds, fruits or grains. According to the instant invention, the term “processed form of a natural substance of plant origin” is understood to denote a form of a natural substance of plant origin that is the result of a modification process. Such modification processes can be used to transform the natural substance of plant origin in a more storable form of such a substance (a storage good). Examples of such modification processes are pre-drying, moistening, crushing, comminuting, grounding, compressing or roasting. Also falling under the definition of a processed form of a natural substance of plant origin is timber, whether in the form of crude timber, such as construction timber, electricity pylons and barriers, or in the form of finished articles, such as furniture or objects made from wood.

According to the instant invention, the term “natural substances of animal origin, which have been taken from the natural life cycle and/or their processed forms” is understood to denote material of animal origin such as skin, hides, leather, furs, hairs and the like.

A preferred embodiment is a method of protecting natural substances of plant origin, which have been taken from the natural life cycle, and/or their processed forms against attack of pests, which comprises applying to said natural substances of plant and/or animal origin or their processed forms a combination of components A and B in a synergistically effective amount.

A further preferred embodiment is a method of protecting fruits, preferably pomes, stone fruits, soft fruits and citrus fruits, which have been taken from the natural life cycle, and/or their processed forms, which comprises applying to said fruits and/or their processed forms a combination of components A and B in a synergistically effective amount.

The combinations according to the present invention are furthermore particularly effective against the following pests: Myzus persicae (aphid), Aphis gossypii (aphid), Aphis fabae (aphid), Lygus spp. (capsids), Dysdercus spp. (capsids), Nilaparvata lugens (planthopper), Nephotettixc incticeps (leafhopper), Nezara spp. (stinkbugs), Euschistus spp. (stinkbugs), Leptocorisa spp. (stinkbugs), Frankliniella occidentalis (thrip), Thrips spp. (thrips), Leptinotarsa decemlineata (Colorado potato beetle), Anthonomus grandis (boll weevil), Aonidiella spp. (scale insects), Trialeurodes spp. (white flies), Bemisia tabaci (white fly), Ostrinia nubilalis (European corn borer), Spodoptera littoralis (cotton leafworm), Heliothis virescens (tobacco budworm), Helicoverpa armigera (cotton bollworm), Helicoverpa zea (cotton bollworm), Sylepta derogata (cotton leaf roller), Pieris brassicae (white butterfly), Plutella xylostella (diamond back moth), Agrotis spp. (cutworms), Chilo suppressalis (rice stem borer), Locusta migratoria (locust), Chortiocetes terminifera (locust), Diabrotica spp. (rootworms), Panonychus ulmi (European red mite), Panonychus citri (citrus red mite), Tetranychus urticae (two-spotted spider mite), Tetranychus cinnabarinus (carmine spider mite), Phyllocoptruta oleivora (citrus rust mite), Polyphagotarsonemus latus (broad mite), Brevipalpus spp. (flat mites), Boophilus microplus (cattle tick), Dermacentor variabilis (American dog tick), Ctenocephalides felis (cat flea), Liriomyza spp. (leafminer), Musca domestica (housefly), Aedes aegypti (mosquito), Anopheles spp. (mosquitoes), Culex spp. (mosquitoes), Lucillia spp. (blowflies), Blattella germanica (cockroach), Periplaneta americana (cockroach), Blatta orientalis (cockroach), termites of the Mastotermitidae (for example Mastotermes spp.), the Kalotermitidae (for example Neotermes spp.), the Rhinotermitidae (for example Coptotermes formosanus, Reticulitermes flavipes, R. speratu, R. virginicus, R. hesperus, and R. santonensis) and the Termitidae (for example Globitermes sulfureus), Solenopsis geminata (fire ant), Monomorium pharaonis (pharaoh's ant), Damalinia spp. and Linognathus spp. (biting and sucking lice), Meloidogyne spp. (root knot nematodes), Globodera spp. and Heterodera spp. (cyst nematodes), Pratylenchus spp. (lesion nematodes), Rhodopholus spp. (banana burrowing nematodes), Tylenchulus spp. (citrus nematodes), Haemonchus contortus (barber pole worm), Caenorhabditis elegans (vinegar eelworm), Trichostrongylus spp. (gastro intestinal nematodes) and Deroceras reticulatum (slug).

The mixtures of the invention may be used for pest control on various plants, including soybean, corn, sugarcane, alfalfa, brassicas, oilseed rape (e.g. canola), potatoes (including sweet potatoes), cotton, rice, coffee, citrus, almonds, fruiting vegetables (e.g. tomatoes, pepper, chili, eggplant, cucumber, squash etc.), tea, bulb vegetables (e.g. onion, leek etc.), grapes, pome fruit (e.g. apples, pears etc.), and stone fruit (e.g. pears, plums etc.).

The mixtures of the invention may be used on soybean to control, for example, Elasmopalpus lignosellus, Diloboderus abderus, Diabrotica speciosa, Sternechus subsignatus, Formicidae, Agrotis ypsilon, Julus sspp., Anticarsia gemmatalis, Megascelis ssp., Procornitermes ssp., Gryllotalpidae, Nezara viridula, Piezodorus spp., Acrosternum spp., Neomegalotomus spp., Cerotoma trifurcata, Popillia japonica, Edessa spp., Liogenys fuscus, Euchistus heros, stalk borer, Scaptocoris castanea, phyllophaga spp., Pseudoplusia includens, Spodoptera spp., Bemisia tabaci, Agriotes spp. The mixtures of the invention are preferably used on soybean to control Diloboderus abderus, Diabrotica speciosa, Nezara viridula, Piezodorus spp., Acrosternum spp., Cerotoma trifurcata, Popillia japonica, Euchistus heros, phyllophaga spp., Agriotes sp

The mixtures of the invention may be used on corn to control, for example, Euchistus heros, Dichelops furcatus, Diloboderus abderus, Elasmopalpus lignosellus, Spodoptera frugiperda, Nezara viridula, Cerotoma trifurcata, Popillia japonica, Agrotis ypsilon, Diabrotica speciosa, Heteroptera, Procornitermes ssp., Scaptocoris castanea, Formicidae, Julus ssp., Dalbulus maidis, Diabrotica virgifera, Mocis latipes, Bemisia tabaci, heliothis spp., Tetranychus spp., thrips spp., phyllophaga spp., scaptocoris spp., Liogenys fuscus, Spodoptera spp., Ostrinia spp., Sesamia spp., Agriotes spp. The mixtures of the invention are preferably used on corn to control Euchistus heros, Dichelops furcatus, Diloboderus abderus, Nezara viridula, Cerotoma trifurcata, Popillia japonica, Diabrotica speciosa, Diabrotica virgifera, Tetranychus spp., thrips spp., phyllophaga spp., scaptocoris spp., Agriotes spp.

The mixtures of the invention may be used on sugar cane to control, for example, Sphenophorus spp., termites, Mahanarva spp. The mixtures of the invention are preferably used on sugar cane to control termites, Mahanarva spp.

The mixtures of the invention may be used on alfalfa to control, for example, Hypera brunneipennis, Hypera postica, Colias eurytheme, Collops spp., Empoasca solana, Epitrix, Geocoris spp., Lygus hesperus, Lygus lineolaris, Spissistilus spp., Spodoptera spp., Trichoplusia ni. The mixtures of the invention are preferably used on alfalfa to control Hypera brunneipennis, Hypera postica, Empoasca solana, Epitrix, Lygus hesperus, Lygus lineolaris, Trichoplusia ni.

The mixtures of the invention may be used on brassicas to control, for example, Plutella xylostella, Pieris spp., Mamestra spp., Plusia spp., Trichoplusia ni, Phyllotreta spp., Spodoptera spp., Empoasca solana, thrips spp., Spodoptera spp., Delia spp. The mixtures of the invention are preferably used on brassicas to control Plutella xylostella Pieris spp., Plusia spp., Trichoplusia ni, Phyllotreta spp., thrips sp

The mixtures of the invention may be used on oil seed rape, e.g. canola, to control, for example, Meligethes spp., Ceutorhynchus napi, Psylloides spp.

The mixtures of the invention may be used on potatoes, including sweet potatoes, to control, for example, Empoasca spp., Leptinotarsa spp., Diabrotica speciosa, Phthorimaea spp., Paratrioza spp., Maladera matrida, Agriotes spp. The mixtures of the invention are preferably used on potatoes, including sweet potatoes, to control Empoasca spp., Leptinotarsa spp., Diabrotica speciosa, Phthorimaea spp., Paratrioza spp., Agriotes spp.

The mixtures of the invention may be used on cotton to control, for example, Anthonomus grandis, Pectinophora spp., heliothis spp., Spodoptera spp., Tetranychus spp., Empoasca spp., thrips spp., Bemisia tabaci, Lygus spp., phyllophaga spp., Scaptocoris spp. The mixtures of the invention are preferably used on cotton to control Anthonomus grandis, Tetranychus spp., Empoasca spp., thrips spp., Lygus spp., phyllophaga spp., Scaptocoris spp.

The mixtures of the invention may be used on rice to control, for example, Leptocorisa spp., Cnaphalocrosis spp., Chilo spp., Scirpophaga spp., Lissorhoptrus spp., Oebalus pugnax. The mixtures of the invention are preferably used on rice to control Leptocorisa spp., Lissorhoptrus spp., Oebalus pugnax.

The mixtures of the invention may be used on coffee to control, for example, Hypothenemus Hampei, Perileucoptera Coffeella, Tetranychus spp. The mixtures of the invention are preferably used on coffee to control Hypothenemus Hampei, Perileucoptera Coffeella.

The mixtures of the invention may be used on citrus to control, for example, Panonychus citri, Phyllocoptruta oleivora, Brevipalpus spp., Diaphorina citri, Scirtothrips spp., thrips spp., Unaspis spp., Ceratitis capitata, Phyllocnistis spp. The mixtures of the invention are preferably used on citrus to control Panonychus citri, Phyllocoptruta oleivora, Brevipalpus spp., Diaphorina citri, Scirtothrips spp., thrips spp., Phyllocnistis spp.

The mixtures of the invention may be used on almonds to control, for example, Amyelois transitella, Tetranychus spp.

The mixtures of the invention may be used on fruiting vegetable, including tomatoes, pepper, chili, eggplant, cucumber, squash etc, to control thrips spp., Tetranychus spp., Polyphagotarsonemus spp., Aculops spp., Empoasca spp., Spodoptera spp., heliothis spp., Tuta absoluta, Liriomyza spp., Bemisia tabaci, Trialeurodes spp., Paratrioza spp., Frankliniella occidentalis, Frankliniella spp., Anthonomus spp., Phyllotreta spp., Amrasca spp., Epilachna spp., Halyomorpha spp., Scirtothrips spp., Leucinodes spp., Neoleucinodes spp. The mixtures of the invention are preferably used on fruiting vegetable, including tomatoes, pepper, chili, eggplant, cucumber, squash etc, to control, for example, thrips spp., Tetranychus spp., Polyphagotarsonemus spp., Aculops spp., Empoasca spp., Spodoptera spp., heliothis spp., Tuta absoluta, Liriomyza spp., Paratrioza spp., Frankliniella occidentalis, Frankliniella spp., Amrasca spp., Scirtothrips spp., Leucinodes spp., Neoleucinodes spp.

The mixtures of the invention may be used on tea to control, for example, Pseudaulacaspis spp., Empoasca spp., Scirtothrips spp., Caloptilia theivora. The mixtures of the invention are prefrerably used on tea to control Empoasca spp., Scirtothrips spp.

The mixtures of the invention may be used on bulb vegetables, including onion, leek etc to control, for example, thrips spp., Spodoptera spp., heliothis spp. The mixtures of the invention are preferably used on bulb vegetables, including onion, leek etc to control thrips spp.

The mixtures of the invention may be used on grapes to control, for example, Empoasca spp., Lobesia spp., Frankliniella spp., thrips spp., Tetranychus spp., Rhipiphorothrips Cruentatus, Eotetranychus Willamettei, Erythroneura Elegantula, Scaphoides spp. The mixtures of the invention are preferably used on grapes to control Frankliniella spp., thrips spp., Tetranychus spp., Rhipiphorothrips Cruentatus, Scaphoides spp.

The mixtures of the invention may be used on pome fruit, including apples, pairs etc, to control, for example, Cacopsylla spp., Psylla spp., Panonychus ulmi, Cydia pomonella. The mixtures of the invention are preferably used on pome fruit, including apples, pairs etc, to control Cacopsylla spp., Psylla spp., Panonychus ulmi.

The mixtures of the invention may be used on stone fruit to control, for example, Grapholita molesta, Scirtothrips spp., thrips spp., Frankliniella spp., Tetranychus spp. The mixtures of the invention are preferably used on stone fruit to control Scirtothrips spp., thrips spp., Frankliniella spp., Tetranychus spp.

The amount of a combination of the invention to be applied, will depend on various factors, such as the compounds employed; the subject of the treatment, such as, for example plants, soil or seeds; the type of treatment, such as, for example spraying, dusting or seed dressing; the purpose of the treatment, such as, for example prophylactic or therapeutic; the type of pest to be controlled or the application time.

The mixtures comprising a compound of formula I, e.g. those selected from table A, and one or more active ingredients as described above can be applied, for example, in a single “ready-mix” form, in a combined spray mixture composed from separate formulations of the single active ingredient components, such as a “tank-mix”, and in a combined use of the single active ingredients when applied in a sequential manner, i.e. one after the other with a reasonably short period, such as a few hours or days. The order of applying the compounds of formula I selected from table A and the active ingredients as described above is not essential for working the present invention.

The synergistic activity of the combination is apparent from the fact that the pesticidal activity of the composition of A+B is greater than the sum of the pesticidal activities of A and B.

The method of the invention comprises applying to the useful plants, the locus thereof or propagation material thereof in admixture or separately, a synergistically effective aggregate amount of a component A and a component B.

Some of said combinations according to the invention have a systemic action and can be used as foliar, soil and seed treatment pesticides.

With the combinations according to the invention it is possible to inhibit or destroy the pests which occur in plants or in parts of plants (fruit, blossoms, leaves, stems, tubers, roots) in different useful plants, while at the same time the parts of plants which grow later are also protected from attack by pests.

The combinations of the present invention are of particular interest for controlling pests in various useful plants or their seeds, especially in field crops such as potatoes, tobacco and sugarbeets, and wheat, rye, barley, oats, rice, maize, lawns, cotton, soybeans, oil seed rape, pulse crops, sunflower, coffee, sugarcane, fruit and ornamentals in horticulture and viticulture, in vegetables such as cucumbers, beans and cucurbits.

The combinations according to the invention are applied by treating the pests, the useful plants, the locus thereof, the propagation material thereof, the natural substances of plant and/or animal origin, which have been taken from the natural life cycle, and/or their processed forms, or the industrial materials threatened by pests, attack with a combination of components A and B in a synergistically effective amount.

The combinations according to the invention may be applied before or after infection or contamination of the useful plants, the propagation material thereof, the natural substances of plant and/or animal origin, which have been taken from the natural life cycle, and/or their processed forms, or the industrial materials by the pests.

The combinations according to the invention can be used for controlling, i.e. containing or destroying, pests of the abovementioned type which occur on useful plants in agriculture, in horticulture and in forests, or on organs of useful plants, such as fruits, flowers, foliage, stalks, tubers or roots, and in some cases even on organs of useful plants which are formed at a later point in time remain protected against these pests.

When applied to the useful plants the compound of formula I is generally applied at a rate of 1 to 500 g a.i./ha in association with 1 to 2000 g a.i./ha, of a compound of component B, depending on the class of chemical employed as component B.

Generally for plant propagation material, such as seed treatment, application rates can vary from 0.001 to 10 g/kg of seeds of active ingredients. When the combinations of the present invention are used for treating seed, rates of 0.001 to 5 g of a compound of formula I per kg of seed, preferably from 0.01 to 1 g per kg of seed, and 0.001 to 5 g of a compound of component B, per kg of seed, preferably from 0.01 to 1 g per kg of seed, are generally sufficient.

The weight ratio of A to B may generally be between 1000:1 and 1:1000. In other embodiments that weight ratio of A to B may be between 500:1 to 1:500, for example between 100:1 to 1:100, for example between 1:50 to 50:1, for example 1:20 to 20:1. Other embodiments of weight ratios of component (B) to component (A) range from 500:1 to 1:250, with one embodiment being from 200:1 to 1:150, another embodiment being from 150:1 to 1:50 and another embodiment being from 50:1 to 1:10. Also of note are weight ratios of component (B) to component (A) which range from 450:1 to 1:300, with one embodiment being from 150:1 to 1:100, another embodiment being from 30:1 to 1:25 and another embodiment being from 10:1 to 1:10.

The invention also provides pesticidal mixtures comprising a combination of components A and B as mentioned above in a synergistically effective amount, together with an agriculturally acceptable carrier, and optionally a surfactant.

Spodoptera preferably means Spodoptera littoralis. Heliothis preferably means Heliothis virescens. Tetranychus preferably means Tetranychus urticae.

The compositions of the invention may be employed in any conventional form, for example in the form of a twin pack, a powder for dry seed treatment (DS), an emulsion for seed treatment (ES), a flowable concentrate for seed treatment (FS), a solution for seed treatment (LS), a water dispersible powder for seed treatment (WS), a capsule suspension for seed treatment (CF), a gel for seed treatment (GF), an emulsion concentrate (EC), a suspension concentrate (SC), a suspo-emulsion (SE), a capsule suspension (CS), a water dispersible granule (WG), an emulsifiable granule (EG), an emulsion, water in oil (EO), an emulsion, oil in water (EW), a micro-emulsion (ME), an oil dispersion (OD), an oil miscible flowable (OF), an oil miscible liquid (OL), a soluble concentrate (SL), an ultra-low volume suspension (SU), an ultra-low volume liquid (UL), a technical concentrate (TK), a dispersible concentrate (DC), a wettable powder (WP), a soluble granule (SG) or any technically feasible formulation in combination with agriculturally acceptable adjuvants.

Such compositions may be produced in conventional manner, e.g. by mixing the active ingredients with appropriate formulation inerts (diluents, solvents, fillers and optionally other formulating ingredients such as surfactants, biocides, anti-freeze, stickers, thickeners and compounds that provide adjuvancy effects). Also conventional slow release formulations may be employed where long lasting efficacy is intended. Particularly formulations to be applied in spraying forms, such as water dispersible concentrates (e.g. EC, SC, DC, OD, SE, EW, EO and the like), wettable powders and granules, may contain surfactants such as wetting and dispersing agents and other compounds that provide adjuvancy effects, e.g. the condensation product of formaldehyde with naphthalene sulphonate, an alkylarylsulphonate, a lignin sulphonate, a fatty alkyl sulphate, and ethoxylated alkylphenol and an ethoxylated fatty alcohol.

A seed dressing formulation is applied in a manner known per se to the seeds employing the combination of the invention and a diluent in suitable seed dressing formulation form, e.g. as an aqueous suspension or in a dry powder form having good adherence to the seeds. Such seed dressing formulations are known in the art. Seed dressing formulations may contain the single active ingredients or the combination of active ingredients in encapsulated form, e.g. as slow release capsules or microcapsules. A typical a tank-mix formulation for seed treatment application comprises 0.25 to 80%, especially 1 to 75%, of the desired ingredients, and 99.75 to 20%, especially 99 to 25%, of a solid or liquid auxiliaries (including, for example, a solvent such as water), where the auxiliaries can be a surfactant in an amount of 0 to 40%, especially 0.5 to 30%, based on the tank-mix formulation. A typical pre-mix formulation for seed treatment application comprises 0.5 to 99.9%, especially 1 to 95%, of the desired ingredients, and 99.5 to 0.1%, especially 99 to 5%, of a solid or liquid adjuvant (including, for example, a solvent such as water), where the auxiliaries can be a surfactant in an amount of 0 to 50%, especially 0.5 to 40%, based on the pre-mix formulation.

In general, the formulations include from 0.01 to 90% by weight of active agent, from 0 to 20% agriculturally acceptable surfactant and 10 to 99.99% solid or liquid formulation inerts and adjuvant(s), the active agent consisting of at least the compound of formula I together with a compound of component B, and optionally other active agents, particularly microbiocides or conservatives or the like. Concentrated forms of compositions generally contain in between about 2 and 80%, preferably between about 5 and 70% by weight of active agent. Application forms of formulation may for example contain from 0.01 to 20% by weight, preferably from 0.01 to 5% by weight of active agent. Whereas commercial products will preferably be formulated as concentrates, the end user will normally employ diluted formulations.

### EXAMPLES

A synergistic effect exists whenever the action of an active ingredient combination is greater than the sum of the actions of the individual components.

The action to be expected E for a given active ingredient combination obeys the so-called COLBY formula and can be calculated as follows (COLBY, S.R. “Calculating synergistic and antagonistic responses of herbicide combination”. Weeds, Vol. 15, pages 20-22; 1967):

ppm=milligrams of active ingredient (=a.i.) per liter of spray mixture
X=% action by active ingredient A) using p ppm of active ingredient
Y=% action by active ingredient B) using q ppm of active ingredient.

According to COLBY, the expected (additive) action of active ingredients A)+B) using p+q ppm of active ingredient is

$$E = X + Y - \frac{X \cdot Y}{100}$$

If the action actually observed (O) is greater than the expected action (E), then the action of the combination is super-additive, i.e. there is a synergistic effect. In mathematical terms the synergism factor SF corresponds to O/E. In the agricultural practice an SF of ≧1.2 indicates significant improvement over the purely complementary addition of activities (expected activity), while an SF of ≦0.9 in the practical application routine signals a loss of activity compared to the expected activity.

Tables 1 to 123 show mixtures and compositions of the present invention demonstrating control on a wide range of invertebrate pests, some with notable synergistic effect. As the percent of mortality cannot exceed 100 percent, the unexpected increase in insecticidal activity can be greatest only when the separate active ingredient components alone are at application rates providing considerably less than 100 percent control. Synergy may not be evident at low application rates where the individual active ingredient components alone have little activity. However, in some instances high activity was observed for combinations wherein individual active ingredient alone at the same application rate had essentially no activity. The synergism is remarkable.

Noteworthy are mixtures comprising A1 and abamectin, chlorpyrifos, cyantraniliprole, emamectin benzoate, lambda cyhalothrin, pymetrozine, spirotetramat, thiamethoxam, clothianidin, imidacloprid or flonicamid; mixtures comprising A5 and abamectin, chlorpyrifos, cyantraniliprole, emamectin benzoate, lambda cyhalothrin, pymetrozine, spirotetramat, thiamethoxam, clothianidin, imidacloprid or flonicamid; mixtures comprising A6 and abamectin, chlorpyrifos, cyantraniliprole, emamectin benzoate, lambda cyhalothrin, pymetrozine, spirotetramat, thiamethoxam, clothianidin, imidacloprid or flonicamid; mixtures comprising A6 and A7 and abamectin, chlorpyrifos, cyantraniliprole, emamectin benzoate, lambda cyhalothrin, pymetrozine, spirotetramat, thiamethoxam, clothianidin, imidacloprid or flonicamid; mixtures comprising A8 and abamectin, chlorpyrifos, cyantraniliprole, emamectin benzoate, lambda cyhalothrin, pymetrozine, spirotetramat, thiamethoxam, clothianidin, imidacloprid or flonicamid.

### Spodoptera Littoralis (Egyptian Cotton Leaf Worm)

### (Larvicide L1, Feeding/Contact)

Cotton leaf discs are placed on agar in Petri dishes and sprayed with test solutions in an application chamber. After drying, the leaf discs are infested with 10 L1 larvae. The samples are checked for mortality 5 days after treatment. 3 replicates per treatment were evaluated. Application rates are as indicated in the Tables. (1 PPM=1 mg l⁻¹)

TABLE 1

| | | | | EXPECT- | OB- |
|---|---|---|---|---|---|
| | | AVERAGE DEAD IN % | | ED | SERVED |
| PPM Al | | AFTER 5 DAYS | | MORTAL- | MORTAL- |
| A1 | Abamectin | A1 | Abamectin | ITY | ITY |
| 0.4 | 0.4 | 20 | 10 | 28 | 33* |
| 0.4 | 0.8 | 20 | 13 | 31 | 37* |
| 0.4 | 1.6 | 20 | 40 | 52 | 47 |
| 0.8 | 0.4 | 50 | 10 | 55 | 50 |
| 0.8 | 0.8 | 50 | 13 | 57 | 53 |
| 0.8 | 1.6 | 50 | 40 | 70 | 90* |

TABLE 2

| | | | | EXPECT- | OB- |
|---|---|---|---|---|---|
| | | AVERAGE DEAD IN % | | ED | SERVED |
| PPM Al | | AFTER 5 DAYS | | MORTAL- | MORTAL- |
| A1 | Chlorpyriphos | A1 | Chlorpyriphos | ITY | ITY |
| 0.4 | 12.5 | 20 | 10 | 28 | 30* |
| 0.4 | 25 | 20 | 17 | 33 | 37* |
| 0.4 | 50 | 20 | 30 | 44 | 37 |
| 0.8 | 12.5 | 50 | 10 | 55 | 53 |
| 0.8 | 25 | 50 | 17 | 58 | 60* |
| 0.8 | 50 | 50 | 30 | 65 | 80* |

TABLE 3

| PPM Al | | AVERAGE DEAD IN % AFTER 5 DAYS | | EXPECTED | OBSERVED |
|---|---|---|---|---|---|
| A1 | Cyantraniliprole | A1 | Cyantraniliprole | MORTALITY | MORTALITY |
| 0.4 | 0.0125 | 37 | 23 | 51 | 40 |
| 0.4 | 0.025 | 37 | 27 | 54 | 40 |
| 0.4 | 0.05 | 37 | 40 | 62 | 90* |
| 0.8 | 0.0125 | 67 | 23 | 74 | 83* |
| 0.8 | 0.025 | 67 | 27 | 76 | 87* |
| 0.8 | 0.05 | 67 | 40 | 80 | 93* |

TABLE 4

| | | AVERAGE DEAD IN | | | |
|---|---|---|---|---|---|
| PPM Al | | % AFTER 5 DAYS | | | |
| | Emamectin | | Emamectin | EXPECTED | OBSERVED |
| A1 | Benzoate | A1 | Benzoate | MORTALITY | MORTALITY |
| 0.4 | 0.003125 | 37 | 20 | 49 | 37 |
| 0.4 | 0.00625 | 37 | 23 | 51 | 70* |
| 0.4 | 0.0125 | 37 | 30 | 56 | 73* |
| 0.8 | 0.003125 | 67 | 20 | 73 | 77* |
| 0.8 | 0.00625 | 67 | 23 | 74 | 80* |
| 0.8 | 0.0125 | 67 | 30 | 77 | 83* |

TABLE 5

| | | AVERAGE DEAD IN | | | |
|---|---|---|---|---|---|
| PPM Al | | % AFTER 5 DAYS | | | |
| | Lambda | | Lambda | EXPECTED | OBSERVED |
| A1 | Cyhalothrin | A1 | Cyhalothrin | MORTALITY | MORTALITY |
| 0.4 | 0.05 | 7 | 10 | 16 | 20* |
| 0.4 | 0.1 | 7 | 13 | 19 | 30* |
| 0.4 | 0.2 | 7 | 17 | 22 | 30* |
| 0.8 | 0.05 | 27 | 10 | 34 | 40* |
| 0.8 | 0.1 | 27 | 13 | 36 | 63* |
| 0.8 | 0.2 | 27 | 17 | 39 | 67* |

TABLE 6

| | | AVERAGE | | | |
|---|---|---|---|---|---|
| | | DEAD IN % | | | |
| PPM Al | | AFTER 5 DAYS | | EXPECTED | OBSERVED |
| A1 | Pymetrozine | A1 | Pymetrozine | MORTALITY | MORTALITY |
| 0.4 | 100 | 7 | 17 | 22 | 20 |
| 0.4 | 200 | 7 | 20 | 25 | 23 |
| 0.8 | 100 | 27 | 17 | 39 | 27 |
| 0.8 | 200 | 27 | 20 | 41 | 33 |

TABLE 7

| | | AVERAGE | | | |
|---|---|---|---|---|---|
| | | DEAD IN % | | | |
| PPM Al | | AFTER 5 DAYS | | EXPECTED | OBSERVED |
| A1 | Spirotetramat | A1 | Spirotetramat | MORTALITY | MORTALITY |
| 0.4 | 25 | 40 | 10 | 46 | 50* |
| 0.4 | 50 | 40 | 17 | 50 | 57* |
| 0.4 | 100 | 40 | 43 | 66 | 83* |
| 0.8 | 25 | 47 | 10 | 52 | 57* |
| 0.8 | 50 | 47 | 17 | 56 | 93* |
| 0.8 | 100 | 47 | 43 | 70 | 97* |

TABLE 8

| | | AVERAGE | | | |
|---|---|---|---|---|---|
| | | DEAD IN % | | | |
| PPM Al | | AFTER 5 DAYS | | EXPECTED | OBSERVED |
| A1 | Thiamethoxam | A1 | Thiamethoxam | MORTALITY | MORTALITY |
| 0.4 | 0.2 | 40 | 7 | 44 | 40 |
| 0.4 | 0.4 | 40 | 13 | 48 | 53* |
| 0.4 | 0.8 | 40 | 30 | 58 | 60* |
| 0.8 | 0.2 | 47 | 7 | 50 | 53* |
| 0.8 | 0.4 | 47 | 13 | 54 | 57* |
| 0.8 | 0.8 | 47 | 30 | 63 | 73* |

TABLE 9

| | | AVERAGE DEAD IN | | | |
|---|---|---|---|---|---|
| PPM Al | | % AFTER 5 DAYS | | EXPECTED | OBSERVED |
| A5 | Abamectin | A5 | Abamectin | MORTALITY | MORTALITY |
| 0.1 | 0.4 | 23 | 10 | 31 | 27 |
| 0.1 | 0.8 | 23 | 13 | 34 | 30 |
| 0.1 | 1.6 | 23 | 40 | 54 | 47 |
| 0.2 | 0.4 | 67 | 10 | 70 | 73* |
| 0.2 | 0.8 | 67 | 13 | 71 | 73* |
| 0.2 | 1.6 | 67 | 40 | 80 | 77 |

TABLE 10

| | | AVERAGE | | | |
|---|---|---|---|---|---|
| | | DEAD IN % | | | |
| PPM Al | | AFTER 5 DAYS | | EXPECTED | OBSERVED |
| A5 | Chlorpyriphos | A5 | Chlorpyriphos | MORTALITY | MORTALITY |
| 0.1 | 12.5 | 23 | 10 | 31 | 30 |
| 0.1 | 25 | 23 | 17 | 36 | 43* |
| 0.1 | 50 | 23 | 30 | 46 | 47* |
| 0.2 | 12.5 | 67 | 10 | 70 | 67 |
| 0.2 | 25 | 67 | 17 | 72 | 73* |
| 0.2 | 50 | 67 | 30 | 77 | 80* |

TABLE 11

| | | AVERAGE | | | |
|---|---|---|---|---|---|
| | | DEAD IN % | | | |
| PPM Al | | AFTER 5 DAYS | | | |
| | Cyan- | | Cyan- | EXPECTED | OBSERVED |
| A5 | traniliprole | A5 | traniliprole | MORTALITY | MORTALITY |
| 0.1 | 0.0125 | 30 | 23 | 46 | 47* |
| 0.1 | 0.025 | 30 | 27 | 49 | 70* |
| 0.1 | 0.05 | 30 | 40 | 58 | 77* |
| 0.2 | 0.0125 | 50 | 23 | 62 | 63* |
| 0.2 | 0.025 | 50 | 27 | 63 | 87* |
| 0.2 | 0.05 | 50 | 40 | 70 | 97* |

TABLE 12

| | | AVERAGE | | | |
|---|---|---|---|---|---|
| | | DEAD IN % | | | |
| PPM Al | | AFTER 5 DAYS | | | |
| | Emamectin | | Emamectin | EXPECTED | OBSERVED |
| A5 | Benzoate | A5 | Benzoate | MORTALITY | MORTALITY |
| 0.1 | 0.003125 | 30 | 20 | 44 | 33 |
| 0.1 | 0.00625 | 30 | 23 | 46 | 50* |
| 0.1 | 0.0125 | 30 | 30 | 51 | 50 |
| 0.2 | 0.003125 | 50 | 20 | 60 | 53 |
| 0.2 | 0.00625 | 50 | 23 | 62 | 53 |
| 0.2 | 0.0125 | 50 | 30 | 65 | 60 |

TABLE 13

| | | AVERAGE | | | |
|---|---|---|---|---|---|
| | | DEAD IN % | | | |
| PPM Al | | AFTER 5 DAYS | | | |
| | Lambda | | Lambda | EXPECTED | OBSERVED |
| A5 | Cyhalothrin | A5 | Cyhalothrin | MORTALITY | MORTALITY |
| 0.1 | 0.05 | 20 | 10 | 28 | 20 |
| 0.1 | 0.1 | 20 | 13 | 31 | 20 |
| 0.1 | 0.2 | 20 | 17 | 33 | 30 |
| 0.2 | 0.05 | 23 | 10 | 31 | 23 |
| 0.2 | 0.1 | 23 | 13 | 34 | 30 |
| 0.2 | 0.2 | 23 | 17 | 36 | 37* |

TABLE 14

| | | AVERAGE DEAD | | | |
|---|---|---|---|---|---|
| | | IN % AFTER | | | |
| PPM Al | | 5 DAYS | | EXPECTED | OBSERVED |
| A5 | Pymetrozine | A5 | Pymetrozine | MORTALITY | MORTALITY |
| 0.1 | 100 | 20 | 17 | 33 | 23 |
| 0.1 | 200 | 20 | 20 | 36 | 23 |
| 0.2 | 100 | 23 | 17 | 36 | 30 |
| 0.2 | 200 | 23 | 20 | 39 | 47* |

TABLE 15

| | | AVERAGE | | | |
|---|---|---|---|---|---|
| | | DEAD IN % | | | |
| PPM Al | | AFTER5 DAYS | | EXPECTED | OBSERVED |
| A5 | Spirotetramat | A5 | Spirotetramat | MORTALITY | MORTALITY |
| 0.1 | 25 | 27 | 10 | 34 | 60* |
| 0.1 | 50 | 27 | 17 | 39 | 60* |
| 0.1 | 100 | 27 | 43 | 58 | 100* |
| 0.2 | 25 | 47 | 10 | 52 | 67* |
| 0.2 | 50 | 47 | 17 | 56 | 90* |
| 0.2 | 100 | 47 | 43 | 70 | 100* |

TABLE 16

| | | AVERAGE | | | |
|---|---|---|---|---|---|
| | | DEAD IN % | | | |
| PPM Al | | AFTER 5 DAYS | | EXPECTED | OBSERVED |
| A5 | Thiamethoxam | A5 | Thiamethoxam | MORTALITY | MORTALITY |
| 0.1 | 0.2 | 27 | 7 | 32 | 27 |
| 0.1 | 0.4 | 27 | 13 | 36 | 27 |
| 0.1 | 0.8 | 27 | 30 | 49 | 50* |
| 0.2 | 0.2 | 47 | 7 | 50 | 53* |
| 0.2 | 0.4 | 47 | 13 | 54 | 53 |
| 0.2 | 0.8 | 47 | 30 | 63 | 53 |

TABLE 17

| | | AVERAGE | | | |
|---|---|---|---|---|---|
| | | DEAD IN % | | | |
| PPM Al | | AFTER 5 DAYS | | EXPECTED | OBSERVED |
| A6 | Abamectin | A6 | Abamectin | MORTALITY | MORTALITY |
| 0.05 | 0.4 | 7 | 7 | 13 | 7 |
| 0.1 | 0.4 | 20 | 7 | 25 | 20 |
| 0.2 | 0.4 | 50 | 7 | 53 | 50 |
| 0.05 | 0.8 | 7 | 10 | 16 | 10 |
| 0.1 | 0.8 | 20 | 10 | 28 | 23 |
| 0.2 | 0.8 | 50 | 10 | 55 | 50 |
| 0.05 | 1.6 | 7 | 20 | 25 | 20 |
| 0.1 | 1.6 | 20 | 20 | 36 | 27 |
| 0.2 | 1.6 | 50 | 20 | 60 | 60 |

TABLE 18

| | | AVERAGE | | | |
|---|---|---|---|---|---|
| | | DEAD IN % | | | |
| PPM Al | | AFTER 5 DAYS | | EXPECTED | OBSERVED |
| | Chlor- | | Chlor- | | |
| A6 | pyriphos | A6 | pyriphos | MORTALITY | MORTALITY |
| 0.05 | 12.5 | 7 | 7 | 13 | 7 |
| 0.1 | 12.5 | 20 | 7 | 25 | 23 |
| 0.2 | 12.5 | 50 | 7 | 53 | 50 |
| 0.05 | 25 | 7 | 10 | 16 | 13 |
| 0.1 | 25 | 20 | 10 | 28 | 27 |
| 0.2 | 25 | 50 | 10 | 55 | 53 |
| 0.05 | 50 | 7 | 20 | 25 | 20 |
| 0.1 | 50 | 20 | 20 | 36 | 43* |
| 0.2 | 50 | 50 | 20 | 60 | 63* |

TABLE 19

| | | | | EXPECT- | OB- |
|---|---|---|---|---|---|
| | | | | ED | SERVED |
| | | AVERAGE DEAD IN % | | MOR- | MOR- |
| PPM AI | | AFTER 5 DAYS | | TAL- | TAL- |
| A6 | Cyantraniliprole | A6 | Cyantraniliprole | ITY | ITY |
| 0.05 | 0.0125 | 7 | 23 | 28 | 23 |
| 0.1 | 0.0125 | 17 | 23 | 36 | 37* |
| 0.2 | 0.0125 | 47 | 23 | 59 | 77* |
| 0.05 | 0.025 | 7 | 30 | 35 | 30 |
| 0.1 | 0.025 | 17 | 30 | 42 | 37 |
| 0.2 | 0.025 | 47 | 30 | 63 | 83* |
| 0.05 | 0.05 | 7 | 50 | 53 | 67 |
| 0.1 | 0.05 | 17 | 50 | 58 | 70 |
| 0.2 | 0.05 | 47 | 50 | 73 | 83 |

TABLE 20

| PPM AI | | AVERAGE DEAD IN % | | EXPECTED | OBSERVED |
|---|---|---|---|---|---|
| | Emamectin | AFTER 5 DAYS | | MORTAL- | MORTAL- |
| A6 | Benzoate | A6 | Emamectin Benzoate | ITY | ITY |
| 0.05 | 0.003125 | 7 | 20 | 25 | 20 |
| 0.1 | 0.003125 | 17 | 20 | 33 | 27 |
| 0.2 | 0.003125 | 47 | 20 | 57 | 80* |
| 0.05 | 0.00625 | 7 | 23 | 28 | 27 |
| 0.1 | 0.00625 | 17 | 23 | 36 | 30 |
| 0.2 | 0.00625 | 47 | 23 | 59 | 83* |
| 0.05 | 0.0125 | 7 | 27 | 32 | 27 |
| 0.1 | 0.0125 | 17 | 27 | 39 | 30 |
| 0.2 | 0.0125 | 47 | 27 | 61 | 90* |

TABLE 21

| PPM AI | | AVERAGE DEAD IN % | | EXPECTED | OBSERVED |
|---|---|---|---|---|---|
| | Lambda | AFTER 5 DAYS | | MORTAL- | MORTAL- |
| A6 | Cyhalothrin | A6 | Lambda Cyhalothrin | ITY | ITY |
| 0.05 | 0.05 | 7 | 20 | 25 | 20 |
| 0.1 | 0.05 | 17 | 20 | 33 | 23 |
| 0.2 | 0.05 | 50 | 20 | 60 | 57 |
| 0.05 | 0.1 | 7 | 37 | 41 | 40 |
| 0.1 | 0.1 | 17 | 37 | 47 | 50* |
| 0.2 | 0.1 | 50 | 37 | 68 | 67 |
| 0.05 | 0.2 | 7 | 57 | 60 | 57 |
| 0.1 | 0.2 | 17 | 57 | 64 | 70* |
| 0.2 | 0.2 | 50 | 57 | 78 | 77 |

TABLE 22

| | | AVERAGE | | | OB- |
|---|---|---|---|---|---|
| | | DEAD IN % | | EXPECTED | SERVED |
| PPM AI | | AFTER 5 DAYS | | MORTAL- | MORTAL- |
| A6 | Pymetrozine | A6 | Pymetrozine | ITY | ITY |
| 0.05 | 100 | 7 | 7 | 13 | 10 |
| 0.1 | 100 | 17 | 7 | 22 | 20 |
| 0.2 | 100 | 50 | 7 | 53 | 50 |
| 0.05 | 200 | 7 | 17 | 22 | 17 |
| 0.1 | 200 | 17 | 17 | 31 | 20 |
| 0.2 | 200 | 50 | 17 | 58 | 60* |

TABLE 23

| | | AVERAGE | | | OB- |
|---|---|---|---|---|---|
| | | DEAD IN % | | EXPECTED | SERVED |
| PPM AI | | AFTER 5 DAYS | | MORTAL- | MORTAL- |
| A6 | Spirotetramat | A6 | Spirotetramat | ITY | ITY |
| 0.05 | 25 | 7 | 23 | 28 | 23 |
| 0.1 | 25 | 13 | 23 | 34 | 27 |
| 0.2 | 25 | 40 | 23 | 54 | 90* |
| 0.05 | 50 | 7 | 33 | 38 | 43* |
| 0.1 | 50 | 13 | 33 | 42 | 63* |
| 0.2 | 50 | 40 | 33 | 60 | 97* |
| 0.05 | 100 | 7 | 67 | 69 | 70* |
| 0.1 | 100 | 13 | 67 | 71 | 90 |
| 0.2 | 100 | 40 | 67 | 80 | 100* |

TABLE 24

| | | AVERAGE | | | |
|---|---|---|---|---|---|
| | | DEAD IN % | | EX- | OB- |
| PPM AI | | AFTER 5 DAYS | | PECTED | SERVED |
| | Thiameth- | | Thiameth- | MORTAL- | MORTAL- |
| A6 | oxam | A6 | oxam | ITY | ITY |
| 0.05 | 0.2 | 7 | 10 | 16 | 13 |
| 0.1 | 0.2 | 13 | 10 | 22 | 23 |
| 0.2 | 0.2 | 40 | 10 | 46 | 40 |
| 0.05 | 0.4 | 7 | 13 | 19 | 13 |
| 0.1 | 0.4 | 13 | 13 | 25 | 33* |
| 0.2 | 0.4 | 40 | 13 | 48 | 40 |
| 0.05 | 0.8 | 7 | 30 | 35 | 30 |
| 0.1 | 0.8 | 13 | 30 | 39 | 40* |
| 0.2 | 0.8 | 40 | 30 | 58 | 43 |

TABLE 25

| | | AVERAGE | | | |
|---|---|---|---|---|---|
| | | DEAD IN % | | EXPECTED | OBSERVED |
| PPM AI | | AFTER 5 DAYS | | MORTAL- | MORTAL- |
| A8 | Abamectin | A8 | Abamectin | ITY | ITY |
| 0.05 | 0.4 | 10 | 7 | 16 | 10 |
| 0.1 | 0.4 | 23 | 7 | 28 | 27 |
| 0.2 | 0.4 | 53 | 7 | 56 | 57* |
| 0.05 | 0.8 | 10 | 10 | 19 | 13 |
| 0.1 | 0.8 | 23 | 10 | 31 | 27 |
| 0.2 | 0.8 | 53 | 10 | 58 | 57 |
| 0.05 | 1.6 | 10 | 20 | 28 | 20 |
| 0.1 | 1.6 | 23 | 20 | 39 | 30 |
| 0.2 | 1.6 | 53 | 20 | 63 | 57 |

TABLE 26

| | | AVERAGE | | | |
|---|---|---|---|---|---|
| | | DEAD IN % | | EX- | OB- |
| PPM AI | | AFTER 5 DAYS | | PECTED | SERVED |
| | Chlor- | | Chlor- | MORTAL- | MORTAL- |
| A8 | pyriphos | A8 | pyriphos | ITY | ITY |
| 0.05 | 12.5 | 10 | 7 | 16 | 10 |
| 0.1 | 12.5 | 23 | 7 | 28 | 23 |
| 0.2 | 12.5 | 53 | 7 | 56 | 53 |
| 0.05 | 25 | 10 | 10 | 19 | 13 |
| 0.1 | 25 | 23 | 10 | 31 | 23 |
| 0.2 | 25 | 53 | 10 | 58 | 57 |
| 0.05 | 50 | 10 | 20 | 28 | 20 |
| 0.1 | 50 | 23 | 20 | 39 | 40* |
| 0.2 | 50 | 53 | 20 | 63 | 60 |

TABLE 27

| | | AVERAGE | | | |
|---|---|---|---|---|---|
| | | DEAD IN % | | EX- | OB- |
| PPM AI | | AFTER 5 DAYS | | PECTED | SERVED |
| | Cyantran- | | Cyantran- | MORTAL- | MORTAL- |
| A8 | iliprole | A8 | iliprole | ITY | ITY |
| 0.05 | 0.0125 | 20 | 23 | 39 | 27 |
| 0.1 | 0.0125 | 30 | 23 | 46 | 30 |
| 0.2 | 0.0125 | 50 | 23 | 62 | 80* |
| 0.05 | 0.025 | 20 | 30 | 44 | 33 |
| 0.1 | 0.025 | 30 | 30 | 51 | 47 |
| 0.2 | 0.025 | 50 | 30 | 65 | 83* |
| 0.05 | 0.05 | 20 | 50 | 60 | 53 |
| 0.1 | 0.05 | 30 | 50 | 65 | 57 |
| 0.2 | 0.05 | 50 | 50 | 75 | 100* |

TABLE 28

| PPM AI | | AVERAGE DEAD IN % | | EXPECTED | OBSERVED |
|---|---|---|---|---|---|
| | Emamectin | AFTER 5 DAYS | | MORTAL- | MORTAL- |
| A8 | Benzoate | A8 | Emamectin Benzoate | ITY | ITY |
| 0.05 | 0.003125 | 20 | 20 | 36 | 27 |
| 0.1 | 0.003125 | 30 | 20 | 44 | 30 |
| 0.2 | 0.003125 | 50 | 20 | 60 | 50 |
| 0.05 | 0.00625 | 20 | 23 | 39 | 27 |
| 0.1 | 0.00625 | 30 | 23 | 46 | 30 |
| 0.2 | 0.00625 | 50 | 23 | 62 | 63* |
| 0.05 | 0.0125 | 20 | 27 | 41 | 33 |
| 0.1 | 0.0125 | 30 | 27 | 49 | 37 |
| 0.2 | 0.0125 | 50 | 27 | 63 | 83* |

TABLE 29

| PPM AI | | AVERAGE DEAD IN % | | EXPECTED | OBSERVED |
|---|---|---|---|---|---|
| | Lambda | AFTER 5 DAYS | | MORTAL- | MORTAL- |
| A8 | Cyhalothrin | A8 | Lambda Cyhalothrin | ITY | ITY |
| 0.05 | 0.05 | 10 | 20 | 28 | 20 |
| 0.1 | 0.05 | 20 | 20 | 36 | 37* |
| 0.2 | 0.05 | 53 | 20 | 63 | 53 |
| 0.05 | 0.1 | 10 | 37 | 43 | 37 |
| 0.1 | 0.1 | 20 | 37 | 49 | 40 |
| 0.2 | 0.1 | 53 | 37 | 70 | 60 |
| 0.05 | 0.2 | 10 | 57 | 61 | 57 |
| 0.1 | 0.2 | 20 | 57 | 65 | 60 |
| 0.2 | 0.2 | 53 | 57 | 80 | 73 |

TABLE 30

| | | AVERAGE DEAD IN % | | EXPECTED | OBSERVED |
|---|---|---|---|---|---|
| PPM AI | | AFTER 5 DAYS | | MORTAL- | MORTAL- |
| A8 | Pymetrozine | A8 | Pymetrozine | ITY | ITY |
| 0.05 | 100 | 10 | 7 | 16 | 17* |
| 0.1 | 100 | 20 | 7 | 25 | 20 |
| 0.2 | 100 | 53 | 7 | 56 | 53 |
| 0.05 | 200 | 10 | 17 | 25 | 20 |
| 0.1 | 200 | 20 | 17 | 33 | 30 |
| 0.2 | 200 | 53 | 17 | 61 | 57 |

TABLE 31

| | | AVERAGE | | | |
|---|---|---|---|---|---|
| | | DEAD IN % | | EXPECTED | OBSERVED |
| PPM AI | | AFTER 5 DAYS | | MORTAL- | MORTAL- |
| A8 | Spirotetramat | A8 | Spirotetramat | ITY | ITY |
| 0.05 | 25 | 13 | 23 | 34 | 23 |
| 0.1 | 25 | 23 | 23 | 41 | 70* |
| 0.2 | 25 | 40 | 23 | 54 | 90* |
| 0.05 | 50 | 13 | 33 | 42 | 43* |
| 0.1 | 50 | 23 | 33 | 49 | 87* |
| 0.2 | 50 | 40 | 33 | 60 | 100* |
| 0.05 | 100 | 13 | 67 | 71 | 77* |
| 0.1 | 100 | 23 | 67 | 74 | 97* |
| 0.2 | 100 | 40 | 67 | 80 | 100* |

TABLE 32

| | | AVERAGE | | | |
|---|---|---|---|---|---|
| | | DEAD IN % | | EXPECTED | OBSERVED |
| PPM AI | | AFTER 5 DAYS | | MORTAL- | MORTAL- |
| A8 | Thiamethoxam | A8 | Thiamethoxam | ITY | ITY |
| 0.05 | 0.2 | 13 | 10 | 22 | 13 |
| 0.1 | 0.2 | 23 | 10 | 31 | 23 |
| 0.2 | 0.2 | 40 | 10 | 46 | 40 |
| 0.05 | 0.4 | 13 | 13 | 25 | 13 |
| 0.1 | 0.4 | 23 | 13 | 34 | 23 |
| 0.2 | 0.4 | 40 | 13 | 48 | 40 |
| 0.05 | 0.8 | 13 | 30 | 39 | 30 |
| 0.1 | 0.8 | 23 | 30 | 46 | 33 |
| 0.2 | 0.8 | 40 | 30 | 58 | 53 |

### Heliothis Virescens (Tobacco Budworm):

### (Ovo-Larvicide, Feeding/Contact)

30-35 fresh eggs (0-24 h old), deposited on filter paper, are placed in Petri dishes on top of a layer of artificial diet and 0.8 ml of diluted test solutions are pipetted onto them. After an incubation period of 7 days, samples are checked for egg and larval mortality. 3 replicates per treatment were evaluated. Application rates are as indicated in the Tables.

TABLE 33

| | | AVERAGE DEAD | | | |
|---|---|---|---|---|---|
| PPM AI | | IN % (LARVAE) | | EXPECTED | OBSERVED |
| A1 | Abamectin | A1 | Abamectin | MORTALITY | MORTALITY |
| 0.2 | 0.025 | 17 | 3 | 19 | 30* |
| 0.2 | 0.05 | 17 | 37 | 48 | 27 |
| 0.2 | 0.1 | 17 | 53 | 61 | 40 |
| 0.4 | 0.025 | 60 | 3 | 61 | 33 |
| 0.4 | 0.05 | 60 | 37 | 75 | 47 |
| 0.4 | 0.1 | 60 | 53 | 81 | 67 |
| 0.8 | 0.025 | 87 | 3 | 87 | 47 |
| 0.8 | 0.05 | 87 | 37 | 92 | 57 |
| 0.8 | 0.1 | 87 | 53 | 94 | 67 |

TABLE 34

| | | AVERAGE | | | |
|---|---|---|---|---|---|
| | | DEAD IN % | | | |
| PPM AI | | (LARVAE) | | EXPECTED | OBSERVED |
| A1 | Chlorpyrifos | A1 | Chlorpyrifos | MORTALITY | MORTALITY |
| 0.2 | 50 | 0 | 0 | 0 | 30* |
| 0.2 | 100 | 0 | 0 | 0 | 17* |
| 0.2 | 200 | 0 | 30 | 30 | 63* |
| 0.4 | 50 | 37 | 0 | 37 | 77* |
| 0.4 | 100 | 37 | 0 | 37 | 70* |
| 0.4 | 200 | 37 | 30 | 56 | 93* |
| 0.8 | 50 | 67 | 0 | 67 | 77 |
| 0.8 | 100 | 67 | 0 | 67 | 90 |
| 0.8 | 200 | 67 | 30 | 77 | 97 |

TABLE 35

| | | AVERAGE | | | |
|---|---|---|---|---|---|
| | | DEAD IN % | | | |
| PPM AI | | (LARVAE) | | | |
| | Cyan- | | Cyan- | EXPECTED | OBSERVED |
| A1 | traniliprole | A1 | traniliprole | MORTALITY | MORTALITY |
| 0.2 | 0.2 | 13 | 23 | 33 | 23 |
| 0.2 | 0.4 | 13 | 70 | 74 | 70 |
| 0.2 | 0.8 | 13 | 82 | 84 | 78 |
| 0.4 | 0.2 | 68 | 23 | 75 | 57 |
| 0.4 | 0.4 | 68 | 70 | 90 | 78 |
| 0.4 | 0.8 | 68 | 82 | 94 | 90 |
| 0.8 | 0.2 | 73 | 23 | 79 | 72 |
| 0.8 | 0.4 | 73 | 70 | 92 | 67 |
| 0.8 | 0.8 | 73 | 82 | 95 | 85 |

TABLE 36

| | | AVERAGE | | | |
|---|---|---|---|---|---|
| | | DEAD IN % | | | |
| PPM AI | | (LARVAE) | | | |
| | Emamectin | | Emamectin | EXPECTED | OBSERVED |
| A1 | benzoate | A1 | benzoate | MORTALITY | MORTALITY |
| 0.2 | 0.0015 | 10 | 5 | 15 | 5 |
| 0.2 | 0.003 | 10 | 5 | 15 | 10 |
| 0.2 | 0.006 | 10 | 10 | 19 | 27* |
| 0.4 | 0.0015 | 47 | 5 | 50 | 53* |
| 0.4 | 0.003 | 47 | 5 | 50 | 70* |
| 0.4 | 0.006 | 47 | 10 | 52 | 57* |
| 0.8 | 0.0015 | 67 | 5 | 69 | 70* |
| 0.8 | 0.003 | 67 | 5 | 69 | 73* |
| 0.8 | 0.006 | 67 | 10 | 70 | 73* |

TABLE 37

| | | AVERAGE | | | |
|---|---|---|---|---|---|
| | | DEAD IN % | | | |
| PPM AI | | (LARVAE) | | | |
| | Lambda | | Lambda | EXPECTED | OBSERVED |
| A1 | Cyhalothrin | A1 | Cyhalothrin | MORTALITY | MORTALITY |
| 0.2 | 0.05 | 24 | 33 | 49 | 80* |
| 0.2 | 0.1 | 24 | 100 | 100 | 100 |
| 0.2 | 0.2 | 24 | 100 | 100 | 100 |
| 0.4 | 0.05 | 61 | 33 | 74 | 80* |
| 0.4 | 0.1 | 61 | 100 | 100 | 100 |
| 0.4 | 0.2 | 61 | 100 | 100 | 100 |
| 0.8 | 0.05 | 72 | 33 | 81 | 73 |
| 0.8 | 0.1 | 72 | 100 | 100 | 100 |
| 0.8 | 0.2 | 72 | 100 | 100 | 100 |

TABLE 38

| | | AVERAGE | | | |
|---|---|---|---|---|---|
| | | DEAD IN % | | | |
| PPM AI | | (LARVAE) | | | |
| | Pymetro- | | Pymetro- | EXPECTED | OBSERVED |
| A1 | zine | A1 | zine | MORTALITY | MORTALITY |
| 0.2 | 100 | 13 | 0 | 13 | 60* |
| 0.2 | 200 | 13 | 40 | 48 | 53* |
| 0.4 | 100 | 68 | 0 | 68 | 83* |
| 0.4 | 200 | 68 | 40 | 81 | 73 |
| 0.8 | 100 | 73 | 0 | 73 | 82* |
| 0.8 | 200 | 73 | 40 | 84 | 75 |

TABLE 39

| | | AVERAGE | | | |
|---|---|---|---|---|---|
| | | DEAD IN % | | | |
| PPM AI | | (LARVAE) | | EXPECTED | OBSERVED |
| A1 | Spirotetramat | A1 | Spirotetramat | MORTALITY | MORTALITY |
| 0.2 | 100 | 13 | 78 | 81 | 60 |
| 0.2 | 200 | 13 | 100 | 100 | — |
| 0.4 | 100 | 68 | 78 | 93 | 78 |
| 0.4 | 200 | 68 | 100 | 100 | 100 |
| 0.8 | 100 | 73 | 78 | 94 | 83 |
| 0.8 | 200 | 73 | 100 | 100 | 100 |

TABLE 40

| | | AVERAGE | | | |
|---|---|---|---|---|---|
| | | DEAD IN % | | | |
| PPM AI | | (LARVAE) | | | |
| | Thia- | | Thia- | EXPECTED | OBSERVED |
| A1 | methoxam | A1 | methoxam | MORTALITY | MORTALITY |
| 0.2 | 100 | 13 | 78 | 81 | 72 |
| 0.2 | 200 | 13 | 80 | 83 | 73 |
| 0.4 | 100 | 68 | 78 | 93 | 88 |
| 0.4 | 200 | 68 | 80 | 94 | 87 |
| 0.8 | 100 | 73 | 78 | 94 | 90 |
| 0.8 | 200 | 73 | 80 | 95 | 63 |

TABLE 41

| | | AVERAGE | | | |
|---|---|---|---|---|---|
| | | DEAD IN % | | | |
| PPM AI | | (LARVAE) | | EXPECTED | OBSERVED |
| A5 | Abamectin | A5 | Abamectin | MORTALITY | MORTALITY |
| 0.025 | 0.025 | 3 | 3 | 6 | 37* |
| 0.025 | 0.05 | 3 | 37 | 39 | 40* |
| 0.025 | 0.1 | 3 | 53 | 54 | 63* |
| 0.05 | 0.025 | 33 | 3 | 35 | 33 |
| 0.05 | 0.05 | 33 | 37 | 58 | 53 |
| 0.05 | 0.1 | 33 | 53 | 69 | 50 |
| 0.1 | 0.025 | 53 | 3 | 54 | 50 |
| 0.1 | 0.05 | 53 | 37 | 70 | 53 |
| 0.1 | 0.1 | 53 | 53 | 78 | 67 |

TABLE 42

| | | AVERAGE DEAD | | EXPECTED | OBSERVED |
|---|---|---|---|---|---|
| PPM AI | | IN % (LARVAE) | | MORTAL- | MORTAL- |
| A5 | Chlorpyrifos | A5 | Chlorpyrifos | ITY | ITY |
| 0.025 | 50 | 0 | 0 | 0 | 0 |
| 0.025 | 100 | 0 | 0 | 0 | 0 |
| 0.025 | 200 | 0 | 30 | 30 | 73* |
| 0.05 | 50 | 7 | 0 | 7 | 43* |
| 0.05 | 100 | 7 | 0 | 7 | 47* |
| 0.05 | 200 | 7 | 30 | 35 | 87* |
| 0.1 | 50 | 67 | 0 | 67 | 80* |
| 0.1 | 100 | 67 | 0 | 67 | 90* |
| 0.1 | 200 | 67 | 30 | 77 | 100* |

TABLE 43

| | | AVERAGE | | | |
|---|---|---|---|---|---|
| | | DEAD IN % | | | |
| PPM AI | | (LARVAE) | | EXPECTED | OBSERVED |
| | Cyan- | | Cyan- | MORTAL- | MORTAL- |
| A5 | traniliprole | A5 | traniliprole | ITY | ITY |
| 0.025 | 0.2 | 12 | 23 | 32 | 20 |
| 0.025 | 0.4 | 12 | 63 | 67 | 62 |
| 0.025 | 0.8 | 12 | 72 | 75 | 90* |
| 0.05 | 0.2 | 67 | 23 | 75 | 23 |
| 0.05 | 0.4 | 67 | 63 | 88 | 62 |
| 0.05 | 0.8 | 67 | 72 | 91 | 83 |
| 0.1 | 0.2 | 87 | 23 | 90 | 70 |
| 0.1 | 0.4 | 87 | 63 | 95 | 77 |
| 0.1 | 0.8 | 87 | 72 | 96 | 92 |

TABLE 44

| | | AVERAGE | | | |
|---|---|---|---|---|---|
| | | DEAD IN % | | | |
| PPM AI | | (LARVAE) | | | |
| | Emamectin | | Emamectin | EXPECTED | OBSERVED |
| A5 | benzoate | A5 | benzoate | MORTALITY | MORTALITY |
| 0.025 | 0.0015 | 3 | 5 | 8 | 2 |
| 0.025 | 0.003 | 3 | 5 | 8 | 15* |
| 0.025 | 0.006 | 3 | 10 | 13 | 25* |
| 0.05 | 0.0015 | 7 | 5 | 12 | 3 |
| 0.05 | 0.003 | 7 | 5 | 12 | 17* |
| 0.05 | 0.006 | 7 | 10 | 16 | 27* |
| 0.1 | 0.0015 | 30 | 5 | 34 | 67* |
| 0.1 | 0.003 | 30 | 5 | 34 | 33 |
| 0.1 | 0.006 | 30 | 10 | 37 | 57* |

TABLE 45

| | | AVERAGE | | | |
|---|---|---|---|---|---|
| | | DEAD IN % | | | |
| PPM AI | | (LARVAE) | | | |
| | Lambda | | Lambda | EXPECTED | OBSERVED |
| A5 | Cyhalothrin | A5 | Cyhalothrin | MORTALITY | MORTALITY |
| 0.025 | 0.05 | 6 | 33 | 37 | 80* |
| 0.025 | 0.1 | 6 | 100 | 100 | 100 |
| 0.025 | 0.2 | 6 | 100 | 100 | 100 |
| 0.05 | 0.05 | 27 | 33 | 51 | 70* |
| 0.05 | 0.1 | 27 | 100 | 100 | 100 |
| 0.05 | 0.2 | 27 | 100 | 100 | 100 |
| 0.1 | 0.05 | 66 | 33 | 77 | 63 |
| 0.1 | 0.1 | 66 | 100 | 100 | 100 |
| 0.1 | 0.2 | 66 | 100 | 100 | 100 |

TABLE 46

| | | AVERAGE | | | |
|---|---|---|---|---|---|
| | | DEAD IN % | | | |
| PPM AI | | (LARVAE) | | EXPECTED | OBSERVED |
| | Pymetro- | | Pymetro- | MOR- | MOR- |
| A5 | zine | A5 | zine | TALITY | TALITY |
| 0.025 | 200 | 10 | 37 | 43 | 13 |
| 0.05 | 200 | 47 | 37 | 67 | 45 |
| 0.1 | 200 | 73 | 37 | 83 | 67 |

TABLE 47

| | | AVERAGE | | | |
|---|---|---|---|---|---|
| | | DEAD IN % | | | |
| PPM AI | | (LARVAE) | | | |
| | Spiro- | | Spiro- | EXPECTED | OBSERVED |
| A5 | tetramat | A5 | tetramat | MORTALITY | MORTALITY |
| 0.025 | 200 | 10 | 98 | 98 | 98 |
| 0.05 | 200 | 47 | 98 | 99 | 100* |
| 0.1 | 200 | 73 | 98 | 99 | 100* |

TABLE 48

| | | AVERAGE | | | |
|---|---|---|---|---|---|
| | | DEAD IN % | | EXPECTED | OBSERVED |
| PPM AI | | (LARVAE) | | MORTAL- | MORTAL- |
| A5 | Thiamethoxam | A5 | Thiamethoxam | ITY | ITY |
| 0.025 | 200 | 10 | 80 | 82 | 83* |
| 0.05 | 200 | 47 | 80 | 89 | 85 |
| 0.1 | 200 | 73 | 80 | 95 | 82 |

TABLE 49

| | | AVERAGE DEAD | | | |
|---|---|---|---|---|---|
| PPM Al | | IN % (EGGS) | | | |
| | Lambda | | Lambda | EXPECTED | OBSERVED |
| A1 | Cyhalothrin | A1 | Cyhalothrin | MORTALITY | MORTALITY |
| 0.2 | 0.05 | 0 | 0 | 0 | 3* |
| 0.2 | 0.1 | 0 | 17 | 17 | 47* |
| 0.2 | 0.2 | 0 | 50 | 50 | 73* |
| 0.4 | 0.05 | 0 | 0 | 0 | 0 |
| 0.4 | 0.1 | 0 | 17 | 17 | 30* |
| 0.4 | 0.2 | 0 | 50 | 50 | 80* |
| 0.8 | 0.05 | 0 | 0 | 0 | 3* |
| 0.8 | 0.1 | 0 | 17 | 17 | 50* |
| 0.8 | 0.2 | 0 | 50 | 50 | 77* |

TABLE 50

| | | AVERAGE | | | |
|---|---|---|---|---|---|
| | | DEAD IN | | | |
| PPM Al | | % (EGGS) | | | |
| | Spiro- | | Spiro- | EXPECTED | OBSERVED |
| A1 | tetramat | A1 | tetramat | MORTALITY | MORTALITY |
| 0.2 | 100 | 0 | 0 | 0 | 0 |
| 0.2 | 200 | 0 | 67 | 67 | 100* |
| 0.4 | 100 | 0 | 0 | 0 | 0 |
| 0.4 | 200 | 0 | 67 | 67 | 67 |
| 0.8 | 100 | 0 | 0 | 0 | 0 |
| 0.8 | 200 | 0 | 67 | 67 | 67 |

TABLE 51

| | | AVERAGE DEAD | | | |
|---|---|---|---|---|---|
| PPM Al | | IN % (EGGS) | | | |
| | Thia- | | Thia- | EXPECTED | OBSERVED |
| A1 | methoxam | A1 | methoxam | MORTALITY | MORTALITY |
| 0.2 | 100 | 0 | 0 | 0 | 0 |
| 0.2 | 200 | 0 | 0 | 0 | 0 |
| 0.4 | 100 | 0 | 0 | 0 | 0 |
| 0.4 | 200 | 0 | 0 | 0 | 0 |
| 0.8 | 100 | 0 | 0 | 0 | 27* |
| 0.8 | 200 | 0 | 0 | 0 | 33* |

TABLE 52

AVERAGE

| | | DEAD | | | |
|---|---|---|---|---|---|
| PPM Al | | IN % (EGGS) | | | |
| | Lambda | | Lambda | | |
| | Cyhalo- | | Cyhalo- | EXPECTED | OBSERVED |
| A5 | thrin | A5 | thrin | MORTALITY | MORTALITY |
| 0.025 | 0.05 | 0 | 0 | 0 | 0 |
| 0.025 | 0.1 | 0 | 17 | 17 | 47* |
| 0.025 | 0.2 | 0 | 50 | 50 | 77* |
| 0.05 | 0.05 | 0 | 0 | 0 | 0 |
| 0.05 | 0.1 | 0 | 17 | 17 | 40* |
| 0.05 | 0.2 | 0 | 50 | 50 | 77* |
| 0.1 | 0.05 | 0 | 0 | 0 | 0 |
| 0.1 | 0.1 | 0 | 17 | 17 | 30* |
| 0.1 | 0.2 | 0 | 50 | 50 | 40 |

TABLE 53

| | | AVERAGE DEAD | | | |
|---|---|---|---|---|---|
| PPM Al | | IN % (EGGS) | | | |
| | Spiro- | | Spiro- | EXPECTED | OBSERVED |
| A5 | tetramat | A5 | tetramat | MORTALITY | MORTALITY |
| 0.025 | 200 | 0 | 65 | 65 | 62 |
| 0.05 | 200 | 0 | 65 | 65 | 92* |
| 0.1 | 200 | 0 | 65 | 65 | 87* |

TABLE 54

| | | AVERAGE DEAD | | | |
|---|---|---|---|---|---|
| PPM Al | | IN % (EGGS) | | | |
| | Thia- | | Thia- | EXPECTED | OBSERVED |
| A5 | methoxam | A5 | methoxam | MORTALITY | MORTALITY |
| 0.025 | 200 | 0 | 0 | 0 | 0 |
| 0.05 | 200 | 0 | 0 | 0 | 0 |
| 0.1 | 200 | 0 | 0 | 0 | 77* |

Single compound applications or combinations of A1 or A5 with Abamectin, Chlorpyrifos, Cyantraniliprole, Emamectin benzoate, or Pymetrozine were all inactive on eggs.

### Heliothis Virescens (Tobacco Budworm)

Eggs (0-24 h old) are placed in 24-well microtiter plate on artificial diet and treated with test solutions (DMSO) by pipetting. After an incubation period of 4 days, samples are checked for larval mortality. Application rates are as indicated in the Tables.

TABLE 55

AVERAGE

| PPM Al | | DEAD IN % | | | |
|---|---|---|---|---|---|
| | Floni- | SYN | Floni- | EXPECTED | OBSERVED |
| A5 | camid | 545706 | camid | MORTALITY | MORTALITY |
| 3.2 | 100 | 98 | 0 | 98 | 95 |
| 1.6 | 50 | 90 | 15 | 92 | 98* |
| 0.8 | 25 | 95 | 0 | 95 | 98* |
| 0.4 | 12.5 | 90 | 0 | 90 | 75 |
| 0.2 | 6.25 | 35 | | 35 | 10 |
| 1.6 | 100 | 90 | 0 | 90 | 95* |
| 0.8 | 50 | 95 | 15 | 96 | 93 |
| 0.4 | 25 | 90 | 0 | 90 | 75 |
| 0.2 | 12.5 | 35 | 0 | 35 | 25 |
| 0.1 | 6.25 | 0 | | 0 | 5* |
| 0.8 | 100 | 95 | 0 | 95 | 85 |
| 0.4 | 50 | 90 | 15 | 92 | 93* |
| 0.2 | 25 | 35 | 0 | 35 | 0 |
| 0.8 | 200 | 95 | 0 | 95 | 98* |
| 0.4 | 100 | 90 | 0 | 90 | 93* |
| 0.2 | 50 | 35 | 15 | 45 | 0 |
| 0.8 | 400 | 95 | 0 | 95 | 98* |
| 0.4 | 200 | 90 | 0 | 90 | 90 |
| 0.2 | 100 | 35 | 0 | 35 | 0 |
| 0.1 | 50 | 0 | 15 | 15 | 0 |

TABLE 56

| | | AVERAGE | | | |
|---|---|---|---|---|---|
| PPM Al | | DEAD IN % | | | |
| | Imida- | SYN | Imida- | EXPECTED | OBSERVED |
| A5 | cloprid | 545706 | cloprid | MORTALITY | MORTALITY |
| 3.2 | 50 | 96 | 85 | 99 | 93 |
| 1.6 | 25 | 91 | 75 | 98 | 95 |
| 0.8 | 12.5 | 88 | 0 | 88 | 85 |
| 0.4 | 6.25 | 78 | 0 | 78 | 80* |
| 0.2 | 3.125 | 25 | | 25 | 0 |
| 1.6 | 50 | 91 | 85 | 99 | 98 |
| 0.8 | 25 | 88 | 75 | 97 | 88 |
| 0.4 | 12.5 | 78 | 0 | 78 | 50 |
| 0.2 | 6.25 | 25 | 0 | 25 | 0 |
| 0.8 | 50 | 88 | 85 | 98 | 100* |
| 0.4 | 25 | 78 | 75 | 94 | 95* |
| 0.2 | 12.5 | 25 | 0 | 25 | 20 |
| 0.8 | 100 | 88 | 88 | 98 | 100 |
| 0.4 | 50 | 78 | 85 | 97 | 93 |
| 0.2 | 25 | 25 | 75 | 81 | 60 |
| 0.1 | 12.5 | 0 | 0 | 0 | 20* |
| 0.8 | 200 | 88 | 100 | 100 | 100 |
| 0.4 | 100 | 78 | 88 | 97 | 98* |
| 0.2 | 50 | 25 | 85 | 89 | 60 |
| 0.1 | 25 | 0 | 75 | 75 | 5 |

TABLE 57

AVERAGE

| PPM Al | | DEAD IN % | | | |
|---|---|---|---|---|---|
| | Clothia- | SYN | Clothia- | EXPECTED | OBSERVED |
| A5 | nidin | 545706 | nidin | MORTALITY | MORTALITY |
| 3.2 | 3 | 96 | 0 | 96 | 98* |
| 1.6 | 1.5 | 91 | 0 | 91 | 93* |
| 0.8 | 0.75 | 88 | 0 | 88 | 85 |
| 0.4 | 0.375 | 78 | 0 | 78 | 10 |
| 0.2 | 0.187 | 25 | | 25 | 0 |
| 1.6 | 3 | 91 | 0 | 91 | 85 |
| 0.8 | 1.5 | 88 | 0 | 88 | 85 |
| 0.4 | 0.75 | 78 | 0 | 78 | 70 |
| 0.2 | 0.375 | 25 | 0 | 25 | 0 |
| 0.8 | 3 | 88 | 0 | 88 | 98* |
| 0.4 | 1.5 | 78 | 0 | 78 | 88* |
| 0.2 | 0.75 | 25 | 0 | 25 | 0 |
| 0.8 | 6 | 88 | 45 | 93 | 93 |
| 0.4 | 3 | 78 | 0 | 78 | 90* |
| 0.2 | 1.5 | 25 | 0 | 25 | 0 |
| 0.8 | 12 | 88 | 80 | 98 | 90 |
| 0.4 | 6 | 78 | 45 | 88 | 90* |
| 0.2 | 3 | 25 | 0 | 25 | 0 |

TABLE 58

| | | AVERAGE | | | |
|---|---|---|---|---|---|
| PPM Al | | DEAD IN % | | | |
| | Aba- | | Aba- | EXPECTED | OBSERVED |
| A6 | mectin | A6 | mectin | MORTALITY | MORTALITY |
| 3.2 | 1.6 | 95 | 78 | 99 | 95 |
| 1.6 | 0.8 | 95 | 68 | 98 | 85 |
| 0.8 | 0.4 | 85 | 45 | 92 | 75 |
| 0.4 | 0.2 | 65 | 0 | 65 | 85* |
| 0.2 | 0.1 | 5 | | 5 | 0 |
| 1.6 | 1.6 | 95 | 78 | 99 | 95 |
| 0.8 | 0.8 | 85 | 68 | 95 | 85 |
| 0.4 | 0.4 | 65 | 45 | 81 | 35 |
| 0.2 | 0.2 | 5 | 0 | 5 | 0 |
| 0.8 | 1.6 | 85 | 78 | 97 | 85 |
| 0.4 | 0.8 | 65 | 68 | 89 | 75 |
| 0.2 | 0.4 | 5 | 45 | 48 | 55* |
| 0.8 | 3.2 | 85 | 100 | 100 | 100 |
| 0.4 | 1.6 | 65 | 78 | 92 | 90 |
| 0.2 | 0.8 | 5 | 68 | 69 | 60 |
| 0.1 | 0.4 | 0 | 45 | 45 | 35 |
| 0.8 | 6.4 | 85 | 100 | 100 | 100 |
| 0.4 | 3.2 | 65 | 100 | 100 | 100 |
| 0.2 | 1.6 | 5 | 78 | 79 | 60 |
| 0.1 | 0.8 | 0 | 68 | 68 | 75* |
| 0.05 | 0.4 | | 45 | 45 | 0 |

TABLE 59

| | | AVERAGE | | | |
|---|---|---|---|---|---|
| PPM Al | | DEAD IN % | | | |
| | Emamectin | | Emamectin | EXPECTED | OBSERVED |
| A6 | benzoate | A6 | benzoate | MORTALITY | MORTALITY |
| 3.2 | 0.006 | 100 | 0 | 100 | 95 |
| 1.6 | 0.003 | 90 | 0 | 90 | 90 |
| 0.8 | 0.0015 | 95 | 0 | 95 | 90 |
| 0.4 | 0.00075 | 70 | 0 | 70 | 45 |
| 0.2 | 0.000375 | 5 | | 5 | 0 |
| 1.6 | 0.006 | 90 | 0 | 90 | 90 |
| 0.8 | 0.003 | 95 | 0 | 95 | 85 |
| 0.4 | 0.0015 | 70 | 0 | 70 | 40 |
| 0.2 | 0.00075 | 5 | 0 | 5 | 50* |
| 0.8 | 0.006 | 95 | 0 | 95 | 90 |
| 0.4 | 0.003 | 70 | 0 | 70 | 60 |
| 0.2 | 0.0015 | 5 | 0 | 5 | 0 |
| 0.8 | 0.012 | 95 | 55 | 98 | 90 |
| 0.4 | 0.006 | 70 | 0 | 70 | 85* |
| 0.2 | 0.003 | 5 | 0 | 5 | 0 |
| 0.8 | 0.024 | 95 | 93 | 100 | 90 |
| 0.4 | 0.012 | 70 | 55 | 87 | 80 |
| 0.2 | 0.006 | 5 | 0 | 5 | 0 |

TABLE 60

| | | AVERAGE | | | |
|---|---|---|---|---|---|
| PPM Al | | DEAD IN % | | | |
| | Chlor- | | Chlor- | EXPECTED | OBSERVED |
| A6 | pyrifos | A6 | pyrifos | MORTALITY | MORTALITY |
| 3.2 | 200 | 100 | 100 | 100 | 100 |
| 1.6 | 100 | 100 | 100 | 100 | 100 |
| 0.8 | 50 | 95 | 90 | 100 | 100 |
| 0.4 | 25 | 65 | 45 | 81 | 65 |
| 1.6 | 200 | 100 | 100 | 100 | 100 |
| 0.8 | 100 | 95 | 100 | 100 | 100 |
| 0.4 | 50 | 65 | 90 | 97 | 75 |
| 0.2 | 25 | 0 | 45 | 45 | 65* |
| 0.8 | 200 | 95 | 100 | 100 | 95 |
| 0.4 | 100 | 65 | 100 | 100 | 100 |
| 0.2 | 50 | 0 | 90 | 90 | 85 |
| 0.1 | 25 | 0 | 45 | 45 | 0 |
| 0.8 | 400 | 95 | 100 | 100 | 100 |
| 0.4 | 200 | 65 | 100 | 100 | 100 |
| 0.2 | 100 | 0 | 100 | 100 | 100 |
| 0.1 | 50 | 0 | 90 | 90 | 80 |
| 0.05 | 25 | | 45 | 45 | 25 |
| 0.8 | 800 | 95 | 100 | 100 | 100 |
| 0.4 | 400 | 65 | 100 | 100 | 100 |
| 0.2 | 200 | 0 | 100 | 100 | 100 |
| 0.1 | 100 | 0 | 100 | 100 | 100 |
| 0.05 | 50 | | 90 | 90 | 85 |
| 0.025 | 25 | | 45 | 45 | 0 |

TABLE 61

| | | AVERAGE | | | |
|---|---|---|---|---|---|
| PPM Al | | DEAD IN % | | | |
| | Cyan- | | Cyan- | EXPECTED | OBSERVED |
| A6 | traniliprole | A6 | traniliprole | MORTALITY | MORTALITY |
| 3.2 | 0.2 | 95 | 78 | 99 | 100* |
| 1.6 | 0.1 | 95 | 45 | 97 | 90 |
| 0.8 | 0.05 | 85 | 0 | 85 | 90* |
| 0.4 | 0.025 | 80 | 0 | 80 | 50 |
| 0.2 | 0.0125 | 65 | | 65 | 0 |
| 1.6 | 0.2 | 95 | 78 | 99 | 90 |
| 0.8 | 0.1 | 85 | 45 | 92 | 90 |
| 0.4 | 0.05 | 80 | 0 | 80 | 85* |
| 0.2 | 0.025 | 65 | 0 | 65 | 25 |
| 0.8 | 0.2 | 85 | 78 | 97 | 95 |
| 0.4 | 0.1 | 80 | 45 | 89 | 85 |
| 0.2 | 0.05 | 65 | 0 | 65 | 25 |
| 0.8 | 0.4 | 85 | 90 | 99 | 95 |
| 0.4 | 0.2 | 80 | 78 | 96 | 90 |
| 0.2 | 0.1 | 65 | 45 | 81 | 65 |
| 0.1 | 0.05 | 0 | 0 | 0 | 25* |
| 0.8 | 0.8 | 85 | 100 | 100 | 100 |
| 0.4 | 0.4 | 80 | 90 | 98 | 90 |
| 0.2 | 0.2 | 65 | 78 | 92 | 85 |
| 0.1 | 0.1 | 0 | 45 | 45 | 65* |

TABLE 62

| | | AVERAGE | | | |
|---|---|---|---|---|---|
| PPM Al | | DEAD IN % | | | |
| | Lambda | | Lambda | | |
| | Cyhalo- | | Cyhalo- | EXPECTED | OBSERVED |
| A6 | thrin | A6 | thrin | MORTALITY | MORTALITY |
| 3.2 | 0.05 | 100 | 0 | 100 | 95 |
| 1.6 | 0.025 | 95 | 0 | 95 | 90 |
| 0.8 | 0.0125 | 90 | 0 | 90 | 70 |
| 0.4 | 0.00625 | 85 | 0 | 85 | 65 |
| 0.2 | 0.0032 | 25 | | 25 | 0 |
| 1.6 | 0.05 | 95 | 0 | 95 | 100* |
| 0.8 | 0.025 | 90 | 0 | 90 | 85 |
| 0.4 | 0.0125 | 85 | 0 | 85 | 40 |
| 0.2 | 0.00625 | 25 | 0 | 25 | 0 |
| 0.8 | 0.05 | 90 | 0 | 90 | 85 |
| 0.4 | 0.025 | 85 | 0 | 85 | 85 |
| 0.2 | 0.0125 | 25 | 0 | 25 | 0 |
| 0.8 | 0.1 | 90 | 25 | 93 | 80 |
| 0.4 | 0.05 | 85 | 0 | 85 | 65 |
| 0.2 | 0.025 | 25 | 0 | 25 | 0 |
| 0.8 | 0.2 | 90 | 75 | 98 | 80 |
| 0.4 | 0.1 | 85 | 25 | 89 | 80 |
| 0.2 | 0.05 | 25 | 0 | 25 | 25 |

TABLE 63

| | | AVERAGE | | | |
|---|---|---|---|---|---|
| PPM Al | | DEAD IN % | | | |
| | Pyme- | | Pyme- | EXPECTED | OBSERVED |
| A6 | trozine | A6 | trozine | MORTALITY | MORTALITY |
| 3.2 | 200 | 98 | 0 | 98 | 93 |
| 1.6 | 100 | 90 | 0 | 90 | 90 |
| 0.8 | 50 | 75 | 0 | 75 | 90* |
| 0.4 | 25 | 75 | 0 | 75 | 10 |
| 1.6 | 200 | 90 | 0 | 90 | 88 |
| 0.8 | 100 | 75 | 0 | 75 | 80* |
| 0.4 | 50 | 75 | 0 | 75 | 85* |
| 0.8 | 200 | 75 | 0 | 75 | 85* |
| 0.4 | 100 | 75 | 0 | 75 | 85* |
| 0.2 | 50 | 0 | 0 | 0 | 0 |
| 0.8 | 400 | 75 | 0 | 75 | 85* |
| 0.4 | 200 | 75 | 0 | 75 | 80* |
| 0.8 | 800 | 75 | 0 | 75 | 85* |
| 0.4 | 400 | 75 | 0 | 75 | 85* |

TABLE 64

| | | AVERAGE | | | |
|---|---|---|---|---|---|
| PPM AI | | DEAD IN % | | EXPECTED | OBSERVED |
| A6 | Spirotetramat | A6 | Spirotetramat | MORTALITY | MORTALITY |
| 3.2 | 50 | 98 | 0 | 98 | 95 |
| 1.6 | 25 | 90 | 0 | 90 | 93* |
| 0.8 | 12.5 | 90 | 0 | 90 | 90 |
| 0.4 | 6.25 | 45 | 0 | 45 | 75* |
| 0.2 | 3.125 | 0 | | 0 | 25* |
| 1.6 | 50 | 90 | 0 | 90 | 93* |
| 0.8 | 25 | 90 | 0 | 90 | 88 |
| 0.4 | 12.5 | 45 | 0 | 45 | 25 |
| 0.8 | 50 | 90 | 0 | 90 | 85 |
| 0.4 | 25 | 45 | 0 | 45 | 80* |
| 0.8 | 100 | 90 | 0 | 90 | 80 |
| 0.4 | 50 | 45 | 0 | 45 | 85* |
| 0.2 | 25 | 0 | 0 | 0 | 0 |
| 0.1 | 12.5 | 0 | 0 | 0 | 25* |
| 0.8 | 200 | 90 | 0 | 90 | 90 |
| 0.4 | 100 | 45 | 0 | 45 | 85* |
| 0.2 | 50 | 0 | 0 | 0 | 0 |
| 0.1 | 25 | 0 | 0 | 0 | 25* |

TABLE 65

| | | AVERAGE | | | |
|---|---|---|---|---|---|
| PPM AI | | DEAD IN % | | EXPECTED | OBSERVED |
| A6 | Thiamethoxam | A6 | Thiamethoxam | MORTALITY | MORTALITY |
| 3.2 | 50 | 95 | 0 | 95 | 95 |
| 1.6 | 25 | 95 | 0 | 95 | 90 |
| 0.8 | 12.5 | 85 | 0 | 85 | 85 |
| 0.4 | 6.25 | 70 | 0 | 70 | 45 |
| 0.2 | 3.125 | 35 | | 35 | 10 |
| 1.6 | 50 | 95 | 0 | 95 | 90 |
| 0.8 | 25 | 85 | 0 | 85 | 90* |
| 0.4 | 12.5 | 70 | 0 | 70 | 70 |
| 0.2 | 6.25 | 35 | 0 | 35 | 25 |
| 0.8 | 50 | 85 | 0 | 85 | 90* |
| 0.4 | 25 | 70 | 0 | 70 | 90* |
| 0.2 | 12.5 | 35 | 0 | 35 | 0 |
| 0.8 | 100 | 85 | 25 | 89 | 0 |
| 0.4 | 50 | 70 | 0 | 70 | 45 |
| 0.2 | 25 | 35 | 0 | 35 | 0 |
| 0.8 | 200 | 85 | 65 | 95 | 85 |
| 0.4 | 100 | 70 | 25 | 78 | 80* |
| 0.2 | 50 | 35 | 0 | 35 | 0 |

TABLE 66

| | | AVERAGE | | | |
|---|---|---|---|---|---|
| PPM AI | | DEAD IN % | | EXPECTED | OBSERVED |
| A6 | Flonicamid | A6 | Flonicamid | MORTALITY | MORTALITY |
| 3.2 | 100 | 95 | 0 | 95 | 95 |
| 1.6 | 50 | 90 | 0 | 90 | 95* |
| 0.8 | 25 | 75 | 0 | 75 | 85* |
| 0.4 | 12.5 | 65 | 0 | 65 | 70* |
| 0.2 | 6.25 | 25 | | 25 | 50* |
| 1.6 | 100 | 90 | 0 | 90 | 90 |
| 0.8 | 50 | 75 | 0 | 75 | 90* |
| 0.4 | 25 | 65 | 0 | 65 | 55 |
| 0.2 | 12.5 | 25 | 0 | 25 | 0 |
| 0.8 | 100 | 75 | 0 | 75 | 85* |
| 0.4 | 50 | 65 | 0 | 65 | 85* |
| 0.2 | 25 | 25 | 0 | 25 | 0 |
| 0.8 | 200 | 75 | 0 | 75 | 85* |
| 0.4 | 100 | 65 | 0 | 65 | 85* |
| 0.2 | 50 | 25 | 0 | 25 | 0 |
| 0.8 | 400 | 75 | 0 | 75 | 75 |
| 0.4 | 200 | 65 | 0 | 65 | 80* |
| 0.2 | 100 | 25 | 0 | 25 | 0 |

TABLE 67

| | | AVERAGE | | | |
|---|---|---|---|---|---|
| PPM AI | | DEAD IN % | | EXPECTED | OBSERVED |
| A6 | Imidacloprid | A6 | Imidacloprid | MORTALITY | MORTALITY |
| 3.2 | 50 | 100 | 50 | 100 | 100 |
| 1.6 | 25 | 95 | 20 | 96 | 93 |
| 0.8 | 12.5 | 85 | 0 | 85 | 45 |
| 0.4 | 6.25 | 85 | 0 | 85 | 0 |
| 1.6 | 50 | 95 | 50 | 98 | 95 |
| 0.8 | 25 | 85 | 20 | 88 | 88 |
| 0.4 | 12.5 | 85 | 0 | 85 | 25 |
| 0.8 | 50 | 85 | 50 | 93 | 90 |
| 0.4 | 25 | 85 | 20 | 88 | 75 |
| 0.8 | 100 | 85 | 95 | 99 | 93 |
| 0.4 | 50 | 85 | 50 | 93 | 93 |
| 0.2 | 25 | 0 | 20 | 20 | 0 |
| 0.1 | 12.5 | 0 | 0 | 0 | 5* |
| 0.8 | 200 | 85 | 100 | 100 | 100 |
| 0.4 | 100 | 85 | 95 | 99 | 95 |
| 0.2 | 50 | 0 | 50 | 50 | 0 |
| 0.1 | 25 | 0 | 20 | 20 | 0 |

TABLE 68

| | | AVERAGE | | | |
|---|---|---|---|---|---|
| PPM AI | | DEAD IN % | | EXPECTED | OBSERVED |
| A6 | Clothianidin | A6 | Clothianidin | MORTALITY | MORTALITY |
| 3.2 | 3 | 100 | 3 | 100 | 98 |
| 1.6 | 1.5 | 95 | 0 | 95 | 95 |
| 0.8 | 0.75 | 80 | 0 | 80 | 83* |
| 0.4 | 0.375 | 70 | 0 | 70 | 70 |
| 0.2 | 0.187 | 20 | | 20 | 10 |
| 1.6 | 3 | 95 | 3 | 95 | 95 |
| 0.8 | 1.5 | 80 | 0 | 80 | 95* |
| 0.4 | 0.75 | 70 | 0 | 70 | 65 |
| 0.2 | 0.375 | 20 | 0 | 20 | 0 |
| 0.8 | 3 | 80 | 3 | 81 | 80 |
| 0.4 | 1.5 | 70 | 0 | 70 | 80* |
| 0.2 | 0.75 | 20 | 0 | 20 | 0 |
| 0.8 | 6 | 80 | 38 | 88 | 90* |
| 0.4 | 3 | 70 | 3 | 71 | 75* |
| 0.2 | 1.5 | 20 | 0 | 20 | 0 |
| 0.8 | 12 | 80 | 48 | 90 | 90 |
| 0.4 | 6 | 70 | 38 | 81 | 85* |
| 0.2 | 3 | 20 | 3 | 22 | 0 |
| 0.1 | 1.5 | 0 | 0 | 0 | 10* |

TABLE 69

| | | AVERAGE | | | |
|---|---|---|---|---|---|
| PPM AI | | DEAD IN % | | EXPECTED | OBSERVED |
| A8 | Abamectin | A8 | Abamectin | MORTALITY | MORTALITY |
| 3.2 | 1.6 | 100 | 78 | 100 | 95 |
| 1.6 | 0.8 | 90 | 68 | 97 | 90 |
| 0.8 | 0.4 | 90 | 45 | 95 | 90 |
| 0.4 | 0.2 | 85 | 0 | 85 | 55 |
| 0.2 | 0.1 | 65 | | 65 | 0 |
| 1.6 | 1.6 | 90 | 78 | 98 | 85 |
| 0.8 | 0.8 | 90 | 68 | 97 | 80 |
| 0.4 | 0.4 | 85 | 45 | 92 | 60 |
| 0.2 | 0.2 | 65 | 0 | 65 | 50 |
| 0.8 | 1.6 | 90 | 78 | 98 | 90 |
| 0.4 | 0.8 | 85 | 68 | 95 | 75 |
| 0.2 | 0.4 | 65 | 45 | 81 | 50 |
| 0.1 | 0.2 | 0 | 0 | 0 | 40* |
| 0.8 | 3.2 | 90 | 100 | 100 | 90 |
| 0.4 | 1.6 | 85 | 78 | 97 | 90 |
| 0.2 | 0.8 | 65 | 68 | 89 | 70 |
| 0.1 | 0.4 | 0 | 45 | 45 | 50* |
| 0.8 | 6.4 | 90 | 100 | 100 | 100 |
| 0.4 | 3.2 | 85 | 100 | 100 | 95 |
| 0.2 | 1.6 | 65 | 78 | 92 | 85 |
| 0.1 | 0.8 | 0 | 68 | 68 | 40 |
| 0.05 | 0.4 | | 45 | 45 | 0 |

TABLE 70

| | | AVERAGE | | | |
|---|---|---|---|---|---|
| PPM AI | | DEAD IN % | | | |
| | Emamectin | | Emamectin | EXPECTED | OBSERVED |
| A8 | benzoate | A8 | benzoate | MORTALITY | MORTALITY |
| 3.2 | 0.006 | 95 | 0 | 95 | 90 |
| 1.6 | 0.003 | 90 | 0 | 90 | 90 |
| 0.8 | 0.0015 | 90 | 0 | 90 | 90 |
| 0.4 | 0.00075 | 45 | 0 | 45 | 50* |
| 1.6 | 0.006 | 90 | 0 | 90 | 85 |
| 0.8 | 0.003 | 90 | 0 | 90 | 75 |
| 0.4 | 0.0015 | 45 | 0 | 45 | 45 |
| 0.2 | 0.00075 | 0 | 0 | 0 | 10* |
| 0.1 | 0.000375 | 0 | | 0 | 10* |
| 0.8 | 0.006 | 90 | 0 | 90 | 90 |
| 0.4 | 0.003 | 45 | 0 | 45 | 80* |
| 0.8 | 0.012 | 90 | 55 | 96 | 85 |
| 0.4 | 0.006 | 45 | 0 | 45 | 75* |
| 0.8 | 0.024 | 90 | 93 | 99 | 90 |
| 0.4 | 0.012 | 45 | 55 | 75 | 80* |

TABLE 71

| | | AVERAGE | | | |
|---|---|---|---|---|---|
| PPM AI | | DEAD IN % | | EXPECTED | OBSERVED |
| A8 | Chlorpyrifos | A8 | Chlorpyrifos | MORTALITY | MORTALITY |
| 3.2 | 200 | 100 | 100 | 100 | 100 |
| 1.6 | 100 | 95 | 100 | 100 | 100 |
| 0.8 | 50 | 90 | 90 | 99 | 95 |
| 0.4 | 25 | 65 | 45 | 81 | 80 |
| 0.2 | 12.5 | 25 | | 25 | 25 |
| 0.1 | 6.25 | 0 | | 0 | 25* |
| 1.6 | 200 | 95 | 100 | 100 | 100 |
| 0.8 | 100 | 90 | 100 | 100 | 100 |
| 0.4 | 50 | 65 | 90 | 97 | 70 |
| 0.2 | 25 | 25 | 45 | 59 | 50 |
| 0.8 | 200 | 90 | 100 | 100 | 100 |
| 0.4 | 100 | 65 | 100 | 100 | 100 |
| 0.2 | 50 | 25 | 90 | 93 | 90 |
| 0.1 | 25 | 0 | 45 | 45 | 25 |
| 0.8 | 400 | 90 | 100 | 100 | 100 |
| 0.4 | 200 | 65 | 100 | 100 | 100 |
| 0.2 | 100 | 25 | 100 | 100 | 100 |
| 0.1 | 50 | 0 | 90 | 90 | 100* |
| 0.05 | 25 | | 45 | 45 | 0 |
| 0.8 | 800 | 90 | 100 | 100 | 100 |
| 0.4 | 400 | 65 | 100 | 100 | 100 |
| 0.2 | 200 | 25 | 100 | 100 | 0 |
| 0.1 | 100 | 0 | 100 | 100 | 100 |
| 0.05 | 50 | | 90 | 90 | 65 |
| 0.025 | 25 | | 45 | 45 | 0 |

TABLE 72

| | | AVERAGE | | | |
|---|---|---|---|---|---|
| PPM AI | | DEAD IN % | | EXPECTED | OBSERVED |
| A8 | Cyantraniliprole | A8 | Cyantraniliprole | MORTALITY | MORTALITY |
| 3.2 | 0.2 | 95 | 78 | 99 | 95 |
| 1.6 | 0.1 | 90 | 45 | 95 | 90 |
| 0.8 | 0.05 | 80 | 0 | 80 | 85* |
| 0.4 | 0.025 | 65 | 0 | 65 | 65 |
| 0.2 | 0.0125 | 50 | | 50 | 0 |
| 1.6 | 0.2 | 90 | 78 | 98 | 95 |
| 0.8 | 0.1 | 80 | 45 | 89 | 85 |
| 0.4 | 0.05 | 65 | 0 | 65 | 65 |
| 0.2 | 0.025 | 50 | 0 | 50 | 80* |
| 0.8 | 0.2 | 80 | 78 | 96 | 90 |
| 0.4 | 0.1 | 65 | 45 | 81 | 80 |
| 0.2 | 0.05 | 50 | 0 | 50 | 0 |
| 0.8 | 0.4 | 80 | 90 | 98 | 90 |
| 0.4 | 0.2 | 65 | 78 | 92 | 80 |
| 0.2 | 0.1 | 50 | 45 | 73 | 25 |
| 0.1 | 0.05 | 0 | 0 | 0 | 65* |
| 0.8 | 0.8 | 80 | 100 | 100 | 90 |
| 0.4 | 0.4 | 65 | 90 | 97 | 85 |
| 0.2 | 0.2 | 50 | 78 | 89 | 80 |
| 0.1 | 0.1 | 0 | 45 | 45 | 60* |

TABLE 73

| | | AVERAGE | | | |
|---|---|---|---|---|---|
| PPM AI | | DEAD IN % | | | |
| | Lambda | | Lambda | EXPECTED | OBSERVED |
| A8 | Cyhalothrin | A8 | Cyhalothrin | MORTALITY | MORTALITY |
| 3.2 | 0.05 | 95 | 0 | 95 | 100* |
| 1.6 | 0.025 | 90 | 0 | 90 | 95* |
| 0.8 | 0.0125 | 85 | 0 | 85 | 90* |
| 0.4 | 0.00625 | 75 | 0 | 75 | 75 |
| 0.2 | 0.0032 | 35 | | 35 | 0 |
| 1.6 | 0.05 | 90 | 0 | 90 | 90 |
| 0.8 | 0.025 | 85 | 0 | 85 | 80 |
| 0.4 | 0.0125 | 75 | 0 | 75 | 25 |
| 0.2 | 0.00625 | 35 | 0 | 35 | 25 |
| 0.8 | 0.05 | 85 | 0 | 85 | 90* |
| 0.4 | 0.025 | 75 | 0 | 75 | 75 |
| 0.2 | 0.0125 | 35 | 0 | 35 | 40* |
| 0.8 | 0.1 | 85 | 25 | 89 | 85 |
| 0.4 | 0.05 | 75 | 0 | 75 | 80* |
| 0.2 | 0.025 | 35 | 0 | 35 | 0 |
| 0.8 | 0.2 | 85 | 75 | 96 | 75 |
| 0.4 | 0.1 | 75 | 25 | 81 | 50 |
| 0.2 | 0.05 | 35 | 0 | 35 | 0 |

TABLE 74

| | | AVERAGE | | | |
|---|---|---|---|---|---|
| PPM AI | | DEAD IN % | | EXPECTED | OBSERVED |
| A8 | Pymetrozine | A8 | Pymetrozine | MORTALITY | MORTALITY |
| 3.2 | 200 | 93 | 0 | 93 | 93 |
| 1.6 | 100 | 90 | 0 | 90 | 90 |
| 0.8 | 50 | 85 | 0 | 85 | 75 |
| 0.4 | 25 | 65 | 0 | 65 | 55 |
| 0.2 | 12.5 | 50 | | 50 | 0 |
| 1.6 | 200 | 90 | 0 | 90 | 90 |
| 0.8 | 100 | 85 | 0 | 85 | 85 |
| 0.4 | 50 | 65 | 0 | 65 | 60 |
| 0.2 | 25 | 50 | 0 | 50 | 0 |
| 0.8 | 200 | 85 | 0 | 85 | 90* |
| 0.4 | 100 | 65 | 0 | 65 | 85* |
| 0.2 | 50 | 50 | 0 | 50 | 0 |
| 0.8 | 400 | 85 | 0 | 85 | 85 |
| 0.4 | 200 | 65 | 0 | 65 | 80* |
| 0.2 | 100 | 50 | 0 | 50 | 0 |
| 0.8 | 800 | 85 | 0 | 85 | 85 |
| 0.4 | 400 | 65 | 0 | 65 | 75* |
| 0.2 | 200 | 50 | 0 | 50 | 0 |
| 0.1 | 100 | 0 | 0 | 0 | 25* |

TABLE 75

| | | AVERAGE | | | |
|---|---|---|---|---|---|
| PPM AI | | DEAD IN % | | EXPECTED | OBSERVED |
| A8 | Spirotetramat | A8 | Spirotetramat | MORTALITY | MORTALITY |
| 3.2 | 50 | 100 | 0 | 100 | 98 |
| 1.6 | 25 | 93 | 0 | 93 | 93 |
| 0.8 | 12.5 | 90 | 0 | 90 | 85 |
| 0.4 | 6.25 | 25 | 0 | 25 | 0 |
| 1.6 | 50 | 93 | 0 | 93 | 90 |
| 0.8 | 25 | 90 | 0 | 90 | 90 |
| 0.4 | 12.5 | 25 | 0 | 25 | 45* |
| 0.8 | 50 | 90 | 0 | 90 | 90 |
| 0.4 | 25 | 25 | 0 | 25 | 90* |
| 0.8 | 100 | 90 | 0 | 90 | 88 |
| 0.4 | 50 | 25 | 0 | 25 | 85* |
| 0.8 | 200 | 90 | 0 | 90 | 90 |
| 0.4 | 100 | 25 | 0 | 25 | 80* |

TABLE 76

| | | AVERAGE | | EXPECTED | OBSERVED |
|---|---|---|---|---|---|
| PPM AI | | DEAD IN % | | MOR- | MOR- |
| A8 | Thiamethoxam | A8 | Thiamethoxam | TALITY | TALITY |
| 3.2 | 50 | 95 | 0 | 95 | 100* |
| 1.6 | 25 | 90 | 0 | 90 | 90 |
| 0.8 | 12.5 | 90 | 0 | 90 | 85 |
| 0.4 | 6.25 | 75 | 0 | 75 | 40 |
| 0.2 | 3.125 | 55 | | 55 | 10 |
| 0.1 | 1.563 | 0 | | 0 | 0 |
| 1.6 | 50 | 90 | 0 | 90 | 90 |
| 0.8 | 25 | 90 | 0 | 90 | 85 |
| 0.4 | 12.5 | 75 | 0 | 75 | 90* |
| 0.2 | 6.25 | 55 | 0 | 55 | 50 |
| 0.8 | 50 | 90 | 0 | 90 | 90 |
| 0.4 | 25 | 75 | 0 | 75 | 75 |
| 0.2 | 12.5 | 55 | 0 | 55 | 0 |
| 0.025 | 1.563 | | | 0 | 0 |
| 0.8 | 100 | 90 | 25 | 93 | 85 |
| 0.4 | 50 | 75 | 0 | 75 | 85* |
| 0.2 | 25 | 55 | 0 | 55 | 0 |
| 0.8 | 200 | 90 | 65 | 97 | 95 |
| 0.4 | 100 | 75 | 25 | 81 | 80 |
| 0.2 | 50 | 55 | 0 | 55 | 0 |
| 0.1 | 25 | 0 | 0 | 0 | 40* |

| | | AVERAGE | | | |
|---|---|---|---|---|---|
| PPM AI | | DEAD IN % | | EXPECTED | OBSERVED |
| A8 | Flonicamid | A8 | Flonicamid | MORTALITY | MORTALITY |
| 3.2 | 100 | 95 | 0 | 95 | 93 |
| 1.6 | 50 | 93 | 0 | 93 | 90 |
| 0.8 | 25 | 85 | 0 | 85 | 85 |
| 0.4 | 12.5 | 60 | 0 | 60 | 50 |
| 1.6 | 100 | 93 | 0 | 93 | 93 |
| 0.8 | 50 | 85 | 0 | 85 | 90* |
| 0.4 | 25 | 60 | 0 | 60 | 70* |
| 0.8 | 100 | 85 | 0 | 85 | 95* |
| 0.4 | 50 | 60 | 0 | 60 | 93* |
| 0.8 | 200 | 85 | 0 | 85 | 98* |
| 0.4 | 100 | 60 | 0 | 60 | 90* |
| 0.8 | 400 | 85 | 0 | 85 | 93* |
| 0.4 | 200 | 60 | 0 | 60 | 85* |

TABLE 78

| | | AVERAGE | | | |
|---|---|---|---|---|---|
| PPM AI | | DEAD IN % | | EXPECTED | OBSERVED |
| A8 | Imidacloprid | A8 | Imidacloprid | MORTALITY | MORTALITY |
| 3.2 | 50 | 100 | 50 | 100 | 95 |
| 1.6 | 25 | 95 | 20 | 96 | 93 |
| 0.8 | 12.5 | 90 | 0 | 90 | 70 |
| 0.4 | 6.25 | 60 | 0 | 60 | 60 |
| 1.6 | 50 | 95 | 50 | 98 | 93 |
| 0.8 | 25 | 90 | 20 | 92 | 88 |
| 0.4 | 12.5 | 60 | 0 | 60 | 30 |
| 0.8 | 50 | 90 | 50 | 95 | 93 |
| 0.4 | 25 | 60 | 20 | 68 | 85* |
| 0.2 | 12.5 | 0 | 0 | 0 | 20* |
| 0.8 | 100 | 90 | 95 | 100 | 98 |
| 0.4 | 50 | 60 | 50 | 80 | 90* |
| 0.2 | 25 | 0 | 20 | 20 | 10 |
| 0.1 | 12.5 | 0 | 0 | 0 | 15* |
| 0.8 | 200 | 90 | 100 | 100 | 100 |
| 0.4 | 100 | 60 | 95 | 98 | 85 |
| 0.2 | 50 | 0 | 50 | 50 | 35 |
| 0.1 | 25 | 0 | 20 | 20 | 25* |

TABLE 79

| | | AVERAGE | | | |
|---|---|---|---|---|---|
| PPM AI | | DEAD IN % | | EXPECTED | OBSERVED |
| A8 | Clothianidin | A8 | Clothianidin | MORTALITY | MORTALITY |
| 3.2 | 3 | 98 | 3 | 98 | 100* |
| 1.6 | 1.5 | 95 | 0 | 95 | 95 |
| 0.8 | 0.75 | 98 | 0 | 98 | 93 |
| 0.4 | 0.375 | 60 | 0 | 60 | 65* |
| 1.6 | 3 | 95 | 3 | 95 | 93 |
| 0.8 | 1.5 | 98 | 0 | 98 | 95 |
| 0.4 | 0.75 | 60 | 0 | 60 | 60 |
| 0.8 | 3 | 98 | 3 | 98 | 93 |
| 0.4 | 1.5 | 60 | 0 | 60 | 85* |
| 0.2 | 0.75 | 0 | 0 | 0 | 10* |
| 0.8 | 6 | 98 | 38 | 98 | 93 |
| 0.4 | 3 | 60 | 3 | 61 | 95* |
| 0.2 | 1.5 | 0 | 0 | 0 | 20* |
| 0.1 | 0.75 | 0 | 0 | 0 | 45* |
| 0.8 | 12 | 98 | 48 | 99 | 95 |

### Tetranychus Urticae (Two Spotted Spider Mite)

### (Contact/Feeding Activity)

Bean plants are infested with mite populations of mixed ages. 1 day after infestation, plants are treated in a spray chamber with diluted test solutions. 1 and 8 days later, samples are checked for adult mortality. 2 replicates per treatment were evaluated. Application rates are as indicated in the Tables.

TABLE 80

| | | AVERAGE | | | |
|---|---|---|---|---|---|
| | | DEAD IN % | | | |
| PPM AI | | AFTER 1 DAY | | EXPECTED | OBSERVED |
| A1 | Abamectin | A1 | Abamectin | MORTALITY | MORTALITY |
| 1.6 | 0.0015 | 0 | 0 | 0 | 0 |
| 1.6 | 0.003 | 0 | 0 | 0 | 0 |
| 1.6 | 0.006 | 0 | 0 | 0 | 10* |
| 3.125 | 0.0015 | 0 | 0 | 0 | 0 |
| 3.125 | 0.003 | 0 | 0 | 0 | 20* |
| 3.125 | 0.006 | 0 | 0 | 0 | 25* |
| 6.25 | 0.0015 | 40 | 0 | 40 | 25 |
| 6.25 | 0.003 | 40 | 0 | 40 | 10 |
| 6.25 | 0.006 | 40 | 0 | 40 | 30 |

TABLE 81

| | | AVERAGE | | | |
|---|---|---|---|---|---|
| | | DEAD IN % | | | |
| PPM AI | | AFTER 1 DAY | | EXPECTED | OBSERVED |
| A1 | Chlorpyrifos | A1 | Chlorpyrifos | MORTALITY | MORTALITY |
| 1.6 | 50 | 0 | 0 | 0 | 30* |
| 1.6 | 100 | 0 | 60 | 60 | 100* |
| 1.6 | 200 | 0 | 88 | 88 | 100* |
| 3.125 | 50 | 20 | 0 | 20 | 75* |
| 3.125 | 100 | 40 | 60 | 76 | 95* |
| 3.125 | 200 | 40 | 88 | 93 | 100* |
| 6.25 | 50 | 50 | 0 | 50 | 70* |
| 6.25 | 100 | 80 | 60 | 92 | 100* |
| 6.25 | 200 | 80 | 88 | 98 | 95 |

TABLE 82

| | | AVERAGE | | EX- | OB- |
|---|---|---|---|---|---|
| | | DEAD IN % | | PECTED | SERVED |
| PPM AI | | AFTER 1 DAY | | MORTAL- | MORTAL- |
| A1 | Cyantraniliprole | A1 | Cyantraniliprole | ITY | ITY |
| 1.6 | 100 | 0 | 0 | 0 | 30* |
| 1.6 | 200 | 0 | 10 | 10 | 55* |
| 3.125 | 100 | 20 | 0 | 20 | 60* |
| 3.125 | 200 | 20 | 10 | 28 | 65* |
| 6.25 | 100 | 50 | 0 | 50 | 85* |
| 6.25 | 200 | 50 | 10 | 55 | 80* |

TABLE 83

| | | AVERAGE | | | |
|---|---|---|---|---|---|
| | | DEAD IN % | | | |
| PPM AI | | AFTER 1 DAY | | | |
| | Emamectin | | Emamectin | EXPECTED | OBSERVED |
| A1 | benzoate | A1 | benzoate | MORTALITY | MORTALITY |
| 1.6 | 0.0125 | 0 | 0 | 0 | 0 |
| 1.6 | 0.025 | 0 | 8 | 8 | 0 |
| 1.6 | 0.05 | 0 | 0 | 0 | 10* |
| 3.125 | 0.0125 | 45 | 0 | 45 | 40 |
| 3.125 | 0.025 | 45 | 8 | 49 | 50* |
| 3.125 | 0.05 | 45 | 0 | 45 | 45 |
| 6.25 | 0.0125 | 80 | 0 | 80 | 90* |
| 6.25 | 0.025 | 80 | 8 | 82 | 95* |
| 6.25 | 0.05 | 80 | 0 | 80 | 100* |

TABLE 84

| | | AVERAGE | | | |
|---|---|---|---|---|---|
| | | DEAD IN % | | | |
| PPM AI | | AFTER 1 DAY | | | |
| | Lambda | | Lambda | EXPECTED | OBSERVED |
| A1 | Cyhalothrin | A1 | Cyhalothrin | MORTALITY | MORTALITY |
| 1.6 | 3.125 | 0 | 25 | 25 | 15 |
| 1.6 | 6.25 | 0 | 55 | 55 | 50 |
| 1.6 | 12.5 | 0 | 88 | 88 | 100* |
| 3.125 | 3.125 | 10 | 25 | 33 | 80* |
| 3.125 | 6.25 | 10 | 55 | 60 | 100* |
| 3.125 | 12.5 | 10 | 88 | 89 | 95* |
| 6.25 | 3.125 | 80 | 25 | 85 | 95* |
| 6.25 | 6.25 | 80 | 55 | 91 | 100* |
| 6.25 | 12.5 | 80 | 88 | 98 | 100* |

TABLE 85

| | | AVERAGE | | | |
|---|---|---|---|---|---|
| | | DEAD IN % | | | |
| PPM AI | | AFTER 1 DAY | | EXPECTED | OBSERVED |
| A1 | Pymetrozine | A1 | Pymetrozine | MORTALITY | MORTALITY |
| 1.6 | 200 | 0 | 5 | 5 | 0 |
| 3.125 | 200 | 40 | 5 | 43 | 40 |
| 6.25 | 200 | 80 | 5 | 81 | 80 |

TABLE 86

| | | AVERAGE | | | |
|---|---|---|---|---|---|
| | | DEAD IN % | | | |
| PPM AI | | AFTER 1 DAY | | EXPECTED | OBSERVED |
| A1 | Spirotetramat | A1 | Spirotetramat | MORTALITY | MORTALITY |
| 1.6 | 0.1 | 0 | 13 | 13 | 10 |
| 1.6 | 0.2 | 0 | 18 | 18 | 35* |
| 1.6 | 0.4 | 0 | 23 | 23 | 35* |
| 3.125 | 0.1 | 15 | 13 | 26 | 20 |
| 3.125 | 0.2 | 15 | 18 | 30 | 10 |
| 3.125 | 0.4 | 15 | 23 | 35 | 25 |
| 6.25 | 0.1 | 75 | 13 | 78 | 90* |
| 6.25 | 0.2 | 75 | 18 | 80 | 95* |
| 6.25 | 0.4 | 75 | 23 | 81 | 85* |

TABLE 87

| | | AVERAGE | | EX- | OB- |
|---|---|---|---|---|---|
| | | DEAD IN % | | PECTED | SERVED |
| PPM AI | | AFTER 1 DAY | | MORTAL- | MORTAL- |
| A1 | Thiamethoxam | A1 | Thiamethoxam | ITY | ITY |
| 1.6 | 200 | 0 | 0 | 0 | 35 |
| 3.125 | 200 | 40 | 0 | 40 | 15 |
| 6.25 | 200 | 80 | 0 | 80 | 100 |

TABLE 88

| | | AVERAGE | | | |
|---|---|---|---|---|---|
| | | DEAD IN % | | | |
| PPM AI | | AFTER 1 DAY | | EXPECTED | OBSERVED |
| A5 | Abamectin | A5 | Abamectin | MORTALITY | MORTALITY |
| 0.4 | 0.0015 | 0 | 0 | 0 | 0 |
| 0.4 | 0.003 | 0 | 0 | 0 | 10* |
| 0.4 | 0.006 | 0 | 0 | 0 | 20* |
| 0.8 | 0.0015 | 20 | 0 | 20 | 0 |
| 0.8 | 0.003 | 20 | 0 | 20 | 0 |
| 0.8 | 0.006 | 20 | 0 | 20 | 25* |
| 1.6 | 0.0015 | 80 | 0 | 80 | 15 |
| 1.6 | 0.003 | 80 | 0 | 80 | 45 |
| 1.6 | 0.006 | 80 | 0 | 80 | 30 |

TABLE 89

| | | AVERAGE | | | |
|---|---|---|---|---|---|
| | | DEAD IN % | | | |
| PPM AI | | AFTER 1 DAY | | EXPECTED | OBSERVED |
| A5 | Chlorpyrifos | A5 | Chlorpyrifos | MORTALITY | MORTALITY |
| 0.4 | 50 | 0 | 0 | 0 | 10 |
| 0.4 | 100 | 0 | 60 | 60 | 60 |
| 0.4 | 200 | 0 | 88 | 88 | 100* |
| 0.8 | 50 | 30 | 0 | 30 | 40* |
| 0.8 | 100 | 0 | 60 | 60 | 100* |
| 0.8 | 200 | 0 | 88 | 88 | 95* |
| 1.6 | 50 | 30 | 0 | 30 | 80* |
| 1.6 | 100 | 75 | 60 | 90 | 95* |
| 1.6 | 200 | 75 | 88 | 97 | 95 |

TABLE 90

| | | AVERAGE | | EX- | OB- |
|---|---|---|---|---|---|
| | | DEAD IN % | | PECTED | SERVED |
| PPM AI | | AFTER 1 DAY | | MORTAL- | MORTAL- |
| A5 | Cyantraniliprole | A5 | Cyantraniliprole | ITY | ITY |
| 0.4 | 100 | 0 | 0 | 0 | 70* |
| 0.4 | 200 | 0 | 10 | 10 | 70* |
| 0.8 | 100 | 30 | 0 | 30 | 50* |
| 0.8 | 200 | 30 | 10 | 37 | 60* |
| 1.6 | 100 | 30 | 0 | 30 | 55* |
| 1.6 | 200 | 30 | 10 | 37 | 80* |

TABLE 91

| | | AVERAGE | | | |
|---|---|---|---|---|---|
| | | DEAD IN % | | | |
| PPM AI | | AFTER 1 DAY | | | |
| | Emamectin | | Emamectin | EXPECTED | OBSERVED |
| A5 | benzoate | A5 | benzoate | MORTALITY | MORTALITY |
| 0.4 | 0.0125 | 0 | 0 | 0 | 0 |
| 0.4 | 0.025 | 0 | 8 | 8 | 0 |
| 0.4 | 0.05 | 0 | 0 | 0 | 20* |
| 0.8 | 0.0125 | 15 | 0 | 15 | 20* |
| 0.8 | 0.025 | 15 | 8 | 22 | 30* |
| 0.8 | 0.05 | 15 | 0 | 15 | 25* |
| 1.6 | 0.0125 | 65 | 0 | 65 | 40 |
| 1.6 | 0.025 | 65 | 8 | 68 | 55 |
| 1.6 | 0.05 | 65 | 0 | 65 | 85* |

TABLE 92

| | | AVERAGE | | | |
|---|---|---|---|---|---|
| | | DEAD IN % | | EX- | OB- |
| PPM AI | | AFTER 1 DAY | | PECTED | SERVED |
| | Lambda | | Lambda | MORTAL- | MORTAL- |
| A5 | Cyhalothrin | A5 | Cyhalothrin | ITY | ITY |
| 0.4 | 3.125 | 10 | 25 | 33 | 15 |
| 0.4 | 6.25 | 10 | 55 | 60 | 60 |
| 0.4 | 12.5 | 10 | 88 | 89 | 95* |
| 0.8 | 3.125 | 35 | 25 | 51 | 80* |
| 0.8 | 6.25 | 35 | 55 | 71 | 80* |
| 0.8 | 12.5 | 35 | 88 | 92 | 100* |
| 1.6 | 3.125 | 75 | 25 | 81 | 45 |
| 1.6 | 6.25 | 75 | 55 | 89 | 75 |
| 1.6 | 12.5 | 75 | 88 | 97 | 100* |

TABLE 93

| | | AVERAGE | | | |
|---|---|---|---|---|---|
| | | DEAD IN % | | | |
| PPM AI | | AFTER 1 DAY | | EXPECTED | OBSERVED |
| A5 | Pymetrozine | A5 | Pymetrozine | MORTALITY | MORTALITY |
| 0.4 | 200 | 0 | 5 | 5 | 0 |
| 0.8 | 200 | 0 | 5 | 5 | 35* |
| 1.6 | 200 | 75 | 5 | 76 | 70 |

TABLE 94

| | | AVERAGE | | | |
|---|---|---|---|---|---|
| | | DEAD IN % | | | |
| PPM Al | | AFTER 1 DAY | | EXPECTED | OBSERVED |
| A5 | Spirotetramat | A5 | Spirotetramat | MORTALITY | MORTALITY |
| 0.4 | 0.1 | 0 | 13 | 13 | 10 |
| 0.4 | 0.2 | 0 | 18 | 18 | 10 |
| 0.4 | 0.4 | 0 | 23 | 23 | 15 |
| 0.8 | 0.1 | 0 | 13 | 13 | 10 |
| 0.8 | 0.2 | 0 | 18 | 18 | 25* |
| 0.8 | 0.4 | 0 | 23 | 23 | 40* |
| 1.6 | 0.1 | 10 | 13 | 22 | 10 |
| 1.6 | 0.2 | 10 | 18 | 26 | 35* |
| 1.6 | 0.4 | 10 | 23 | 31 | 25 |

TABLE 95

| | | AVERAGE | | | |
|---|---|---|---|---|---|
| | | DEAD IN % | | EXPECTED | OBSERVED |
| PPM Al | | AFTER 1 DAY | | MORTAL- | MORTAL- |
| A5 | Thiamethoxam | A5 | Thiamethoxam | ITY | ITY |
| 0.4 | 200 | 0 | 0 | 0 | 0 |
| 0.8 | 200 | 0 | 0 | 0 | 40* |
| 1.6 | 200 | 75 | 0 | 75 | 65 |

TABLE 96

| | | AVERAGE | | | |
|---|---|---|---|---|---|
| | | DEAD IN % | | | |
| PPM Al | | AFTER 1 DAY | | EXPECTED | OBSERVED |
| | Lambda | | Lambda | MORTAL- | MORTAL- |
| A6 | Cyhalothrin | A6 | Cyhalothrin | ITY | ITY |
| 0.2 | 3.125 | 3 | 70 | 71 | 100* |
| 0.2 | 6.25 | 3 | 90 | 90 | 100* |
| 0.2 | 12.5 | 3 | 83 | 84 | 100* |
| 0.4 | 3.125 | 20 | 70 | 76 | 100* |
| 0.4 | 6.25 | 20 | 90 | 92 | 100* |
| 0.4 | 12.5 | 20 | 83 | 86 | 100* |
| 0.8 | 3.125 | 85 | 70 | 96 | 90 |
| 0.8 | 6.25 | 85 | 90 | 99 | 100* |
| 0.8 | 12.5 | 85 | 83 | 97 | 100* |

TABLE 97

| | | AVERAGE DEAD IN % | | | OB- |
|---|---|---|---|---|---|
| PPM Al | | AFTER 1 DAY | | EXPECTED | SERVED |
| | Lambda | | Lambda | MORTAL- | MORTAL- |
| A8 | Cyhalothrin | A8 | Cyhalothrin | ITY | ITY |
| 0.4 | 3.125 | 38 | 70 | 81 | 95* |
| 0.4 | 6.25 | 38 | 90 | 94 | 100* |
| 0.4 | 12.5 | 38 | 83 | 89 | 100* |
| 0.8 | 3.125 | 35 | 70 | 81 | 90* |
| 0.8 | 6.25 | 35 | 90 | 94 | 85 |
| 0.8 | 12.5 | 35 | 83 | 89 | 85 |
| 1.5 | 3.125 | 100 | 70 | 100 | 90 |
| 1.5 | 6.25 | 100 | 90 | 100 | 95 |
| 1.5 | 12.5 | 100 | 83 | 100 | 95 |

TABLE 98

| | | AVERAGE | | | |
|---|---|---|---|---|---|
| | | DEAD IN % | | EXPECTED | OBSERVED |
| PPM Al | | AFTER 8 DAYS | | MORTAL- | MORTAL- |
| A1 | Abamectin | A1 | Abamectin | ITY | ITY |
| 1.5 | 0.0015 | 30 | 25 | 48 | 35 |
| 1.5 | 0.003 | 30 | 20 | 44 | 30 |
| 1.5 | 0.006 | 30 | 25 | 48 | 35 |
| 3.125 | 0.0015 | 45 | 25 | 59 | 70* |
| 3.125 | 0.003 | 45 | 20 | 56 | 75* |
| 3.125 | 0.006 | 45 | 25 | 59 | 75* |
| 6.25 | 0.0015 | 65 | 25 | 74 | 100* |
| 6.25 | 0.003 | 65 | 20 | 72 | 100* |
| 6.25 | 0.006 | 65 | 25 | 74 | 100* |

TABLE 99

| | | AVERAGE | | EXPECT- | OBSERV- |
|---|---|---|---|---|---|
| | | DEAD IN % | | ED | ED |
| PPM Al | | AFTER 8 DAYS | | MORTAL- | MORTAL- |
| A1 | Chlorpyrifos | A1 | Chlorpyrifos | ITY | ITY |
| 1.5 | 50 | 30 | 0 | 30 | 65* |
| 1.5 | 100 | 10 | 20 | 28 | 80* |
| 1.5 | 200 | 10 | 63 | 67 | 75* |
| 3.125 | 50 | 85 | 0 | 85 | 100* |
| 3.125 | 100 | 60 | 20 | 68 | 95* |
| 3.125 | 200 | 60 | 63 | 85 | 95* |
| 6.25 | 50 | 90 | 0 | 90 | 95* |
| 6.25 | 100 | 90 | 20 | 92 | 100* |
| 6.25 | 200 | 90 | 63 | 96 | 100* |

TABLE 100

| | | AVERAGE | | EXPECT- | OBSERV- |
|---|---|---|---|---|---|
| | | DEAD IN % | | ED | ED |
| PPM Al | | AFTER 8 DAYS | | MORTAL- | MORTAL- |
| A1 | Cyantraniliprole | A1 | Cyantraniliprole | ITY | ITY |
| 1.5 | 100 | 30 | 35 | 55 | 75* |
| 1.5 | 200 | 30 | 25 | 48 | 85* |
| 3.125 | 100 | 85 | 35 | 90 | 100* |
| 3.125 | 200 | 85 | 25 | 89 | 80 |
| 6.25 | 100 | 90 | 35 | 94 | 95* |
| 6.25 | 200 | 90 | 25 | 93 | 100* |

TABLE 101

| | | AVERAGE | | | |
|---|---|---|---|---|---|
| | | DEAD IN % | | | OBSERV- |
| PPM Al | | AFTER 8 DAYS | | EXPECTED | ED |
| | Emamectin | | Emamectin | MORTAL- | MORTAL- |
| A1 | benzoate | A1 | benzoate | ITY | ITY |
| 1.5 | 0.0125 | 30 | 5 | 34 | 40* |
| 1.5 | 0.025 | 30 | 23 | 46 | 40 |
| 1.5 | 0.05 | 30 | 38 | 57 | 80* |
| 3.125 | 0.0125 | 85 | 5 | 86 | 100* |
| 3.125 | 0.025 | 85 | 23 | 88 | 100* |
| 3.125 | 0.05 | 85 | 38 | 91 | 95* |
| 6.25 | 0.0125 | 95 | 5 | 95 | 100* |
| 6.25 | 0.025 | 95 | 23 | 96 | 100* |
| 6.25 | 0.05 | 95 | 38 | 97 | 100* |

TABLE 102

| | | AVERAGE | | | |
|---|---|---|---|---|---|
| | | DEAD IN % | | | |
| PPM Al | | AFTER 8 DAYS | | EXPECTED | OBSERVED |
| | Lambda | | Lambda | MORTAL- | MORTAL- |
| A1 | Cyhalothrin | A1 | Cyhalothrin | ITY | ITY |
| 1.5 | 3.125 | 10 | 20 | 28 | 20 |
| 1.5 | 6.25 | 10 | 85 | 87 | 80 |
| 1.5 | 12.5 | 10 | 98 | 98 | 100* |
| 3.125 | 3.125 | 45 | 20 | 56 | 95* |
| 3.125 | 6.25 | 45 | 85 | 92 | 100* |
| 3.125 | 12.5 | 45 | 98 | 99 | 100* |
| 6.25 | 3.125 | 85 | 20 | 88 | 95* |
| 6.25 | 6.25 | 85 | 85 | 98 | 100* |
| 6.25 | 12.5 | 85 | 98 | 100 | 100 |

TABLE 103

| | | AVERAGE | | | |
|---|---|---|---|---|---|
| | | DEAD IN % | | | OBSERVED |
| PPM Al | | AFTER 8 DAYS | | EXPECTED | MORTAL- |
| A1 | Pymetrozine | A1 | Pymetrozine | MORTALITY | ITY |
| 1.5 | 200 | 10 | 0 | 10 | 50* |
| 3.125 | 200 | 60 | 0 | 60 | 60 |
| 6.25 | 200 | 90 | 0 | 90 | 95* |

TABLE 104

| | | AVERAGE | | | |
|---|---|---|---|---|---|
| | | DEAD IN % | | EXPECTED | OBSERVED |
| PPM Al | | AFTER 8 DAYS | | MORTAL- | MORTAL- |
| A1 | Spirotetramat | A1 | Spirotetramat | ITY | ITY |
| 1.5 | 0.1 | 0 | 10 | 10 | 5 |
| 1.5 | 0.2 | 0 | 33 | 33 | 65* |
| 1.5 | 0.4 | 0 | 38 | 38 | 75* |
| 3.125 | 0.1 | 90 | 10 | 91 | 95* |
| 3.125 | 0.2 | 90 | 33 | 93 | 100* |
| 3.125 | 0.4 | 90 | 38 | 94 | 100* |
| 6.25 | 0.1 | 100 | 10 | 100 | 100 |
| 6.25 | 0.2 | 100 | 33 | 100 | 100 |
| 6.25 | 0.4 | 100 | 38 | 100 | 100 |

TABLE 105

| | | AVERAGE | | EXPECT- | OBSERV- |
|---|---|---|---|---|---|
| | | DEAD IN % | | ED | ED |
| PPM Al | | AFTER 8 DAYS | | MORTAL- | MORTAL- |
| A1 | Thiamethoxam | A1 | Thiamethoxam | ITY | ITY |
| 1.5 | 200 | 10 | 5 | 15 | 35* |
| 3.125 | 200 | 60 | 5 | 62 | 70* |
| 6.25 | 200 | 90 | 5 | 91 | 100* |

TABLE 106

| | | AVERAGE | | | |
|---|---|---|---|---|---|
| | | DEAD IN % | | | |
| PPM Al | | AFTER 8 DAYS | | EXPECTED | OBSERVED |
| A5 | Abamectin | A5 | Abamectin | MORTALITY | MORTALITY |
| 0.4 | 0.0015 | 45 | 25 | 59 | 30 |
| 0.4 | 0.003 | 45 | 20 | 56 | 35 |
| 0.4 | 0.006 | 45 | 25 | 59 | 40 |
| 0.8 | 0.0015 | 80 | 25 | 85 | 35 |
| 0.8 | 0.003 | 80 | 20 | 84 | 55 |
| 0.8 | 0.006 | 80 | 25 | 85 | 75 |
| 1.5 | 0.0015 | 100 | 25 | 100 | 100 |
| 1.5 | 0.003 | 100 | 20 | 100 | 95 |
| 1.5 | 0.006 | 100 | 25 | 100 | 100 |

TABLE 107

| | | AVERAGE | | | |
|---|---|---|---|---|---|
| | | DEAD IN % | | EXPECTED | OBSERVED |
| PPM Al | | AFTER 8 DAYS | | MORTAL- | MORTAL- |
| A5 | Chlorpyrifos | A5 | Chlorpyrifos | ITY | ITY |
| 0.4 | 50 | 25 | 0 | 25 | 55* |
| 0.4 | 100 | 0 | 20 | 20 | 40* |
| 0.4 | 200 | 0 | 63 | 63 | 65* |
| 0.8 | 50 | 65 | 0 | 65 | 75* |
| 0.8 | 100 | 25 | 20 | 40 | 80* |
| 0.8 | 200 | 25 | 63 | 72 | 85* |
| 1.5 | 50 | 100 | 0 | 100 | 100 |
| 1.5 | 100 | 100 | 20 | 100 | 100 |
| 1.5 | 200 | 100 | 63 | 100 | 100 |

TABLE 108

| | | AVERAGE | | | |
|---|---|---|---|---|---|
| | | DEAD IN % | | EXPECTED | OBSERVED |
| PPM Al | | AFTER 8 DAYS | | MORTAL- | MORTAL- |
| A5 | Cyantraniliprole | A5 | Cyantraniliprole | ITY | ITY |
| 0.4 | 100 | 25 | 35 | 51 | 100* |
| 0.4 | 200 | 25 | 25 | 44 | 90* |
| 0.8 | 100 | 65 | 35 | 77 | 80* |
| 0.8 | 200 | 65 | 25 | 74 | 85* |
| 1.5 | 100 | 100 | 35 | 100 | 100 |
| 1.5 | 200 | 100 | 25 | 100 | 100 |

TABLE 109

| | | AVERAGE | | | |
|---|---|---|---|---|---|
| | | DEAD IN % | | | |
| PPM A1 | | AFTER 8 DAYS | | | |
| | Emamectin | | Emamectin | EXPECTED | OBSERVED |
| A5 | benzoate | A5 | benzoate | MORTALITY | MORTALITY |
| 0.4 | 0.0125 | 15 | 5 | 19 | 5 |
| 0.4 | 0.025 | 15 | 23 | 35 | 10 |
| 0.4 | 0.05 | 15 | 38 | 47 | 25 |
| 0.8 | 0.0125 | 55 | 5 | 57 | 85* |
| 0.8 | 0.025 | 55 | 23 | 65 | 95* |
| 0.8 | 0.05 | 55 | 38 | 72 | 80* |
| 1.5 | 0.0125 | 100 | 5 | 100 | 100 |
| 1.5 | 0.025 | 100 | 23 | 100 | 100 |
| 1.5 | 0.05 | 100 | 38 | 100 | 100 |

TABLE 110

| | | AVERAGE | | | |
|---|---|---|---|---|---|
| | | DEAD IN % | | | |
| PPM A1 | | AFTER 8 DAYS | | | |
| | Lambda | | Lambda | EXPECTED | OBSERVED |
| A5 | Cyhalothrin | A5 | Cyhalothrin | MORTALITY | MORTALITY |
| 0.4 | 3.125 | 0 | 20 | 20 | 10 |
| 0.4 | 6.25 | 0 | 85 | 85 | 60 |
| 0.4 | 12.5 | 0 | 98 | 98 | 100 |
| 0.8 | 3.125 | 40 | 20 | 52 | 30 |
| 0.8 | 6.25 | 40 | 85 | 91 | 50 |
| 0.8 | 12.5 | 40 | 98 | 99 | 100* |
| 1.5 | 3.125 | 100 | 20 | 100 | 100 |
| 1.5 | 6.25 | 100 | 85 | 100 | 100 |
| 1.5 | 12.5 | 100 | 98 | 100 | 100 |

TABLE 111

| | | AVERAGE | | | |
|---|---|---|---|---|---|
| | | DEAD IN % | | | |
| PPM A1 | | AFTER 8 DAYS | | EXPECTED | OBSERVED |
| A5 | Pymetrozine | A5 | Pymetrozine | MORTALITY | MORTALITY |
| 0.4 | 200 | 0 | 0 | 0 | 15* |
| 0.8 | 200 | 25 | 0 | 25 | 35* |
| 1.5 | 200 | 100 | 0 | 100 | 100 |

TABLE 112

| | | AVERAGE | | | |
|---|---|---|---|---|---|
| | | DEAD IN % | | | |
| PPM A1 | | AFTER 8 DAYS | | EXPECTED | OBSERVED |
| A5 | Spirotetramat | A5 | Spirotetramat | MORTALITY | MORTALITY |
| 0.4 | 0.1 | 0 | 10 | 10 | 0 |
| 0.4 | 0.2 | 0 | 33 | 33 | 0 |
| 0.4 | 0.4 | 0 | 38 | 38 | 35 |
| 0.8 | 0.1 | 35 | 10 | 42 | 95* |
| 0.8 | 0.2 | 35 | 33 | 56 | 95* |
| 0.8 | 0.4 | 35 | 38 | 60 | 100* |
| 1.5 | 0.1 | 100 | 10 | 100 | 100 |
| 1.5 | 0.2 | 100 | 33 | 100 | 100 |
| 1.5 | 0.4 | 100 | 38 | 100 | 100 |

TABLE 113

| | | AVERAGE | | | |
|---|---|---|---|---|---|
| | | DEAD IN % | | | |
| PPM A1 | | AFTER 8 DAYS | | EXPECTED | OBSERVED |
| A5 | Thiamethoxam | A5 | Thiamethoxam | MORTALITY | MORTALITY |
| 0.4 | 200 | 0 | 5 | 5 | 0 |
| 0.8 | 200 | 25 | 5 | 29 | 40* |
| 1.5 | 200 | 100 | 5 | 100 | 100 |

TABLE 114

| | | AVERAGE | | | |
|---|---|---|---|---|---|
| | | DEAD IN % | | | |
| PPM A1 | | AFTER 8 DAYS | | | |
| | Lambda | | Lambda | EXPECTED | OBSERVED |
| A6 | Cyhalothrin | A6 | Cyhalothrin | MORTALITY | MORTALITY |
| 0.2 | 3.125 | 3 | 75 | 76 | 100* |
| 0.2 | 6.25 | 3 | 90 | 90 | 100* |
| 0.2 | 12.5 | 3 | 90 | 90 | 100* |
| 0.4 | 3.125 | 60 | 75 | 90 | 100* |
| 0.4 | 6.25 | 60 | 90 | 96 | 100* |
| 0.4 | 12.5 | 60 | 90 | 96 | 100* |
| 0.8 | 3.125 | 85 | 75 | 96 | 100* |
| 0.8 | 6.25 | 85 | 90 | 99 | 100* |
| 0.8 | 12.5 | 85 | 90 | 99 | 100* |

TABLE 115

| | | AVERAGE | | | |
|---|---|---|---|---|---|
| | | DEAD IN % | | | |
| PPM A1 | | AFTER 8 DAYS | | | |
| | Lambda | | Lambda | EXPECTED | OBSERVED |
| A8 | Cyhalothrin | A8 | Cyhalothrin | MORTALITY | MORTALITY |
| 0.4 | 3.125 | 55 | 75 | 89 | 100* |
| 0.4 | 6.25 | 55 | 90 | 96 | 100* |
| 0.4 | 12.5 | 55 | 90 | 96 | 100* |
| 0.8 | 3.125 | 38 | 75 | 85 | 100* |
| 0.8 | 6.25 | 38 | 90 | 94 | 100* |
| 0.8 | 12.5 | 38 | 90 | 94 | 100* |
| 1.5 | 3.125 | 100 | 75 | 100 | 100 |
| 1.5 | 6.25 | 100 | 90 | 100 | 100 |
| 1.5 | 12.5 | 100 | 90 | 100 | 100 |

### Tetranychus Urticae (Two-Spotted Spider Mite)

Bean leaf discs on agar in 24-well microtiter plates are sprayed with test solutions (DMSO). After drying, the leaf discs are infested with mite populations of mixed ages. 8 days later, discs are checked for mixed population mortality. Application rates are as indicated in the Tables.

TABLE 116

| | | AVERAGE | | | |
|---|---|---|---|---|---|
| PPM A1 | | DEAD IN % | | EXPECTED | OBSERVED |
| A6 | Abamectin | A6 | Abamectin | MORTALITY | MORTALITY |
| 0.4 | 0.1 | 90 | 85 | 99 | 100* |
| 0.4 | 0.05 | 90 | 85 | 99 | 100* |
| 0.4 | 0.025 | 90 | 0 | 90 | 100* |
| 0.4 | 0.0125 | 90 | 0 | 90 | 100* |
| 0.4 | 0.006 | 90 | 0 | 90 | 90 |
| 0.4 | 0.003 | 90 | 0 | 90 | 100* |
| 0.4 | 0.0015 | 90 | 0 | 90 | 100* |
| 0.4 | 0.0008 | 90 | 0 | 90 | 100* |
| 0.4 | 0.0004 | 90 | 0 | 90 | 100* |
| 0.4 | 0.0002 | 90 | 0 | 90 | 100* |
| 0.2 | 0.1 | 0 | 85 | 85 | 95* |
| 0.2 | 0.05 | 0 | 85 | 85 | 100* |
| 0.2 | 0.025 | 0 | 0 | 0 | 90* |
| 0.2 | 0.0125 | 0 | 0 | 0 | 90* |
| 0.2 | 0.006 | 0 | 0 | 0 | 80* |
| 0.2 | 0.003 | 0 | 0 | 0 | 90* |
| 0.2 | 0.0015 | 0 | 0 | 0 | 90* |
| 0.2 | 0.0008 | 0 | 0 | 0 | 90* |
| 0.2 | 0.0004 | 0 | 0 | 0 | 70* |
| 0.2 | 0.0002 | 0 | 0 | 0 | 75* |
| 0.1 | 0.1 | 0 | 85 | 85 | 90* |
| 0.1 | 0.05 | 0 | 85 | 85 | 80 |
| 0.05 | 0.1 | 0 | 85 | 85 | 45 |
| 0.05 | 0.05 | 0 | 85 | 85 | 40 |

TABLE 117

| | | AVERAGE | | | |
|---|---|---|---|---|---|
| PPM A1 | | DEAD IN % | | EXPECTED | OBSERVED |
| A6 | Emamectin | A6 | Emamectin | MORTALITY | MORTALITY |
| 0.8 | 0.8 | 100 | 95 | 100 | 95 |
| 0.4 | 0.4 | 75 | 93 | 98 | 85 |
| 0.2 | 0.2 | 25 | 75 | 81 | 65 |
| 0.1 | 0.1 | 0 | 70 | 70 | 65 |
| 0.4 | 0.8 | 75 | 95 | 99 | 100* |
| 0.2 | 0.4 | 25 | 93 | 94 | 95* |
| 0.1 | 0.2 | 0 | 75 | 75 | 75 |
| 0.05 | 0.1 | 0 | 70 | 70 | 25 |
| 0.2 | 0.8 | 25 | 95 | 96 | 100* |
| 0.1 | 0.4 | 0 | 93 | 93 | 100* |
| 0.05 | 0.2 | 0 | 75 | 75 | 60 |
| 0.025 | 0.1 | 0 | 70 | 70 | 25 |
| 0.2 | 1.6 | 25 | 95 | 96 | 100* |
| 0.1 | 0.8 | 0 | 95 | 95 | 100* |
| 0.05 | 0.4 | 0 | 93 | 93 | 75 |
| 0.025 | 0.2 | 0 | 75 | 75 | 90* |
| 0.0125 | 0.1 | | 70 | 70 | 65 |
| 0.2 | 3.2 | 25 | 100 | 100 | 100 |
| 0.1 | 1.6 | 0 | 95 | 95 | 100* |
| 0.05 | 0.8 | 0 | 95 | 95 | 95 |
| 0.025 | 0.4 | 0 | 93 | 93 | 90 |
| 0.0125 | 0.2 | | 75 | 75 | 60 |
| 0.00625 | 0.1 | | 70 | 70 | 0 |

TABLE 118

| | | | | EX- | OB- |
|---|---|---|---|---|---|
| | | AVERAGE | | PECTED | SERVED |
| PPM A1 | | DEAD IN % | | MOR- | MOR- |
| A6 | Thiamethoxam | A6 | Thiamethoxam | TALITY | TALITY |
| 0.8 | 200 | 95 | 0 | 95 | 100* |
| 0.4 | 100 | 90 | 38 | 94 | 100* |
| 0.2 | 50 | 0 | 13 | 13 | 65* |
| 0.1 | 25 | 25 | 0 | 25 | 0 |
| 0.4 | 200 | 90 | 0 | 90 | 85 |
| 0.2 | 100 | 0 | 38 | 38 | 65* |
| 0.1 | 50 | 25 | 13 | 34 | 0 |
| 0.2 | 200 | 0 | 0 | 0 | 80* |
| 0.1 | 100 | 25 | 38 | 53 | 25 |
| 0.05 | 50 | 0 | 13 | 13 | 0 |
| 0.025 | 25 | 0 | 0 | 0 | 25* |
| 0.2 | 400 | 0 | 0 | 0 | 70* |
| 0.1 | 200 | 25 | 0 | 25 | 30* |
| 0.05 | 100 | 0 | 38 | 38 | 25 |
| 0.025 | 50 | 0 | 13 | 13 | 0 |
| 0.2 | 800 | 0 | 13 | 13 | 65* |
| 0.1 | 400 | 25 | 0 | 25 | 25 |
| 0.05 | 200 | 0 | 0 | 0 | 0 |
| 0.025 | 100 | 0 | 38 | 38 | 25 |
| 0.0125 | 50 | | 13 | 13 | 0 |

TABLE 119

| | | | | EX- | OB- |
|---|---|---|---|---|---|
| | | AVERAGE | | PECTED | SERVED |
| PPM A1 | | DEAD IN % | | MOR- | MOR- |
| A6 | Imidacloprid | A6 | Imidacloprid | TALITY | TALITY |
| 0.8 | 200 | 100 | 0 | 100 | 95 |
| 0.4 | 100 | 95 | 25 | 96 | 50 |
| 0.2 | 50 | 50 | 0 | 50 | 0 |
| 0.1 | 25 | 50 | 0 | 50 | 50 |
| 0.05 | 12.5 | 25 | | 25 | 25 |
| 0.4 | 200 | 95 | 0 | 95 | 80 |
| 0.2 | 100 | 50 | 25 | 63 | 0 |
| 0.1 | 50 | 50 | 0 | 50 | 0 |
| 0.05 | 25 | 25 | 0 | 25 | 0 |
| 0.2 | 200 | 50 | 0 | 50 | 80* |
| 0.1 | 100 | 50 | 25 | 63 | 25 |
| 0.05 | 50 | 25 | 0 | 25 | 0 |
| 0.2 | 400 | 50 | 13 | 56 | 70* |
| 0.1 | 200 | 50 | 0 | 50 | 65* |
| 0.05 | 100 | 25 | 25 | 44 | 0 |
| 0.025 | 50 | 0 | 0 | 0 | 60* |
| 0.0125 | 25 | | 0 | 0 | 25* |
| 0.2 | 800 | 50 | 25 | 63 | 70* |
| 0.1 | 400 | 50 | 13 | 56 | 25 |
| 0.05 | 200 | 25 | 0 | 25 | 0 |
| 0.025 | 100 | 0 | 25 | 25 | 50* |

TABLE 120

| | | AVERAGE | | | |
|---|---|---|---|---|---|
| PPM A1 | | DEAD IN % | | EXPECTED | OBSERVED |
| A8 | Abamectin | A8 | Abamectin | MORTALITY | MORTALITY |
| 0.4 | 0.1 | 80 | 80 | 96 | 90 |
| 0.4 | 0.05 | 80 | 70 | 94 | 90 |
| 0.4 | 0.025 | 80 | 0 | 80 | 100* |
| 0.4 | 0.0125 | 80 | 0 | 80 | 100* |
| 0.4 | 0.006 | 80 | 0 | 80 | 100* |
| 0.4 | 0.003 | 80 | 0 | 80 | 100* |
| 0.4 | 0.0015 | 80 | 0 | 80 | 100* |
| 0.4 | 0.0008 | 80 | 0 | 80 | 100* |
| 0.4 | 0.0004 | 80 | 0 | 80 | 100* |
| 0.4 | 0.0002 | 80 | 0 | 80 | 100* |
| 0.2 | 0.1 | 0 | 80 | 80 | 80 |
| 0.2 | 0.05 | 0 | 70 | 70 | 85* |
| 0.2 | 0.025 | 0 | 0 | 0 | 80* |
| 0.2 | 0.0125 | 0 | 0 | 0 | 100* |
| 0.2 | 0.006 | 0 | 0 | 0 | 100* |
| 0.2 | 0.003 | 0 | 0 | 0 | 90* |
| 0.2 | 0.0015 | 0 | 0 | 0 | 90* |
| 0.2 | 0.0008 | 0 | 0 | 0 | 90* |
| 0.2 | 0.0004 | 0 | 0 | 0 | 90* |
| 0.2 | 0.0002 | 0 | 0 | 0 | 90* |
| 0.1 | 0.1 | 0 | 80 | 80 | 95* |
| 0.1 | 0.05 | 0 | 70 | 70 | 80* |
| 0.05 | 0.1 | 0 | 80 | 80 | 55 |
| 0.05 | 0.05 | 0 | 70 | 70 | 0 |

TABLE 121

| | | AVERAGE | | | |
|---|---|---|---|---|---|
| PPM A1 | | DEAD IN % | | EXPECTED | OBSERVED |
| A8 | Emamectin | A8 | Emamectin | MORTALITY | MORTALITY |
| 0.8 | 0.8 | 100 | 95 | 100 | 90 |
| 0.4 | 0.4 | 65 | 93 | 97 | 90 |
| 0.2 | 0.2 | 50 | 75 | 88 | 30 |
| 0.1 | 0.1 | 50 | 70 | 85 | 0 |
| 0.4 | 0.8 | 65 | 95 | 98 | 95 |
| 0.2 | 0.4 | 50 | 93 | 96 | 95 |
| 0.1 | 0.2 | 50 | 75 | 88 | 25 |
| 0.05 | 0.1 | 0 | 70 | 70 | 0 |
| 0.2 | 0.8 | 50 | 95 | 98 | 95 |
| 0.1 | 0.4 | 50 | 93 | 96 | 95 |
| 0.05 | 0.2 | 0 | 75 | 75 | 85* |
| 0.025 | 0.1 | 0 | 70 | 70 | 0 |
| 0.2 | 1.6 | 50 | 95 | 98 | 100* |
| 0.1 | 0.8 | 50 | 95 | 98 | 95 |
| 0.05 | 0.4 | 0 | 93 | 93 | 100* |
| 0.025 | 0.2 | 0 | 75 | 75 | 95* |
| 0.0125 | 0.1 | | 70 | 70 | 65 |
| 0.2 | 3.2 | 50 | 100 | 100 | 100 |
| 0.1 | 1.6 | 50 | 95 | 98 | 95 |
| 0.05 | 0.8 | 0 | 95 | 95 | 100* |
| 0.025 | 0.4 | 0 | 93 | 93 | 100* |
| 0.0125 | 0.2 | | 75 | 75 | 80* |
| 0.00625 | 0.1 | | 70 | 70 | 0 |

TABLE 122

| | | | | EX- | OB- |
|---|---|---|---|---|---|
| | | AVERAGE | | PECTED | SERVED |
| PPM A1 | | DEAD IN % | | MOR- | MOR- |
| A8 | Thiamethoxam | A8 | Thiamethoxam | TALITY | TALITY |
| 0.8 | 200 | 100 | 0 | 100 | 90 |
| 0.4 | 100 | 85 | 38 | 91 | 85 |
| 0.2 | 50 | 55 | 13 | 61 | 80* |
| 0.1 | 25 | 50 | 0 | 50 | 0 |
| 0.4 | 200 | 85 | 0 | 85 | 65 |
| 0.2 | 100 | 55 | 38 | 72 | 25 |
| 0.1 | 50 | 50 | 13 | 56 | 0 |
| 0.2 | 200 | 55 | 0 | 55 | 65* |
| 0.1 | 100 | 50 | 38 | 69 | 0 |
| 0.05 | 50 | 0 | 13 | 13 | 0 |
| 0.025 | 25 | 0 | 0 | 0 | 40* |
| 0.2 | 400 | 55 | 0 | 55 | 90* |
| 0.1 | 200 | 50 | 0 | 50 | 25 |
| 0.05 | 100 | 0 | 38 | 38 | 0 |
| 0.025 | 50 | 0 | 13 | 13 | 25* |
| 0.2 | 800 | 55 | 13 | 61 | 0 |
| 0.1 | 400 | 50 | 0 | 50 | 0 |
| 0.025 | 100 | 0 | 38 | 38 | 0 |
| 0.0125 | 50 | | 13 | 13 | 0 |

TABLE 123

| | | | | EX- | OB- |
|---|---|---|---|---|---|
| | | AVERAGE | | PECTED | SERVED |
| PPM A1 | | DEAD IN % | | MOR- | MOR- |
| A8 | Imidacloprid | A8 | Imidacloprid | TALITY | TALITY |
| 0.8 | 200 | 90 | 0 | 90 | 100* |
| 0.4 | 100 | 85 | 25 | 89 | 85 |
| 0.2 | 50 | 80 | 0 | 80 | 0 |
| 0.1 | 25 | 65 | 0 | 65 | 50 |
| 0.05 | 12.5 | 25 | | 25 | 0 |
| 0.4 | 200 | 85 | 0 | 85 | 80 |
| 0.2 | 100 | 80 | 25 | 85 | 60 |
| 0.1 | 50 | 65 | 0 | 65 | 25 |
| 0.05 | 25 | 25 | 0 | 25 | 50* |
| 0.2 | 200 | 80 | 0 | 80 | 75 |
| 0.1 | 100 | 65 | 25 | 74 | 60 |
| 0.05 | 50 | 25 | 0 | 25 | 25 |
| 0.2 | 400 | 80 | 13 | 83 | 85* |
| 0.1 | 200 | 65 | 0 | 65 | 65 |
| 0.05 | 100 | 25 | 25 | 44 | 0 |
| 0.025 | 50 | 0 | 0 | 0 | 50* |
| 0.0125 | 25 | | 0 | 0 | 50* |
| 0.2 | 800 | 80 | 25 | 85 | 50 |
| 0.1 | 400 | 65 | 13 | 69 | 50 |
| 0.05 | 200 | 25 | 0 | 25 | 0 |
| 0.025 | 100 | 0 | 25 | 25 | 50* |
| 0.0125 | 50 | | 0 | 0 | 25* |

Unless otherwise indicated, the compounds were formulated as follows: Compound A1 EC, Compound A5 EC, Abamectin EC, Chlorpyrifos ME, Cyantraniliprole SC, Emamectin benzoate SG, Lambda-Cyhalothrin EC, Pymetrozine WP, Spirotetramat OD, Thiamethoxam WG. Data is not shown for experiments where there was no insect mortality.

1. A pesticidal mixture comprising a component A and a component B, wherein component A is a compound of formula I 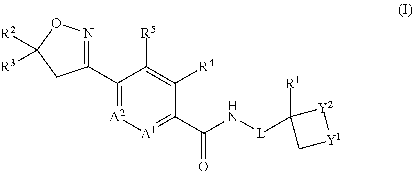
wherein
one of Y¹ and Y² is S, SO or SO₂ and the other is CH₂;
L is a direct bond or methylene;
A¹ and A² are C—H, or one of A¹ and A² is C—H and the other is N;
R¹ is hydrogen or methyl;
R² is chlorodifluoromethyl or trifluoromethyl;
R³ is 3,5-dibromo-phenyl, 3,5-dichloro-phenyl, 3,4-dichloro-phenyl, or 3,4,5-trichloro-phenyl;
R⁴ is methyl;
R⁵ is hydrogen;
or R⁴ and R⁵ together form a bridging 1,3-butadiene group;
and component B is a compound selected from
a) a pyrethroid including those selected from the group consisting of permethrin, cypermethrin, fenvalerate, esfenvalerate, deltamethrin, cyhalothrin, lambda-cyhalothrin, gamma-cyhalothrin, bifenthrin, fenpropathrin, cyfluthrin, tefluthrin, ethofenprox, natural pyrethrin, tetramethrin, S-bioallethrin, fenfluthrin, prallethrin and 5-benzyl-3-furylmethyl-(E)-(1R,3S)-2,2-dimethyl-3-(2-oxothiolan-3-ylidenemethyl)cyclopropane carboxylate;
b) an organophosphate including those selected from the group consisting of sulprofos, acephate, methyl parathion, azinphos-methyl, demeton-s-methyl, heptenophos, thiometon, fenamiphos, monocrotophos, profenofos, triazophos, methamidophos, dimethoate, phosphamidon, malathion, chlorpyrifos, phosalone, terbufos, fensulfothion, fonofos, phorate, phoxim, pirimiphos-methyl, pirimiphos-ethyl, fenitrothion, fosthiazate and diazinon;
c) a carbamate including those selected from the group consisting of pirimicarb, triazamate, cloethocarb, carbofuran, furathiocarb, ethiofencarb, aldicarb, thiofurox, carbosulfan, bendiocarb, fenobucarb, propoxur, methomyl and oxamyl;
d) a benzoyl urea including those selected from the group consisting of diflubenzuron, triflumuron, hexaflumuron, flufenoxuron, lufenuron and chlorfluazuron;
e) an organic tin compound including those selected from the group consisting of cyhexatin, fenbutatin oxide and azocyclotin;
f) a pyrazole including those selected from the group consisting of tebufenpyrad and fenpyroximate;
g) a macrolide including those selected from the group consisting of abamectin, emamectin, ivermectin, milbemycin, spinosad, azadirachtin and spinetoram;
h) an organochlorine compound including those selected from the group consisting of endosulfan, benzene hexachloride, DDT, chlordane and dieldrin;
i) an amidine including those selected from the group consisting of chlordimeform and amitraz;
j) a fumigant agent including those selected from the group consisting of chloropicrin, dichloropropane, methyl bromide and metam;
k) a neonicotinoid compound including those selected from the group consisting of imidacloprid, thiacloprid, acetamiprid, nitenpyram, dinotefuran, thiamethoxam, clothianidin, nithiazine and flonicamid;
l) a diacylhydrazine including those selected from the group consisting of tebufenozide, chromafenozide and methoxyfenozide;
m) a diphenyl ether including those selected from the group consisting of diofenolan and pyriproxyfen;
n) Indoxacarb;
o) chlorfenapyr;
p) pymetrozine;
q) spirotetramat, spirodiclofen and spiromesifen;
r) a diamide including those selected from the group consisting of flubendiamide, chlorantraniliprole (Rynaxypyr®) and cyantraniliprole;
s) sulfoxaflor;
t) metaflumizone;
u) fipronil and ethiprole;
v) pyrifluqinazon;
w) buprofezin;
x) diafenthiuron;
y) 4-[(6-Chloro-pyridin-3-ylmethyl)-(2,2-difluoro-ethyl)-amino]-5H-furan-2-one; and
z) Bacillus firmus, Bacillus cereus, Bacillus subtilis, and Pasteuria penetrans.

2. A pesticidal mixture according to claim 1, wherein in the compound of formula I L is a direct bond or methylene; one of Y¹ and Y² is S and the other is CH₂; A¹ and A² are C—H; R¹ is hydrogen or methyl; R² is trifluoromethyl; R³ is 3,5-dichloro-phenyl; R⁴ is methyl; and R⁵ is hydrogen.

3. A pesticidal mixture according to claim 1, wherein in the compound of formula I L is a direct bond or methylene; one of Y¹ and Y² is SO and the other is CH₂; A¹ and A² are C—H; R¹ is hydrogen or methyl; R² is trifluoromethyl; R³ is 3,5-dichloro-phenyl; R⁴ is methyl; and R⁵ is hydrogen.

4. A pesticidal mixture according to claim 3, wherein the molar proportion of the cis SO compounds of formula I compared to the total amount of cis SO and trans SO compounds of formula I is greater than 50%.

5. A pesticidal mixture according to claim 1, wherein in the compound of formula I L is a direct bond or methylene; one of Y¹ and Y² is SO₂ and the other is CH₂; A¹ and A² are C—H; R¹ is hydrogen or methyl; R² is trifluoromethyl; R³ is 3,5-dichloro-phenyl; R⁴ is methyl; and R⁵ is hydrogen.

6. A pesticidal mixture according to claim 1, wherein when L is a direct bond Y² is CH₂ and Y¹ is S, SO or SO₂, and wherein when L is methylene Y² is S, SO or SO₂ and Y¹ is CH₂.

7. A pesticidal mixture according to claim 1, wherein component A is a mixture of compounds I* and I** 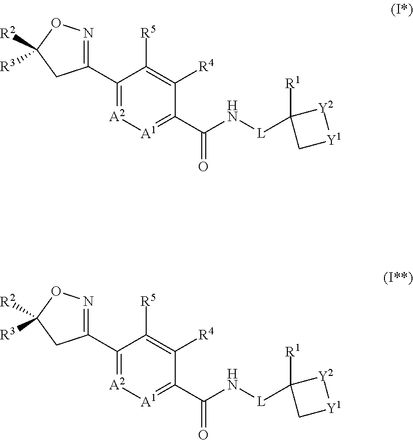
wherein the molar proportion of compound I** compared to the total amount of both enantiomers is greater than 50%.

8. A pesticidal mixture according to claim 1, wherein component B is a compound selected from
a) a pyrethroid selected from the group consisting of permethrin, cypermethrin, fenvalerate, esfenvalerate, deltamethrin, cyhalothrin, lambda-cyhalothrin, gamma-cyhalothrin, bifenthrin, fenpropathrin, cyfluthrin, tefluthrin, ethofenprox, natural pyrethrin, tetramethrin, S-bioallethrin, fenfluthrin, prallethrin and 5-benzyl-3-furylmethyl-(E)-(1R,3S)-2,2-dimethyl-3-(2-oxothiolan-3-ylidenemethyl)cyclopropane carboxylate;
b) an organophosphate selected from the group consisting of sulprofos, acephate, methyl parathion, azinphos-methyl, demeton-s-methyl, heptenophos, thiometon, fenamiphos, monocrotophos, profenofos, triazophos, methamidophos, dimethoate, phosphamidon, malathion, chlorpyrifos, phosalone, terbufos, fensulfothion, fonofos, phorate, phoxim, pirimiphos-methyl, pirimiphos-ethyl, fenitrothion, fosthiazate and diazinon;
c) a carbamate selected from the group consisting of pirimicarb, triazamate, cloethocarb, carbofuran, furathiocarb, ethiofencarb, aldicarb, thiofurox, carbosulfan, bendiocarb, fenobucarb, propoxur, methomyl and oxamyl;
d) a benzoyl urea selected from the group consisting of diflubenzuron, triflumuron, hexaflumuron, flufenoxuron, lufenuron and chlorfluazuron;
e) an organic tin compound selected from the group consisting of cyhexatin, fenbutatin oxide and azocyclotin;
f) a pyrazole selected from the group consisting of tebufenpyrad and fenpyroximate;
g) a macrolide selected from the group consisting of abamectin, emamectin, ivermectin, milbemycin, spinosad, azadirachtin and spinetoram;
h) an organochlorine compound selected from the group consisting of endosulfan, benzene hexachloride, DDT, chlordane and dieldrin;
i) an amidine selected from the group consisting of chlordimeform and amitraz;
j) a fumigant agent selected from the group consisting of chloropicrin, dichloropropane, methyl bromide and metam;
k) a neonicotinoid compound selected from the group consisting of imidacloprid, thiacloprid, acetamiprid, nitenpyram, dinotefuran, thiamethoxam, clothianidin, nithiazine and flonicamid;
l) a diacylhydrazine, selected from the group consisting of tebufenozide, chromafenozide and methoxyfenozide;
m) a diphenyl ether selected from the group consisting of diofenolan and pyriproxyfen;
n) Indoxacarb;
o) chlorfenapyr;
p) pymetrozine;
q) spirotetramat, spirodiclofen and spiromesifen;
r) a diamide selected from the group consisting of flubendiamide, chlorantraniliprole and cyantraniliprole;
s) sulfoxaflor;
t) metaflumizone;
u) fipronil and ethiprole;
v) pyrifluqinazon;
w) buprofezin;
x) diafenthiuron;
y) 4-[(6-Chloro-pyridin-3-ylmethyl)-(2,2-difluoro-ethyl)-amino]-5H-furan-2-one; and
z) Bacillus firmus, Bacillus cereus, Bacillus subtilis, and Pasteuria penetrans.

9. A pesticidal mixture according to claim 1, wherein component B is a compound selected from
pymetrozine;
an organophosphate selected from the group consisting of sulprofos, acephate, methyl parathion, azinphos-methyl, demeton-s-methyl, heptenophos, thiometon, fenamiphos, monocrotophos, profenofos, triazophos, methamidophos, dimethoate, phosphamidon, malathion, chlorpyrifos, phosalone, terbufos, fensulfothion, fonofos, phorate, phoxim, pirimiphos-methyl, pirimiphos-ethyl, fenitrothion, fosthiazate and diazinon;
a pyrethroid selected from the group consisting of permethrin, cypermethrin, fenvalerate, esfenvalerate, deltamethrin, cyhalothrin, lambda-cyhalothrin, gamma-cyhalothrin, bifenthrin, fenpropathrin, cyfluthrin, tefluthrin, ethofenprox, natural pyrethrin, tetramethrin, S-bioallethrin, fenfluthrin, prallethrin and 5-benzyl-3-furylmethyl-(E)-(1R,3S)-2,2-dimethyl-3-(2-oxothiolan-3-ylidenemethyl)cyclopropane carboxylate;
a macrolide selected from the group consisting of abamectin, emamectin, ivermectin, milbemycin, spinosad, azadirachtin and spinetoram;
a diamide selected from the group consisting of flubendiamide, chlorantraniliprole and cyantraniliprole;
a neonicotinoid compound selected from the group consisting of imidacloprid, thiacloprid, acetamiprid, nitenpyram, dinotefuran, thiamethoxam, clothianidin, nithiazine and flonicamid;
spirotetramat, spirodiclofen and spiromesifen; and
sulfoxaflor, lufeneron, diafenthiuron, and fipronil.

10. A pesticidal mixture according to claim 1, wherein component B is a compound selected from the group consisting of abamectin, chlorpyrifos, cyantraniliprole, emamectin, lambda cyhalothrin, pymetrozine, spirotetramat, thiamethoxam, clothianidin, imidacloprid, chlorantraniliprole, flonicamid. Sulfoxaflor, Lufeneron, Diafenthiuron, Flubendiamide, Tefluthrin, and Fipronil

11. A pesticidal mixture according to claim 1, wherein component B is a compound selected from the group consisting of abamectin, chlorpyrifos, cyantraniliprole, emamectin, lambda cyhalothrin, pymetrozine, spirotetramat, thiamethoxam, clothianidin, imidacloprid and flonicamid.

12. A pesticidal mixture according to claim 1, wherein the mixture comprises an agricultural acceptable carrier and optionally a surfactant.

13. A pesticidal mixture according to claim 1, wherein the weight ratio of A to B is 1000:1 to 1:1000.

14. A method of controlling insects, acarines, nematodes or molluscs which comprises applying to a pest, to a locus of a pest, or to a plant susceptible to attack by a pest a combination of components A and B, wherein components A and B are as defined in claim 1.

15. A seed comprising a mixture as defined in claim 1.

16. A method comprising coating a seed with a mixture as defined in claim 1.
